(19) United States
(12) Patent Application Publication
(10) Pub. No.: US 2024/0184133 A1
(43) Pub. Date: Jun. 6, 2024

(54) AIR FLOATING VIDEO DISPLAY APPARATUS

(71) Applicant: Maxell, Ltd., Kyoto (JP)

(72) Inventors: Hiroaki TAKAHASHI, Kyoto (JP); Koji FUJITA, Kyoto (JP)

(73) Assignee: Maxell, Ltd., Kyoto (JP)

(21) Appl. No.: 18/525,878

(22) Filed: Dec. 1, 2023

(30) Foreign Application Priority Data
Dec. 2, 2022 (JP) 2022-193538
Mar. 31, 2023 (JP) 2023-058401

(51) Int. Cl. G02B 30/56; H04N 13/305; H04N 13/366; H04N 13/398

(52) U.S. Cl. CPC G02B 30/56; H04N 13/305; H04N 13/366; H04N 13/398

(57) ABSTRACT

An air floating video display apparatus includes: a video display apparatus displaying a video; a lenticular lens arranged on a video-light emission side of the video display apparatus; and a retroreflector reflecting video light emitted from the video display apparatus and aerially forming an air floating video by using the reflection light. The video display apparatus displays a plurality of multi-viewpoint images including at least three objects so that a position of an optional object among the at least three objects is fixed while a position of an object other than the optional object is shifted among the plurality of different multi-viewpoint images in a predetermined direction.

### CROSS-REFERENCE TO RELATED APPLICATIONS

The present application claims priority from Japanese Patent Application No. 2022-193538 filed on Dec. 2, 2022, and Japanese Patent Application No. 2023-058401 filed on Mar. 31, 2023, the contents of each are hereby incorporated by reference into this application.

### TECHNICAL FIELD OF THE INVENTION

The present invention relates to an air floating video display apparatus.

### BACKGROUND OF THE INVENTION

As air floating video display apparatuses, video display apparatuses and display methods each for displaying a video as an aerial image directly toward the outside have already been known. Furthermore, a detection system that reduces erroneous detection for an operation on an operation surface of a displayed aerial image is also described in, for example, Japanese Patent Application Laid-Open Publication No. 2019-128722 (Patent Document 1).

### RELATED ART DOCUMENT

### Patent Document

Patent Document 1: Japanese Patent Application Laid-Open Publication No. 2019-128722

### SUMMARY OF THE INVENTION

However, in the disclosure of the Patent Document 1, a configuration for providing practical brightness and quality of the air floating video, a configuration for allowing the user to virtually and more pleasantly recognize the air floating video, and the like have not been sufficiently considered.

An objective of the present invention is to provide a more suitable air floating video display apparatus.

In order to solve the above-described problem, for example, configurations described in the claims are adopted. The present invention includes a plurality of means for solving the above-described problems, but an example is as follows. An air floating video display apparatus includes: a video display apparatus displaying a video; a lenticular lens arranged on a video-light emission side of the video display apparatus; and a retroreflector reflecting video light emitted from the video display apparatus and aerially forming an air floating video by using the reflection light. The video display apparatus displays a plurality of multi-viewpoint images including at least three objects so that a position of an optional object among the at least three objects is fixed while a position of an object other than the optional object is shifted among the plurality of different multi-viewpoint images in a predetermined direction.

According to the present invention, a more suitable air floating video display apparatus can be achieved. Other problems, configurations, and effects will be apparent from the following description of embodiments.

### BRIEF DESCRIPTIONS OF THE DRAWINGS

FIG. 1A is a diagram illustrating an example of a usage mode of an air floating video display apparatus according to an embodiment;

FIG. 1B is a diagram illustrating an example of a usage mode of an air floating video display apparatus according to an embodiment;

FIG. 2 is a diagram illustrating an example of an internal configuration of an air floating video display apparatus according to an embodiment;

FIG. 3A is a diagram illustrating an example of configurations of a principal part and a retroreflection portion of an air floating video display apparatus according to an embodiment;

FIG. 3B is a diagram illustrating an example of configurations of a principal part and a retroreflection portion of an air floating video display apparatus according to an embodiment;

FIG. 3C is a diagram illustrating an example of configurations of a principal part and a retroreflection portion of an air floating video display apparatus according to an embodiment;

FIG. 4A is a diagram illustrating another example of the configurations of the principal part and the retroreflection portion of the air floating video display apparatus according to an embodiment;

FIG. 4B is a diagram illustrating another example of the configurations of the principal part and the retroreflection portion of the air floating video display apparatus according to the embodiment;

FIG. 5 is a perspective view illustrating an arrangement example of members that block abnormal light rays formed by retroreflection according to an embodiment;

FIG. 6A is a cross-sectional view illustrating an arrangement example of members that block abnormal light rays formed by retroreflection according to an embodiment;

FIG. 6B is a cross-sectional view illustrating an arrangement example of members that block abnormal light rays formed by retroreflection according to an embodiment;

FIG. 7A is an explanatory diagram of a first sensing technique used in an air floating video display apparatus according to an embodiment;

FIG. 7B is an explanatory diagram of a first sensing technique used in an air floating video display apparatus according to an embodiment;

FIG. 8A is an explanatory diagram of a second sensing technique used in an air floating video display apparatus according to an embodiment;

FIG. 8B is an explanatory diagram of a second sensing technique used in an air floating video display apparatus according to an embodiment;

FIG. 9A is an explanatory view of an operation and an apparatus of a sensing system used in an air floating video display apparatus according to an embodiment;

FIG. 9B is an explanatory view of an operation and an apparatus of a sensing system used in an air floating video display apparatus according to an embodiment;

FIG. 10 is a diagram showing properties of spectral irradiance of sunlight;

FIG. 11 is a diagram illustrating a reflection property with respect to a light ray incident angle of polarization light incident on a medium having a refractive index of 1.5;

FIG. 12A is a diagram illustrating a configuration of a principal part of an air floating video display apparatus according to an embodiment;

FIG. 12B is a diagram illustrating a configuration of a principal part of an air floating video display apparatus according to an embodiment;

FIG. 13A is a diagram illustrating a configuration of a principal part of another air floating video display apparatus according to an embodiment;

FIG. 13B is a diagram illustrating a configuration of a principal part of another air floating video display apparatus according to an embodiment;

FIG. 14A is a diagram illustrating a principle of displaying a multi-viewpoint image;

FIG. 14B is a diagram illustrating a principle of displaying a multi-viewpoint image;

FIG. 15 is a diagram illustrating an example of camera arrangement for generating a multi-viewpoint video;

FIG. 16A is a diagram illustrating an example of a video displayed by a multi-viewpoint video display apparatus;

FIG. 16B is a diagram illustrating an example of a video displayed by a multi-viewpoint video display apparatus;

FIG. 17 is a diagram illustrating an example of how a multi-viewpoint video appears as an air floating video;

FIG. 18 is a diagram illustrating another example of how the multi-viewpoint video appears as the air floating video;

FIG. 19 is a diagram illustrating an example of a multi-viewpoint video according to an embodiment;

FIG. 20 is a diagram illustrating an example of how a multi-viewpoint video according to an embodiment appears;

FIG. 21 is a diagram illustrating another example of the multi-viewpoint video according to the embodiment;

FIG. 22 is a diagram illustrating another example of how the multi-viewpoint video according to the embodiment appears;

FIG. 23 is a diagram illustrating an example of how a multi-viewpoint video according to an embodiment appears as an air floating video;

FIG. 24 is a diagram illustrating another example of how the multi-viewpoint video according to the embodiment appears as the air floating video;

FIG. 25 is a supplementary explanatory diagram regarding generation of a multi-viewpoint image according to an embodiment;

FIG. 26 is a diagram illustrating an example of a multi-viewpoint video according to an embodiment;

FIG. 27 is a diagram illustrating an example of how a multi-viewpoint video according to an embodiment appears;

FIG. 28 is a diagram illustrating another example of the multi-viewpoint video according to the embodiment;

FIG. 29 is a diagram illustrating another example of how the multi-viewpoint video according to the embodiment appears;

FIG. 30 is a supplementary explanatory diagram regarding generation of a multi-viewpoint image according to an embodiment;

FIG. 31 is a diagram illustrating an example of how a multi-viewpoint video according to an embodiment appears as an air floating video;

FIG. 32 is a diagram illustrating another example of how the multi-viewpoint video according to the embodiment appears as the air floating video;

FIG. 33 is a diagram illustrating another example of the multi-viewpoint video according to the embodiment;

FIG. 34 is a diagram illustrating another example of how the multi-viewpoint video appears according to the embodiment;

FIG. 35 is a diagram illustrating another example of how the multi-viewpoint video according to the embodiment appears as the air floating video;

FIG. 36 is a diagram illustrating another example of the multi-viewpoint video according to the embodiment;

FIG. 37 is a diagram illustrating another example of how the multi-viewpoint video according to the embodiment appears;

FIG. 38 is a diagram illustrating another example of how the multi-viewpoint video according to the embodiment appears as the air floating video;

FIG. 39 is a supplementary explanatory diagram regarding generation of a multi-viewpoint image according to an embodiment; and

FIG. 40 is a diagram illustrating an external appearance example of a vending machine according to an embodiment.

### DESCRIPTIONS OF THE PREFERRED EMBODIMENTS

Hereinafter, embodiments of the present disclosure will be described in detail with reference to the drawings. In the drawings, the same parts are denoted by the same reference symbols in principle, and repetitive description thereof is omitted. In the drawings, the expressions of the components may not represent actual positions, sizes, shapes, ranges, and the like in order to easily understand the invention.

For the description, in explanation for processing operated by a program, the program, the function, the processing portion, and the like may be explained as entities. However, the entities as hardware for these components are a processor, or a controller, an apparatus, a computer, a system, and the like configured by the processor and the like. In the computer, the processing is executed by the processor in accordance with the program read out on the memory while appropriately using resources such as the memory and the communication interface. As a result, predetermined functions, processing portions, and the like are achieved. The processor is made of, for example, a semiconductor device such as a CPU/MPU or a GPU. The processing is not limited to software program processing, and can be implemented by a dedicated circuit. As the dedicated circuit, FPGA, ASIC, CPLD, or the like can be applied.

The program may be previously installed as data in the target computer, or may be distributed as data from a program source to the target computer. The program source may be a program distribution server on a communication network, or may be a non-transitory computer-readable storage medium such as a memory card or a disk. The program may be made of a plurality of modules. The computer system may be made of a plurality of apparatuses. The computer system may be made of a client server system, a cloud computing system, an IoT system, or the like. The various pieces of data and information are made of, for example, a structure such as a table and a list, but are not limited thereto. Expressions for identification information, an identifier, an ID, a name, a number and the like can be replaced with one another.

When an air floating video is displayed as a three-dimensional shape, in order to display an image having a three-dimensional texture based on motion parallax caused by a multi-viewpoint image, it is necessary to use a plurality of images obtained by imaging a display object such as a push button in a plurality of different directions or generate an image observed in different directions by rendering. This case has a problem that is necessity for a lot of time and effort in order to generate the multi-viewpoint image. Therefore, when an HMI having a relatively simple shape such as a push button is displayed as a three-dimensional air floating video, a technique for creating the multi-viewpoint image by a simpler method has been desired.

Therefore, the following embodiments can provide an air floating display apparatus capable of generating a multi-viewpoint image by a simpler method to display a three-dimensionally viewable object. An air floating video display apparatus (hereinafter, it may be simply referred to as an apparatus) according to an embodiment includes a configuration that first improves visual recognition by eliminating a ghost image that significantly reduces the visual recognition of the air floating video to improve the brightness of the air floating video. Furthermore, when the air floating video having the three-dimensional shape is used as, for example, signage (electronic signboard), an effect of further increasing people's interest on a product or a service displayed by the signage can be expected. For example, when a man/machine interface (which may also be referred to as HMI; Human Machine Interface, or simply UI; a user interface) such as a push button (number button) is displayed as the air floating video, a three-dimensionally viewable non-contact HMI having depth texture can be achieved. Therefore, indirect contact among an unspecified number of people can be prevented more than that in a case of usage of a physical push button, and a risk due to infection or the like can be reduced.

In addition, when the three-dimensionally viewable push button is displayed as the air floating video, the push button three-dimensionally appears while having depth texture, in other words, the push button is displayed to protrude or conversely be recessed more than the push button displayed as the planar air floating video (the air floating video based on the two-dimensional video/image). Therefore, the air floating video causes an effect being excellent in usability as the HMI for a person who views the air floating video for the first time or a person who is unfamiliar with handling.

For example, an apparatus according to an embodiment is applied to a number button for product selection in a vending machine, a button on a telephone, or the like, and provides a user interface using a screen based on the air floating video. Based on this technique, when the user approaches a housing of the apparatus, a system according to an embodiment displays the number button for product selection, the button on the telephone, and the like onto the screen of the air floating video.

When the user has approached the air floating video or has performed any operation on the air floating video, the air floating video display apparatus according to the embodiment automatically displays a welcome message and a person image for explaining how to use the air floating video, and then, the screen transits and changes to an operation menu screen including a plurality of push buttons (number buttons), an enter button, and the like so that the user can press the buttons. Furthermore, when the apparatus determines that the user does not understand the operation method of the air floating video (for example, when no operation is performed for a long time) or the like, the apparatus may make the detail guidance about the operation method for the user.

In addition, the air floating video display apparatus of one embodiment has a function of identifying and specifying the user, based on, for example, face authentication using a camera. The system refers to user attribute information such as age and system use history for the user specified by the function. The system performs control to change a size of a letter of the guidance for the operation method displayed as the air floating video in accordance with the attribute of the user.

In the following explanation for the embodiments, note that the aerially floating video is expressed as a term “air floating video”. In place of this term, expressions such as “spatial image”, “aerial image”, “spatial floating video”, “air floating optical image of display video”, “spatial floating optical image of display video” and others are acceptable. The term “air floating video” mainly used in the explanation for the embodiments is used as a typical example of these terms.

### <Air Floating Video Display Apparatus>

The present disclosure relates to, for example, a display apparatus capable of transmitting a video based on video light emitted from a video light emission source having a large area, through a transparent member such as a glass of a show window 30 (display window) separating a space or others, and displaying the video as the air floating video inside or outside a shop space. Also, the present disclosure relates to a large digital signage system made of a plurality of the display apparatuses.

According to the following embodiments, for example, high-resolution video can be displayed above a glass surface of a show window or a light-transmittable plate member while floating in air. In this case, only normal reflection light can be efficiently reflected with respect to a retroreflector (retroreflection member) or a retroreflection plate by making a divergence angle of the emitted video light small, that is, be an acute angle, and unifying the video light to have a specific polarization wave. Therefore, according to the present embodiment, the light use efficiency is high, and the ghost image occurring in addition to the main air floating image can be suppressed, the ghost image being the issue of the related-art retroreflection method, and thus, a clear air floating video can be provided.

By an apparatus including the light source of the present disclosure, a new air floating video display apparatus being capable of significantly reducing power consumption and excellent in availability can be provided. A technique of the present disclosure can provide, for example, an in-vehicle floating video display apparatus being capable of displaying a visually-recognizable, that is, unidirectionality air floating video outside the vehicle through a shield glass including a front windshield glass, a rear windshield glass and a side windshield glass of the vehicle.

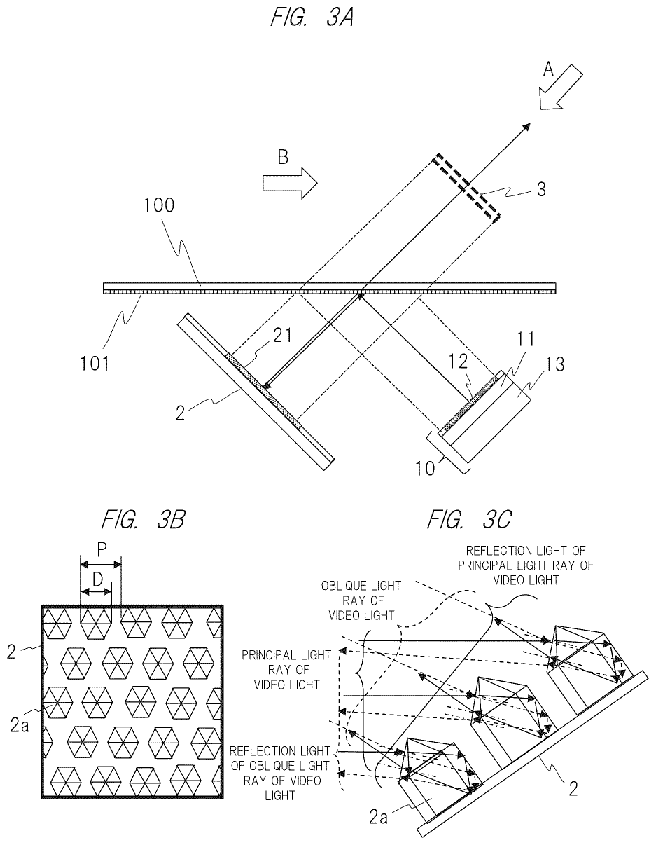

Meanwhile, in the related-art air floating video display apparatus, an organic EL panel or a liquid crystal display panel (also referred to as liquid crystal panel) and a retroreflector are combined as a color-display video source having high resolution. In an air floating video display apparatus based on a related art, the video light diverges at a wide angle. Therefore, when the retroreflector 2 made of the polyhedron shown in FIG. 3B in the first embodiment is used, the ghost image is formed by the video light obliquely entering the retroreflector 2 (retroreflection portion 2a) as shown in FIG. 3C in addition to the normal reflection light (the resultant normal air floating video) normally reflected on the retroreflector 2. Accordingly, a quality of the air floating video is reduced. In the air floating video display apparatus based on the related art, a plurality of ghost images depending on the number of the reflection surfaces are formed in addition to the normal air floating video. Therefore, other person than a viewing person is undesirably allowed to view the same air floating video that is the ghost image, and this case has a large problem also in a viewpoint of security.

### <First Configuration Example of Air Floating Video Display Apparatus>

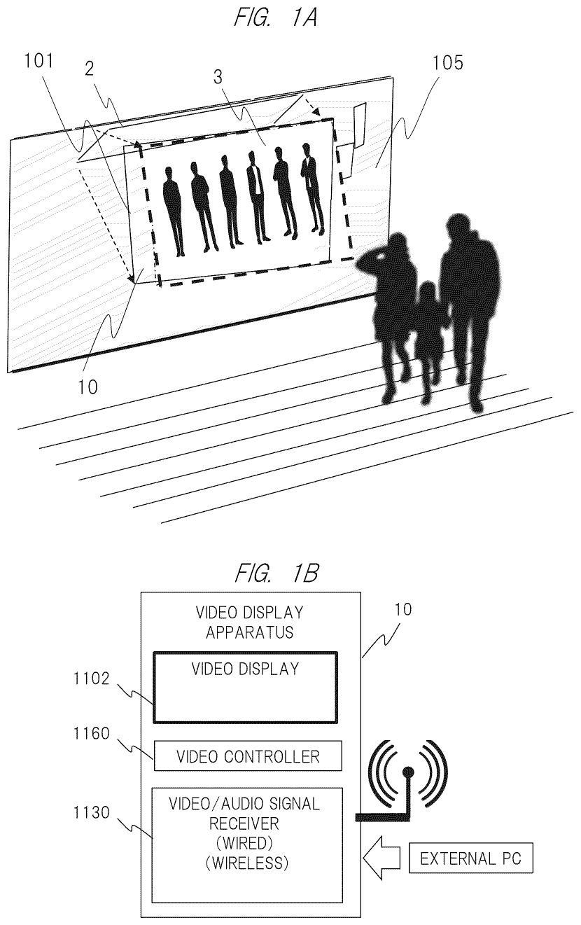

FIG. 1A is a diagram showing an example of a use mode of the air floating video display apparatus of the present embodiment, and is a diagram for explaining an entire configuration of the air floating video display apparatus. In FIG. 1A, for example, the space in the shop or others is partitioned by a show window (also referred to as “window glass”) 105 that is a light transmittable member (also referred to as transparent member) such as a glass. According to the present air floating video display apparatus, the air floating video can be transmitted through the transparent member, and be unidirectionally displayed outside the shop space.

Specifically, according to the present system, light having directionality of a narrow angle and specific polarization wave is emitted as video light flux from a video display apparatus 10. The emitted video light flux is temporarily caused to enter the retroreflector 2, is transmitted through the window glass 105 after retroreflection, and forms an air floating video 3 (spatial image) that is an actual image outside the shop space. In FIG. 1A, an inside of the shop that is an inside of the transparent member (in this case, window glass) 105 is illustrated as a depth side while an outside of the window glass 105 (such as sidewalk) is illustrated as a front side. Meanwhile, the window glass 105 may be provided with means for reflecting the specific polarization wave, and the video light flux may be reflected by the means to form the spatial image at a desirable position inside the shop.

FIG. 1B shows an internal configuration of the video display apparatus 10. The video display apparatus 10 includes a video display 1102 displaying an original image of the spatial image, a video controller 1160 converting the input video in accordance with a resolution of a panel, and a video/audio signal receiver 1130 receiving a video/audio signal as input.

Among these components, the video/audio signal receiver 1130 plays a role of handling a wired input signal through an input interface such as HDMI (High-Definition Multimedia Interface (registered trademark)) and handling a wireless input signal through Wi-Fi (Wireless Fidelity) (registered trademark). And, the video/audio signal receiver 1130 can also individually function as a video receiver/display. Further, the video/audio signal receiver 1130 can also display/output the video information output from a tablet terminal, a smartphone or others. Still further, a processor (computing processor) such as a stick PC is connectable to the video/audio signal receiver 1130 as necessary. In this case, the entire video/audio signal receiver can be also provided with a performance of a calculation processing, a video analysis processing and others.

### [Functional Block of Air Floating Video Display Apparatus]

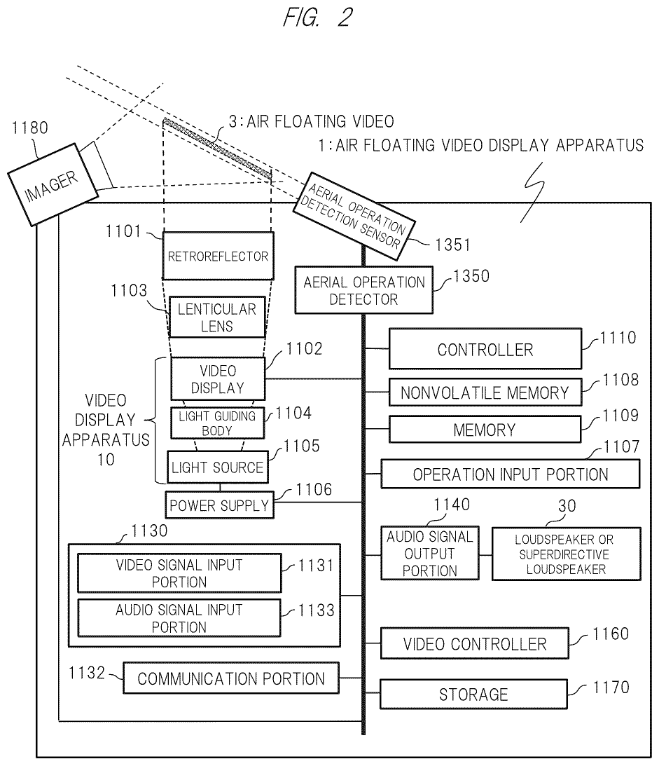

FIG. 2 show a functional block diagram of the air floating video display apparatus 1. The video display 1102 generates a video by modulating the light transmitted through the video display 1102, based on a video signal. The video display 1102 may be also referred to as display panel, liquid crystal panel or liquid crystal display panel. As the video display 1102, for example, a transmission-type display panel may be used. Alternatively, the video display 1102 may be made of, for example, a reflection-type display panel modulating the light reflected toward the panel on the basis of the video signal, a DMD (Digital Micromirror Device: registered trademark) panel, or the like.

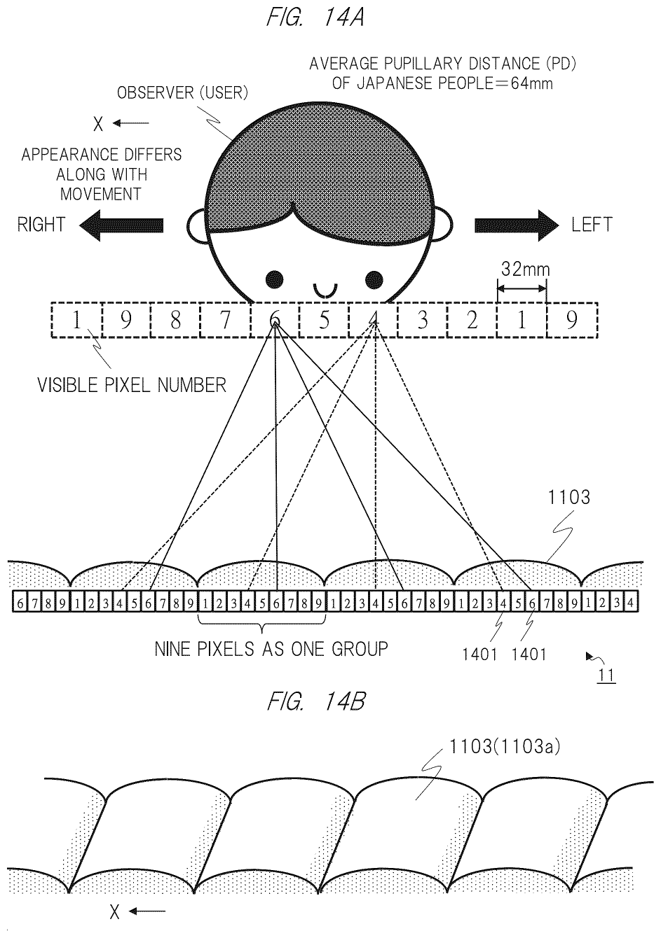

As shown in FIG. 2, the air floating video display apparatus 1 includes a lenticular lens 1103. The lenticular means a printed object, a pattern of which changes depending on a viewing angle or which provides three-dimensional texture, when using a sheet-shaped lenticular lens. The lenticular lens is an aggregate of lenses each having a semicylindrical shape (in other words, semielliptical cylindrical shape, see FIG. 14 described later), and video displays 1102 that display different videos corresponding to the number of viewpoints of the multi-viewpoint images (or videos) are arranged below one lens (semicylindrical lens). In the present embodiment, the lenticular lens 1103 is arranged on the video-light emission side of the video display 1102. Specifically, the lenticular lens 1103 is arranged at a predetermined distance from the video-light emission side of the video display 1102. Furthermore, the air floating video display apparatus 1 displays the multi-viewpoint image (or the multi-viewpoint video) of the video light emitted from the video display 1102 through the lenticular lens 1103, and the user can observe the multi-viewpoint image (or the multi-viewpoint video).

According to the configuration of FIG. 2, when the user moves in the direction of the arrangement of the semicylindrical lenses forming the lenticular lens 1103 (for example, left and right directions), the user can view different images (or videos) from the respective positions. Therefore, the different images (or videos) are formed as shot images (or videos) with different shooting directions for one subject. As a result, through the lenticular lens, the user can visually recognize the image (or video) displayed on the liquid crystal panel configuring the video display 1102 as the multi-viewpoint three-dimensional image accompanied by the motion parallax.

A retroreflection portion 1101 performs the retroreflection of the light modulated by the video display 1102. Of the reflection light from the retroreflection portion 1101, light emitted to the outside of the air floating video display apparatus 1 forms the air floating video 3. A light source 1105 generates light for the video display 1102. As the light source 1105, for example, a solid-state light source such as an LED light source or a laser light source is used. A power supply 1106 converts an AC current input from the outside into a DC current, and supplies power to the light source 1105. Furthermore, the power supply 1106 supplies necessary DC current to each of the other portions.

A light guiding body 1104 guides light formed at the light source 1105 to irradiate the video display 1102. A combination of the light guiding body 1104 and the light source 1105 can be also called a backlight of the video display 1102. Various types of the combination of the light guiding body 1104 and the light source 1105 can be thought. Note that a portion made of three components that are the video display 1102, the light guiding body 1104 and the light source 1105 as shown in FIG. 2 is particularly called video display apparatus 10.

An aerial operation detection sensor 1351 is a sensor sensing a range overlapping at least a part of the display range of the air floating video 3 of the entire display range for detecting operation (also referred to as aerial operation) on the air floating video 3 operated with a user's hand finger. A specific sensor configuration of the aerial operation detection sensor 1351 is a distance sensor using non-visible light such as infrared light, non-visible light laser, ultrasonic waves, or the like, or may be configured of a combination of a plurality of sensors so as to detect coordinates on a two-dimensional plane. Also, the aerial operation detection sensor 1351 may be configured of a LiDAR (Light Detection and Ranging) of a TOF (Time Of Flight) scheme described later.

An aerial operation detector 1350 acquires a sensing signal (in other words, detection information) from the aerial operation detection sensor 1351, and calculates, for example, the presence or absence of the touch on the air floating video 3 operated with the user's hand finger or a position of the touch on the air floating video 3. The aerial operation detector 1350 may be configured of a circuit such as an FPGA.

The aerial operation detection sensor 1351 and the aerial operation detector 1350 (these components may be referred to as sensing system) may be configured to be embedded in the air floating video display apparatus 1, but may be externally provided as separated from the air floating video display apparatus 1. When they are provided as separate, these components may be configured so as to be able to transmit information and signals to the air floating video display apparatus 1 through a wired or wireless communication connection path or signal transmission path. When the aerial operation detection sensor 1351 and the aerial operation detector 1350 may be provided as separate. In this case, it is possible to architect a system in which only the aerial operation detection function can be optionally added to the air floating video display apparatus 1 as a main body without the aerial operation detection function. Alternatively, only the aerial operation detection sensor 1351 may be provided as separate while the aerial operation detector 1350 may be embedded in the air floating video display apparatus 1. For example, when it is more desirable to freely arrange the aerial operation detection sensor 1351 from the installation position of the air floating video display apparatus 1, the structure in which only the aerial operation detection sensor 1351 is as separate is advantageous.

An imager 1180 is so-called camera having an image sensor, and captures a video of a space in the vicinity of the air floating video 3 and/or user's face, arm, finger and others. As the imager 1180, a plurality of cameras or a camera with a depth sensor may be used. The imager 1180 may be provided as separate from the air floating video display apparatus 1. If the plurality of cameras or the camera with the depth sensor is used as the imager 1180, the imager 1180 may assist the aerial operation detector 1350 to detect the touch operation on the air floating video 3 operated by the user, in other words, the aerial operation in contact with the surface of the air floating video 3.

For example, if the aerial operation detection sensor 1351 is configured to be a sensor for an object entering a plane to be targeted and belonging to the air floating video 3, it may be impossible for only the aerial operation detection sensor 1351 to detect information about how near the object (such as the user's hand finger) not entering the plane yet is to this plane. In this case, by using the depth calculation information based on the result of the video captured by the plurality of cameras of the above-described imager 1180 or the depth information sensed by the depth sensor, a distance between the plane and the object (such as the user's hand finger) not entering the plane of the air floating video 3 can be calculated. The calculation information can be used for various display controls on the air floating video 3.

Alternatively, in the present system, the aerial operation detector 1350 may be configured not to use the aerial operation detection sensor 1351 and to detect the touch operation (aerial operation) on the air floating video 3 operated by the user, based on the result of the video captured by the imager 1180.

Also, an image of the face of the user who is operating the air floating video 3 may be captured by the imager 1180, and the control portion 1110 may perform user identification/specification processing or user authentication processing. Alternatively, the imager 1180 may be configured to capture an image including the user who is operating the air floating video 3 and its peripheral region in order to determine whether a different person who is standing around or behind the user who is operating the air floating video 3 takes a peek at the operation of the user on the air floating video 3 or the like.

An operation input portion 1107 is, for example, an operation button or a remote controller light-receiver which receives an input of a signal about the user's operation different from the aerial operation on the air floating video 3. The operation input portion 1107 may be used to operate this system by an administrator of the air floating video display apparatus 1 different from the user who is operating the air floating video 3.

A video signal input portion 1131 has a function of connecting an external video output apparatus to input video data. An audio signal input portion 1133 has a function of connecting an external audio output apparatus to input audio data. Meanwhile, an audio signal output portion 1140 has a function of outputting an audio signal based on the audio data input to the audio signal input portion 1133. In addition, the audio signal output portion 1140 may output an audio signal based on audio data such as numbers and letter strings recorded previously in a storage 1170, and data of other operation sounds and error alert sounds. Note that the video signal input portion 1131 and the audio signal input portion 1133 are collectively referred to as the video/audio signal input portion 1130. The video signal input portion 1131 and the audio signal input portion 1133 may have respective configurations, but may be combined to be one component.

The audio signal output portion 1140 is connected to a loudspeaker or a super-directive loudspeaker 30. The audio signal output portion 1140 may be connected to the loudspeaker that outputs audio in a normal audible band. However, particularly, when high confidentiality is required and security needs to be considered, the audio signal output portion may be connected to the super-directive loudspeaker so that the person different from the user cannot hear the audio. The super-directive loudspeaker is a loudspeaker having a property allowing only an ear of a person existing in a specific limited spatial region to hear the audio in the audible band but not allowing an ear of a person existing outside the specific spatial region to hear the audio in the audible band.

The super-directive loudspeaker 30 is made of an array of a plurality of ultrasonic output elements capable of emitting an ultrasonic signal of, for example, about 40 kHz on a plane. In this case, the larger the number of ultrasonic output elements for use is, the larger the sound volume of the audio provided by the super-directive loudspeaker is. The principles of the super-directive loudspeaker are briefly described. As well known, ultrasonic wave has higher rectilinear propagation than that of the audio of the audible band (such as talking voice of a person). Therefore, it is possible to make the audio audible only in the specific limited spatial region by, based on the audio signal of the audible band, modulating (for example, preforming AM modulation to) the above-described ultrasonic signal of 40 kHz as a carrier wave.

For example, when the plurality of cameras are used as the imager 1180, the audio is made audible only in a region in vicinity of the user's ears by the output of the super-directive loudspeaker 30 in response to a result of specification of a position of the user's face, ears, or so forth. Specifically, the audio is made audible only in the specific limited spatial region by control of a phase (in other words, delay time) of each ultrasonic signal input to each ultrasonic output element configuring the super-directive loudspeaker 30. Also, the audio is also made audible only in the specific limited spatial region by a configuration in which the plurality of ultrasonic output elements are arranged not on the plane but also, for example, on a concave plane.

A non-volatile memory 1108 stores various types of data for use in the air floating video display apparatus 1. The data stored in the non-volatile memory 1108 includes, for example, various types of operation data, user interface video information such as an icon and a button, data and layout information of an object to be operated by the user, to be displayed as the air floating video 3. The memory 1109 stores video data and apparatus control data to be displayed as the air floating video 3.

A controller 1110 corresponds to a controller of the air floating video display apparatus 1, in other words, a control apparatus, and controls the operation of each portion to be connected. The controller 1110 includes a device such as a processor. The controller 1110 executes processing in accordance with a program read out from the nonvolatile memory 1108 or the storage 1170 into the memory 1109 or the internal memory. As a result, various functions are achieved. The controller 1110 may perform computing processing based on information acquired from each connected portion in cooperation with the program stored in the memory 1109. The controller 1110 may be mounted in a housing configuring the air floating video display apparatus 1 using a microcomputer or the like, or may be connected and mounted outside the housing.

A communication portion 1132 communicates with an external apparatus, an external server, or the like through a wired or wireless communication interface. The communication portion 1132 transmits and receives a video, an image, an audio, and various pieces of data through the communication.

The storage 1170 records a video, an image, an audio, various pieces of data, and the like. For example, a video, an image, an audio, various pieces of data, and the like may be recorded in the storage 1170 previously at the time of product shipment. A video, an image, sound, various pieces of data, and the like acquired from an external apparatus, an external server, or the like through the communication portion 1132 may be recorded in the storage 1170. A video, an image, various pieces of data, and the like recorded in the storage 1170 can be output as the air floating video 3 through the video display 1102, the video display apparatus 10, and the retroreflection portion 1101.

The data of the video or the image to be recorded in the storage 1170 may also include data such as an icon, a button, an object to be operated by the user, and the like displayed as the user interface (including an operation menu and a person image to be described later) on the air floating video 3 and data configuring the person image. Further, the various pieces of data to be recorded in the storage 1170 may include information such as the operation menu of the icon, button, and object to be displayed as the user interfaces on the air floating video 3, layout information of the human image, and various pieces of metadata information regarding the operation menu and the human image. Further, audio data causing the human image of the air floating video 3 to output the audio may also be recorded in the storage 1170. The audio data recorded in the storage 1170 may be output as the audio signal from the loudspeaker or the super-directive loudspeaker 30 through the audio signal output portion 1140.

The controller 1110, the video controller 1160 or the audio signal output portion 1140 may appropriately create the video data or the audio data for displaying and outputting the operation menu or the person image, based on various pieces of data for configuring the operation menu or the person image stored in the storage 1170, the nonvolatile memory 1108, or the like.

The video controller 1160 performs various controls on the video signals input to the video display 1102. For example, the video controller 1160 may perform video switching control for selecting which video among the video stored in the memory 1109, the video input by the video signal input portion 1131, and the like is to be input to the video display 1102. Alternatively, the video controller 1160 may perform control of superimposing the video stored in the memory 1109 and the video input by the video signal input portion 1131 to generate a combined video to be input to the video display 1102. Furthermore, the video controller 1160 may control image processing on the video data input by the video signal input portion 1131, the video stored in the memory 1109, and the like. Examples of the image processing include scaling processing of enlarging, shrinking, and deforming an image, brightness adjustment processing of changing luminance, contrast adjustment processing of changing a contrast curve of an image, and retinex processing of decomposing an image into components of light and changing weighting for each component.

Furthermore, the video controller 1160 may perform special effect video processing or the like for assisting the user's aerial operation on the video to be input to the video display 1102. The special effect video processing may be controlled based on the detection result of the user operation by the aerial operation detector 1350 or the imaging result of the user using the imager 1180.

As described above, various functions can be mounted on the air floating video display apparatus 1. However, the air floating video display apparatus 1 does not necessarily have all of the above-described configurations. The air floating video display apparatus 1 may have any configuration as long as it has at least a function of generating the air floating video 3.

### [First Method for Forming Air Floating Video]

Each of FIGS. 3A to 3C illustrates a configuration of a principal part of the air floating video display apparatus of the embodiment, and also illustrates an example (referred to as a first method) regarding the formation of the air floating video 3 and the configuration of the retroreflector 2.

As illustrated in FIG. 3A, the air floating video display apparatus includes the video display apparatus 10 that diverges the video light of the specific polarization wave at a narrow angle in an oblique direction with respect to a transparent member 100 that is a transmissive plate such as glass having transmittance. The video display apparatus 10 includes a liquid crystal display panel 11 and a light source 13 that generates the light of the specific polarization wave having the narrow divergence property.

The video light of the specific polarization wave emitted from the video display apparatus 10 is reflected by a polarization splitter 101 provided on the transparent member 100 and having a film that selectively reflects the video light of the specific polarization wave, and the reflection light is incident on the retroreflector 2. In FIGS. 3A to 3C, the sheet-shaped polarization splitter 101 is adhered to the transparent member 100.

The retroreflector 2 is provided in the other oblique direction with respect to the transparent member 100. A video-light entering surface of the retroreflector 2 is provided with a λ/4 plate 21 (in other words, a ¼ waveplate). The video light is converted from the specific polarization wave (one polarization wave) to the other polarization wave when being transmitted through the λ/4 plate 21 twice in total that are the entering to and the emission from the retroreflector 2.

Here, the polarization splitter 101 that selectively reflects the video light of the specific polarization wave has a property of transmitting the polarization light of the other polarization wave after the polarization conversion. Therefore, the video light of the other polarization wave after the polarization conversion is transmitted through the polarization splitter 101. As illustrated in the drawing, the video light having been transmitted through the polarization splitter 101 forms the air floating video 3 that is an actual image outside the transparent member 100.

Note that the light forming the air floating video 3 is aggregation of light rays converging from the retroreflector 2 to the optical image of the air floating video 3, and these light rays rectilinearly propagate even after being transmitted through the optical image of the air floating video 3. Therefore, the air floating video 3 is a video having high directionality as different from the diverged video light formed on a screen by a general projector or the like.

Therefore, in the configuration of FIGS. 3A to 3C, when the user visually recognizes the air floating video 3 in a direction of an arrow A, the air floating video 3 is visually recognized as a bright video. However, when a different person visually recognizes the air floating video 3 in, for example, a direction of an arrow B, the air floating video 3 cannot be visually recognized as a video at all. Such a property of the air floating video 3 is very suitable when being applied to a system displaying a video requiring high security, a video having high confidentiality that needs to be secured for a person facing the user or the like.

Note that the polarization axes of the reflected video light may be ununified depending on the performance of the retroreflector 2. In this case, a part of the video light having the ununified polarization axes is reflected by the polarization splitter 101 described above, and returned to the video display apparatus 10. The part of the video light is reflected again by the video display surface of the liquid crystal display panel 11 configuring the video display apparatus 10 to generate the ghost image. This may be a cause of the reduction in the image quality of the air floating video 3.

Therefore, in the present embodiment, the video display surface of the video display apparatus 10 is provided with an absorption-type light polarizer 12. In the absorption-type light polarizer 12, the re-reflection can be suppressed since the video light emitted from the video display apparatus 10 is transmitted through the absorption-type light polarizer 12 while the reflection light returning from the polarization splitter 101 is absorbed by the absorption-type light polarizer 12. Therefore, according to the present embodiment using the absorption-type light polarizer 12, the reduction in the image quality due to the ghost image of the air floating video 3 can be prevented or suppressed.

The above-described polarization splitter 101 may be made of, for example, a reflection-type light polarizer, a metal multilayer film that reflects the specific polarization wave, or the like.

FIG. 3B shows a configuration example of the retroreflector 2 using the first method. FIG. 3B shows a surface shape of a retroreflector produced by Nippon Carbide Industries Co., Inc., used as the typical retroreflector 2 for the present study. A surface of this retroreflector 2 has hexagonal-prism retroreflectors (retroreflector elements) 2a orderly arrayed. The light ray entering the hexagonal prism is reflected on a wall surface and a bottom surface of the hexagonal prism, is emitted as retroreflection light in a direction corresponding to the incident light, and displays the air floating video 3 that is an actual image, based on the video displayed on the video display apparatus 1.

Resolution of this air floating video 3 significantly depends on not only the resolution of the liquid crystal display panel 11 but also a diameter “D” and a pitch “P” of the retroreflection portion 2a of the retroreflector 2 shown in FIG. 3B. For example, when a WUXGA liquid crystal display panel 11 of 7 inches (1920×1200 pixels) is used, even if one pixel (corresponding one triplet) is about 80 μm, if the diameter D and the pitch P of the retroreflection portion 2a are, for example, 240 μm and 300 μm, respectively, one pixel of the air floating video 3 is equivalent to 300 μm. Therefore, effective resolution of the air floating video 3 decreases down to about ⅓. Accordingly, in order to make the resolution of the air floating video 3 equal to the resolution of the video display apparatus 10, it is desirable to make the diameter D and the pitch P of the retroreflection portion 2a close to one pixel of the liquid crystal display panel 11. Meanwhile, in order to suppress the moire based on the pixels of the liquid crystal display panel 11 and the retroreflection portion 2a, each pitch ratio may be designed to deviate from an integral multiple of one pixel.

Regarding the shape, all sides of the retroreflection portion 2a may be arranged not to overlap all sides of one pixel of the liquid crystal display panel 11.

Meanwhile, in order to manufacture the retroreflector 2 at a low cost, the retroreflector 2 may be shaped by a roll press method. Specifically, this method is a method of arranging and forming the retroreflection portion 2a on a film. This method forms a necessary shape by forming an inverse shape of the formed shape on a roll surface, applying an ultraviolet curing resin onto a base material for fixation, and causing the portion to pass through a gap between the rolls, and then, hardens the shape by emitting the ultraviolet ray thereto. This manner provides the retroreflector 2 having a desirable shape.

### [Second Method for Forming Air Floating Video]

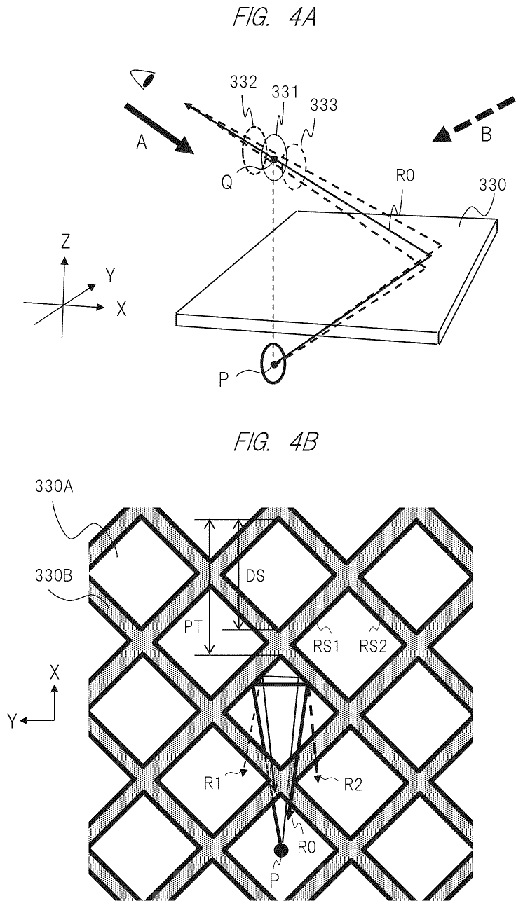

Next, each of FIGS. 4A and 4B illustrates another example (referred to as a second method) regarding the formation of the air floating video 3 and the configuration of the retroreflector in the air floating video display apparatus of the present embodiment. FIG. 4A illustrates an outline of formation of the air floating video 3 using a retroreflector 330 in the second method. With respect to the retroreflector 330, light from an object P (corresponding point P) in one space (in this example, a space lower in a Z-direction) enters and retroreflected by the retroreflector 330 to form an air floating video 331 (corresponding point Q) in the other space (in this example, an upper space in the Z-direction).

As a representative retroreflector 330, FIG. 4B illustrates a surface shape for explaining an operation principle of a retroreflector manufactured by Asukanet Co., Ltd, used for the present study. A surface (X-Y surface in the drawing) of the retroreflector 330 has a four-sided structure (in other words, a tetrahedron) 330A regularly arrayed. A plurality of structures 330A are arranged between side walls 330B. The four-sided structure 330A is, for example, a micromirror having a quadrangular prism shape extending in the Z-direction. For example, light (also referred to as object light) emitted from the object P enters the four-sided structure 330A. The light ray entering the four-sided structure 330A is reflected by two surfaces (for example, a reflecting surface RS1 and a reflecting surface RS2) of the wall surfaces of the four-sided structure 330A. The reflection light rays (both the light ray emitted upward from the reflecting surface RS1 and the light ray emitted upward from the reflecting surface RS2) are indicated as reflection light R0. The reflection light R0 is emitted as retroreflection light in a direction corresponding to the incident light, and forms and displays an air floating video 331 that is an actual image based on the object P as illustrated in FIG. 4A.

Resolution of this air floating video 331 also significantly depends on an outer shape (diameter) “DS” and a pitch “PT” of the retroreflection portion (the four-sided structure 330A) of the retroreflector 330 as similar to the retroreflector 2 of the first method shown in FIG. 3. For example, when a WUXGA liquid crystal display panel 11 of 7 inches (1920×1200 pixels) is used, even if one pixel (corresponding one triplet) is about 80 μm, if the outer shape (diameter) D and the pitch PT of the retroreflection portion are, for example, 120 μm and 150 μm, respectively, one pixel of the air floating video 331 is equivalent to 150 μm. Therefore, effective resolution of the air floating video 331 decreases down to about ½.

Accordingly, in order to make the resolution of the air floating video 331 equal to the resolution of the video display apparatus 10, it is desirable to make the diameter DS and the pitch PT of the retroreflection portion (structure 330A) close to one pixel of the liquid crystal display panel. Meanwhile, in order to suppress the moire based on the pixels of the liquid crystal display panel 11 and the retroreflector 330, each pitch ratio may be designed to deviate from an integral multiple of one pixel as described above. Regarding the shape, all sides of the retroreflection portion (structure 330A) may be arranged not to overlap all sides of one pixel of the liquid crystal display panel.

Note that the light forming the air floating video 331 is aggregation of light rays converging from the retroreflector 330 to the optical image of the air floating video 331, and these light rays rectilinearly propagate even after being transmitted through the optical image of the air floating video 331. Therefore, the air floating video 331 is a video having high directionality as different from the diverged video light formed on a screen by a general projector or the like.

Therefore, in the configuration of FIGS. 4A and 4B, when the user visually recognizes the air floating video 331 in a direction of an arrow A, the air floating video 331 is visually recognized as a bright video. However, when a different person visually recognizes the air floating video 3 in, for example, a direction of an arrow B, the air floating video 331 cannot be visually recognized as a video at all. Such a property of the air floating video 331 is very suitable when being applied to a system displaying a video requiring high security, a video having high confidentiality that needs to be secured for a person facing the user or the like, as similar to the air floating video using the retroreflector 2 of the first method.

Note that, in the retroreflector 330 of the second method, as illustrated in FIG. 4B, the light emitted from the object P enters the retroreflector 330 from one side (lower side in the Z-direction), is reflected by two reflecting surfaces (RS1, RS2) provided on the four-sided wall surfaces configuring the retroreflector 330, and images the air floating video 331 as the reflection light R0 at the position of the point Q on the other side (upper side in the Z-direction). At this time, on the two reflecting surfaces (RS1, RS2), abnormal lights R1 and R2 are generated as light having a reflection direction different from that of the reflection light R0. The ghost images 332 and 333 as illustrated in FIG. 4A are generated by the abnormal lights R1 and R2 generated on the two reflecting surfaces (RS1, RS2). Therefore, the ghost images 332 and 333 may be a cause of the reduction in the image quality of the air floating video 331.

As described above, in the retroreflector 2 of the first method, the ghost image is generated in accordance with the number of reflecting surfaces. On the other hand, in the retroreflector 330 of the second method, the ghost image is generated only in specific two directions due to the incident angle of the object light. Therefore, the retroreflector 330 of the second method is less affected by the ghost image, and the air video display with high image quality can be performed. Therefore, only a case of application of the retroreflector 330 of the second method to the following air floating video display apparatus will be described.

### [Technical Means for Reducing Ghost Image]

In order to achieve an air video display apparatus or the like capable of forming a high-quality air floating video with less ghost images, an emitting surface of a liquid crystal display panel may be provided with a video light control sheet for controlling a divergence angle of the video light emitted from the liquid crystal display panel as the video display element to bend the video light in a desired direction. Furthermore, the light-ray emitting surface of the retroreflector 330, the light-ray entering surface of the same, or both surfaces of the same may be provided with the video light control sheet to absorb the abnormal lights R1 and R2 (FIG. 4B) that are the cause of the formation of the ghost images.

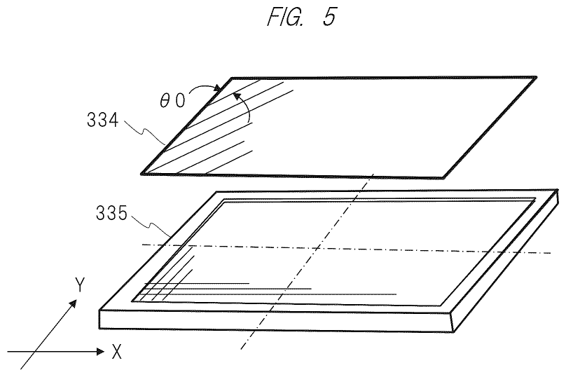

FIG. 5 illustrates specific method and configuration example of applying the video light control sheet to the air floating video display apparatus. In FIG. 5, an emitting surface of a liquid crystal display panel 335 which is the video display element is provided with a video light control sheet 334. In FIG. 5, the emitting surface of the liquid crystal display panel 335 is illustrated as a plane (X-Y plane) formed by the illustrated X-axis and Y-axis. The video light control sheet 334 has a light transmitting portion and a light absorbing portion on the main plane (X-Y plane). In this case, the moire may be generated by interference between the pixel of the liquid crystal display panel 335 and the pitch between the light transmitting portion and the light absorbing portion of the video light control sheet 334. In order to reduce this moire, the following two methods are effective.

(1) As a first method, vertical fringes (oblique lines in the drawing) generated by the light transmitting portions and the light absorbing portions of the video light control sheet 334 are arranged to incline by a predetermined angle (inclination) “θ0” from the arrangement of pixels (the X-axis and the Y-axis) of the liquid crystal display panel 335.

(2) As a second method, in an assumption that the pixel dimension of the liquid crystal display panel 335 is “A” while the pitch between the vertical stripes of the video light control sheet 334 is “B”, a ratio (B/A) thereof is selected to a value deviating from an integral multiple. Since one pixel of the liquid crystal display panel 335 is made of parallel-arrayed sub-pixels of three colors that are RGB and is of generally square, the generation of the moire described above cannot be suppressed in the entire screen. Therefore, the inclination θ0 described in the (1) first method may be optimized within a range of 5 degrees to 25 degrees so that a position of the generation of the moire can be intentionally shifted to a position at which the air floating video is not displayed.

The liquid crystal display panel and the video light control sheet 334 have been described as the subject matter in order to reduce the moire. When the retroreflector 330 is provided with the video light control sheet 334, the similar method and configuration can be applied to the moire generated between the retroreflector 330 and the video light control sheet 334. Since the retroreflector 330 and the video light control sheet 334 both have linear structures, the video light control sheet 334 may be optimally inclined while targeting the X-axis and the Y-axis of the retroreflector 330. As a result, a large moire that can be visually recognized and that has a long wavelength and a low frequency can be reduced.

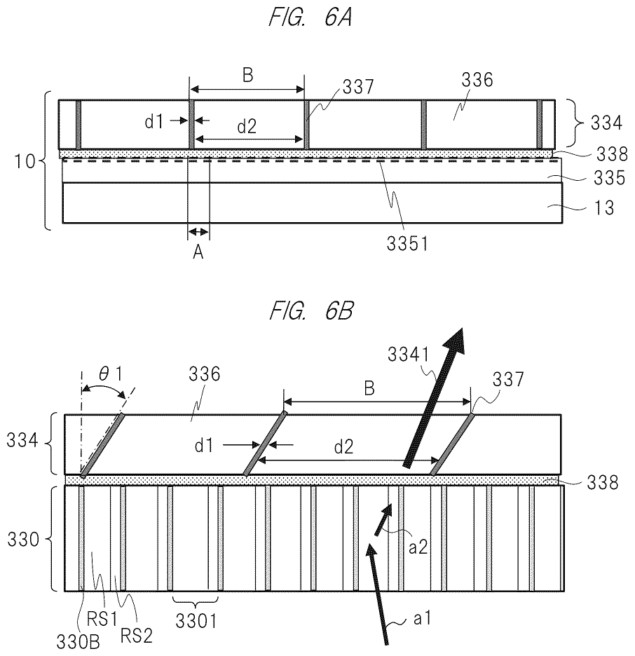

FIG. 6A illustrates a vertical cross-sectional view of the video display apparatus 10 having a configuration in which the video light control sheet 334 is arranged on a video light emitting surface 3351 of a liquid crystal display panel 335. The video light control sheet 334 is made of the light transmitting portions 336 and the light absorption portions 337 that are alternately arranged on the main plane, and is adhesively fixed to the video light emitting surface 3351 of the liquid crystal display panel 335 by an adhesive layer 338.

In addition, as described above, when a WUXGA liquid crystal display panel of 7 inches (1920×1200 pixels) is used as the video display apparatus 10, even if one pixel (corresponding one triplet) (illustrated with “A” in the drawing) is about 80 μm, the ghost images 332 and 333 formed on both sides of the air floating video 331 in FIG. 4A can be reduced by the following configuration. For example, as the pitch B of the video light control sheet 334, a pitch B made of a distance d2 of the light transmitting portion 336 of 300 μm and a distance d1 of the light absorbing portion 337 of 40 μm is set to 340 μm. In this case, the ghost image can be reduced by the video light control sheet 334 causing the sufficient transmission property and the control for the divergence property of the video light emitted from the video display apparatus 10 that causes the abnormal light. In this case, when a thickness of the video light control sheet 334 is ⅔ of the pitch B or more, the ghost reduction effect is significantly improved.

FIG. 6B is a vertical cross-sectional view of a configuration in which the video-light emitting surface of the retroreflector 330 (FIGS. 4A and 4B) is provided with the video light control sheet 334. The video light control sheet 334 is made of the light transmitting portions 336 and the light absorbing portions 337 that are alternately arranged, and inclines by a predetermined inclination angle θ1 from the retroreflector 330 to match with the emission direction of the retroreflection light 3341. As a result, the video light control sheet 334 can absorb the abnormal lights R1 and R2 (FIG. 4B) generated by the above-described retroreflection, and on the other hand, can transmit the normal reflection light as the retroreflection light 3341 without loss.

In the retroreflector 330, a space 3301 corresponding to the retroreflection portion based on the above-described four-sided structure 330A (FIGS. 4A and 4B) is arranged. The space 3301 corresponding to the retroreflection portion is partitioned by the surface of the side wall 330B. The space 3301 includes, for example, the reflecting surface R1 and the reflecting surface R2. The light “a1” entering the retroreflector 330 from, for example, the lower side is reflected by, for example, the reflecting surface RS1 of the space 3301, and the reflection light “a2” is further reflected by, for example, the reflecting surface RS2, and is emitted to the upper side of the retroreflector 330. The emitted light enters the video light control sheet 334, and is emitted as retroreflection light 3341.

When a WUXGA liquid crystal display panel of 7 inches (1920×1200 pixels) is used, even if one pixel (corresponding one triplet) is about 80 μm, the ghost images 332 and 333 formed on both sides of the air floating video 331 can be reduced by the configuration in FIG. 4A. For example, as illustrated in FIG. 6B, as the pitch B of the video light control sheet 334, a pitch B made of a distance d2 of the light transmitting portion 336 of the retroreflector 330 of 400 μm and a distance d1 of the light absorbing portion 337 of 20 μm is set to 420 μm. In this case, the ghost image can be reduced by the video light control sheet 334 causing the sufficient transmission property and the control for the divergence property of the video light emitted from the video display apparatus 10 that causes the abnormal light in the retroreflector 330.

On the other hand, the above-described video light control sheet 334 also prevents external light emitted from the outside from entering the air floating video display apparatus, and therefore, leads to improvement of reliability of the components. For the video light control sheet 334, for example, a viewing-angle control film (VCF) manufactured by Shin-Etsu Polymer Co., Ltd., is suitable. A structure of the VCF has a sandwich structure in which transparent silicon and black silicon are alternately arranged while the light entering/emitting surface is provided with a synthetic resin. Therefore, the above-described effect can be expected when the VCF is applied as the video light control sheet 334 of the present embodiment.

### [Technique for Sensing Operation on Air Floating Video]

The user (may be also referred to as user, operator, viewing person, or the like) is bidirectionally connected to the air floating video display apparatus 1 through the air floating video 3 (FIG. 2 and the like) formed by the air floating video display apparatus 1. In other words, by viewing and operating the air floating video 3, the user uses an application of the air floating video display apparatus 1, such as a function as a telephone in which a numeric keypad or the like is displayed as the air floating video. Therefore, there is a need for a sensing technique for sensing a virtual operation of the air floating video 3 operated by the user. An example of this sensing technique will be described below with respect to specific examples. The “sensing technique” described here includes the aerial operation detection sensor 1351 and the aerial operation detector 1350 described with reference to FIG. 2, and is a technique for detecting the user's operation (in other words, aerial operation) particularly in a three-dimensional space. The aerial operation detection sensor 1351 and the aerial operation detector 1350 may be referred to as a sensing system.

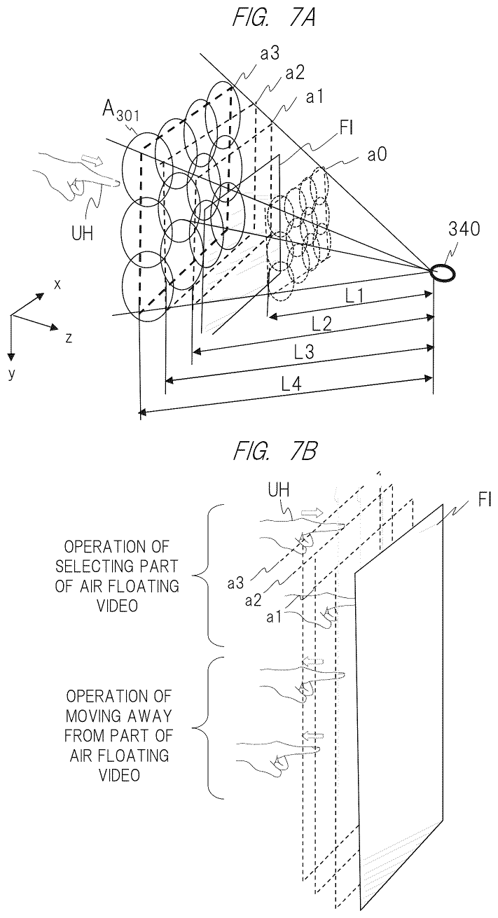

FIG. 7A illustrates a principle diagram for explaining the first sensing technique. As illustrated in FIG. 7A, each of the sensing areas a0, a1, a2, and a3 for an air floating video FI is divided into a plurality of areas (in other words, regions). In the present embodiment, each of the sensing areas a0, a1, a2, and a3 is vertically and horizontally divided into twelve areas of “3×4-12”. In FIG. 7A, a plane of the air floating video FI is illustrated as the x-y plane, and a front-back direction of the plane is illustrated as a “z” direction. For example, an illustrated area A301 is one upper left area of the sensing plane a3.

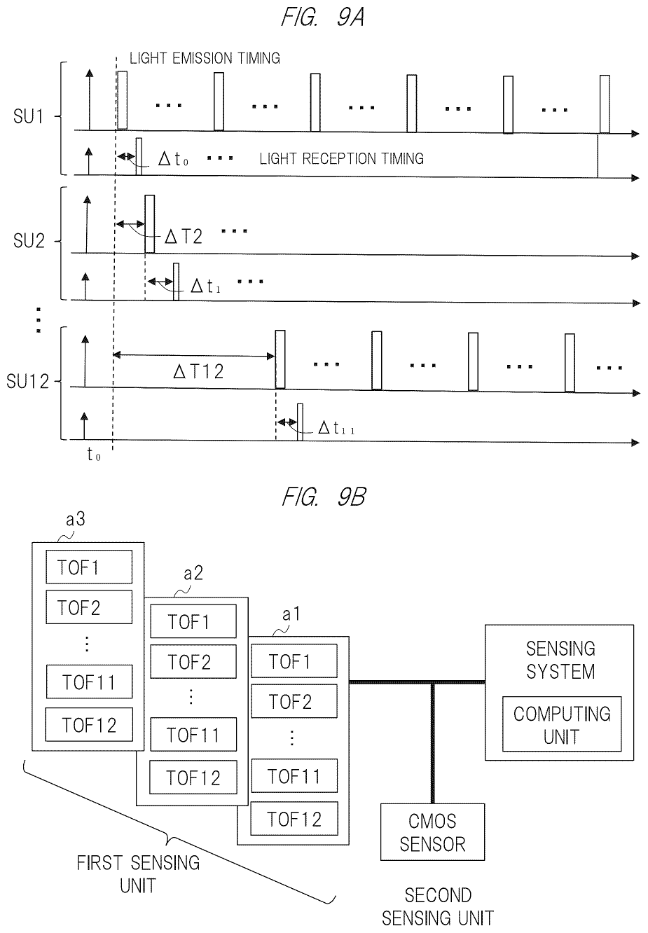

In the first sensing technique, a first ranging apparatus 340 including a time of flight (TOF) system corresponding to each area of the air floating video FI is provided. The first ranging apparatus 340 is provided instead of the aerial operation detection sensor 1351 of FIG. 2. A near-infrared light emitting diode (LED) that is a light source is caused to emit light from a light emitter of the first ranging apparatus 340 in synchronization with a signal of the system. A light emission side of the LED is provided with an optical element for controlling the divergence angle, and a pair of high-sensitivity avalanche diodes (ABD) having picosecond time resolution as light receivers are aligned in four vertical columns and three horizontal rows so as to correspond to the twelve areas. A phase shift that is a temporal shift between the light emission timing and the light reception timing, more specifically, Δt0 to Δt11 in FIGS. 9A and 9B described later are caused to correspond to time taken from the light emission of the LED that is the light source in synchronization with the signal from the system through the reflection of the light by the object (here, the tip of the user's hand finger UH) to be measured in distance to the return of the reflection light to the light receiver.

A computing unit of the sensing system illustrated in FIG. 9B receives the signal from the system and the signal generated by the avalanche diode that is the light receiver of the first ranging apparatus 340, and calculates the phase shift from these signals to calculate the distance to the object. The distance is calculated for each TOF system (TOF1 to TOF12) corresponding to each area. As measurement hierarchies of the ranging apparatus 340, FIG. 7A illustrates sensing planes a3, a2, and a1 (may be also referred to as a first sensing plane a3, a second sensing plane a2, and a third sensing plane a1) to be nearer in the z direction to the object (hand finger UH) in this order with respect to the plane of the air floating video FI, and further illustrates a sensing plane a0 to be farther from the air floating video FI. A distance L1 indicates a distance to the sensing plane a0, a distance L2 indicates a distance to the sensing plane a1, a distance L3 indicates a distance to the sensing plane a2, and a distance L4 indicates a distance to the sensing plane a3.

Next, the sensing system recognizes a direction of movement of the object (hand finger UH) by recognizing which area of the twelve areas the object has passed in each of the measurement hierarchies (sensing planes a3 to a1), and calculating the movement time at each of the measurement hierarchies by the above-described method.

FIG. 9A illustrates the light emission timing of the LED light source and the light reception timing of the light receiver for each of the twelve measurement areas. Terms “SU1” to “SU12” indicate light emission timing and light reception timing for each sensing unit corresponding to each area and TOF. As illustrated in FIG. 9A, the time difference between the light emission timing and the light reception timing in the sensing unit SU1 is Δt0, the time difference between the light emission timing and the light reception timing in the sensing unit SU2 is Δt1, and the time difference between the light emission timing and the light reception timing in the sensing unit SU12 is Δt1l. Here, the sensing system unifies individual pieces of data by delaying the light emission timing of the LED for each of the twelve measurement areas.

Practically, it is assumed that the user intentionally reaches the hand finger UH toward the air floating video FI to be desirably bidirectionally connected to the system. In this case, the sensing system obtains, for example, a first sensing signal S1 sensed in the area A301 on the sensing plane a3 farthest from the air floating video FI, for example, a second sensing signal S2 sensed in a specific area of the sensing plane a2, and, for example, a third sensing signal S3 sensed in a specific area of the third sensing plane a1. The sensing system obtains a contact position with the air floating video FI from calculation using the moving direction of the hand finger UH and the time difference in the crossing at each sensing plane, based on these sensing signals (S1 to S3).

In order to acquire the position information with higher accuracy, the sensing plane a0 at a position far away from the air floating video FI in a depth direction is set. The sensing system detects the passage of the hand finger UH through the air floating video FI as an end signal based on the sensing at the sensing plane a0, and obtains a contact point with the air floating video FI as three-dimensional coordinates from position coordinates of this sensing and the above-described two sensing signals.

Furthermore, FIG. 7B illustrates an operation of selecting a part of the air floating video FI by the user's hand finger UH (particularly, fingertip) and an operation of moving the user's hand finger UH away from the part of the air floating video FI. As illustrated in FIG. 7B, the first sensing technique provides the following state when the user makes the contact with the desired position coordinates of the air floating video FI, and then, returns the hand finger UH. That is, the sensing system sequentially transmits the first sensing signal S1 sensed at the first sensing plane a1, the second sensing signal S2 sensed at the second sensing plane a2, and the third sensing signal S3 sensed at the third sensing plane a3 to the computing unit of the sensing system, and performs calculation processing. As a result, the system recognizes that the user's hand finger UH has moved away from the specific coordinates of the air floating video FI.

Next, a more accurate sensing technique for virtually operating the air floating video will be described below.

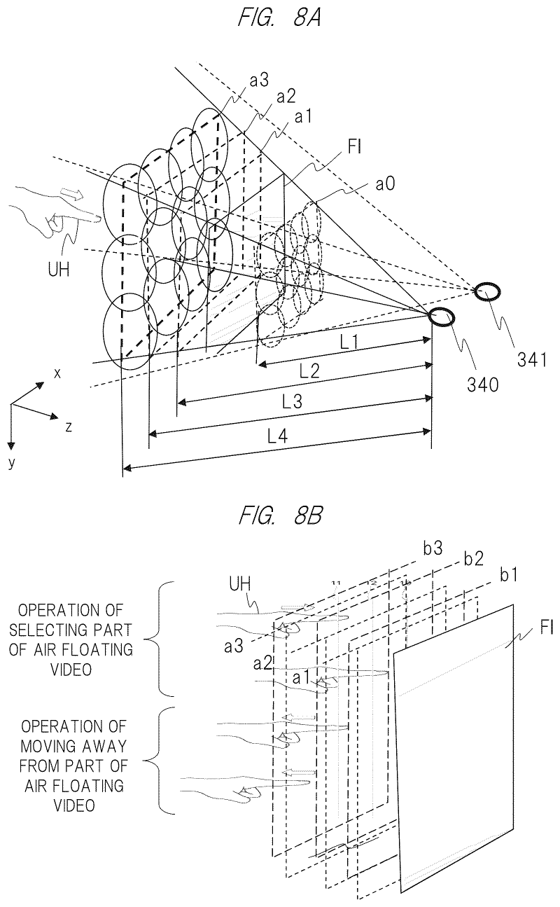

FIG. 8A illustrates a principle diagram for explaining the second sensing technique. The second sensing technique is different from the first sensing technique illustrated in FIG. 7A in that a second ranging apparatus 341 is arranged in addition to the first ranging apparatus 340 to achieve the more accurate sensing. In the second sensing technique, the second ranging apparatus 341 (particularly, a CMOS sensor) is used as the second sensing system in combination with the first sensing system using the first ranging apparatus 340. As illustrated in FIG. BA, the second ranging apparatus 341 performs sensing while targeting a range (sensing planes a1, a2, a3, a0) as similar to that of the first ranging apparatus 340.

As described above, the first ranging apparatus 340 includes a TOF system corresponding to each of the plurality of areas divided into, for example, twelve areas in the air floating video FI (the sensing system in FIG. 9B is referred to as first sensing system). On the other hand, to the second ranging apparatus 341, a two-dimensional image sensor such as a ¼-inch CMOS sensor for sensing camera is applied. An aspect ratio of the CMOS sensor is generally 3:4. Therefore, in the present embodiment, in accordance with the aspect ratio of the CMOS sensor, the sensing area of the TOF system of the first ranging apparatus 340 is also divided into twelve areas in total that are three areas in the vertical direction and four areas in the horizontal direction as described above.

In addition, although resolution of even about 1 million pixels is sufficient for resolution of the CMOS sensor, it is not necessary to provide an RGB color separation filter as different from a normal camera system. Therefore, in viewpoint of the same number of pixels, the CMOS sensor can achieve not only downsizing and high sensitivity but also achieve high sensitivity to near-infrared light. Therefore, in the second sensing technique, the object (the tip of the hand finger UH) to be measured in distance by the light-source light of the TOF system of the first ranging apparatus 340 is illuminated at the timing determined for each area, and therefore, the detection accuracy is significantly improved. Although not described in detail, FIG. 9B illustrates the above-described system as a functional block diagram.

FIG. 8B illustrates the sensing planes a1, a2, and a3 measured by the first ranging apparatus 340 and sensing planes b1, b2, and b3 measured by the second ranging apparatus 341 to correspond to the sensing planes. And, FIG. 8B illustrates an operation of selecting a part of the air floating video FI by the hand finger UH or an operation of moving it away from the part with respect to the sensing planes.

As illustrated in FIG. 8B, the air floating video display apparatus using the second sensing technique provides the following state when the user intentionally reaches the hand finger UH toward the air floating video FI. In this case, three-dimensional information based on the second ranging apparatus 341 is provided in addition to the three-dimensional information based on the first ranging apparatus 340 described above. The in-plane resolution of the sensing plane b3 of the second ranging apparatus 341 corresponding to the sensing plane a3 of the first ranging apparatus 340 farthest from the air floating video FI can be accurate in accordance with the resolution of the used CMOS sensor. Similarly, the sensing plane b2 corresponds to the sensing plane a2, and the sensing plane b1 corresponds to the sensing plane a1. As a result, it is possible to achieve a sensing system having the significantly improved in-plane resolution.

At this time, regarding the moving direction of the hand finger UH, a contact position with the air floating video FI is obtained from calculation using the time difference in the crossing at each sensing plane of the first ranging apparatus 340 and the second ranging apparatus 341. In order to acquire the position information with higher accuracy, the sensing plane a0 away in the depth direction from the air floating video FI is set. The sensing system can detect the passage of the hand finger UH through the air floating video FI as an end signal, and calculate the contact point with the air floating video FI as three-dimensional coordinates with higher definition from the position coordinates on the sensing plane a0 and the above-described two sensing signals.

In addition, when the frame rate of the CMOS sensor is increased from 1/20 seconds to 1/30 seconds or 1/120 seconds, the plane information captured per unit time increases in addition to the detection accuracy in the plane direction, and therefore, the resolution is significantly improved. At this time, the detection information based on the second sensing technique and the position information based on the first sensing technique are systematized by a synchronization signal supplied from the system.

Furthermore, as illustrated in FIG. 8B, when the user returns the hand finger UH after contacting the desired position coordinates of the air floating video FI, the first sensing signal S1 sensed on the first sensing plane a1, the second sensing signal S2 sensed on the second sensing plane a2, and the third sensing signal S3 sensed on the third sensing plane a3 are sequentially transmitted to the computing unit of the sensing system as similar to the first sensing technique described above. Then, by the calculation processing in the computing unit, it is recognized on the system that the user's hand finger UH has moved away from the specific coordinates of the air floating video FI.

In the LED light source used in the TOF sensor of the first ranging apparatus 340 of the sensing system described above, the reduction in accuracy of the ranging apparatus for the external light such as sunlight is prevented, and the near infrared light having high light energy in a region exceeding a visible light range (380 nm to 780 nm) that cannot be visually recognized with bare eyes is preferably used.

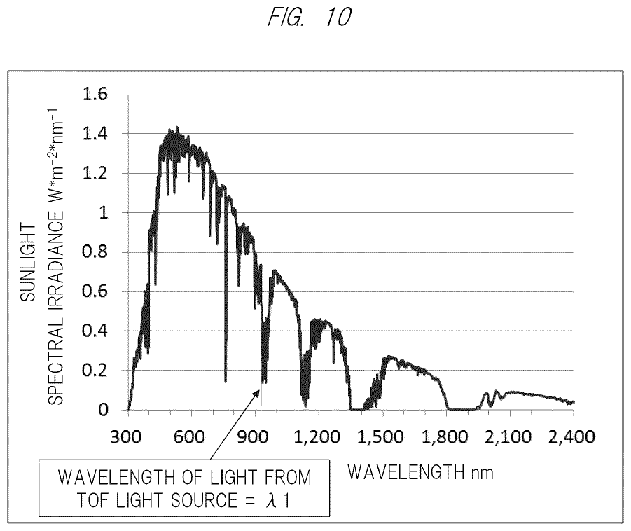

FIG. 10 illustrates a property diagram of spectral irradiance of sunlight. As a wavelength of the light-source light of the LED of the TOF sensor, light having a wavelength λ1 of 920 nm having a small energy of the spectral irradiance of sunlight illustrated in FIG. 10 may be used.

### <Second Configuration Example of Air Floating Video Display Apparatus>

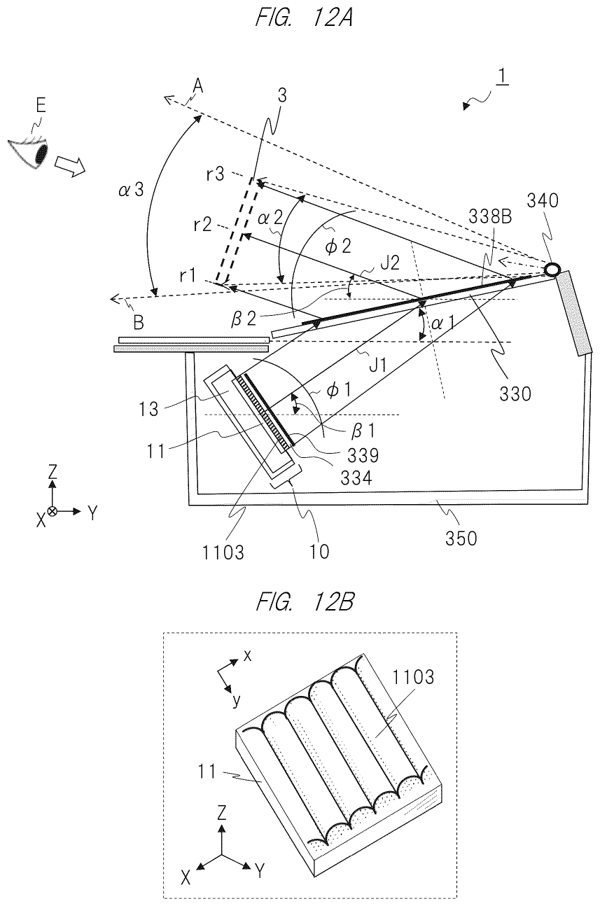

FIG. 12A illustrates a configuration of a principal part of the air floating video display apparatus 1 according to an embodiment. FIG. 12B is an enlarged view of a lenticular lens 1103 arranged on the video-light emission side of the video display apparatus 10 in FIG. 12A, that is, on the video-light emission side of the liquid crystal display panel 11. The air floating video display apparatus 1 illustrated in FIG. 12A is a system suitable for observation of the air floating video 3 from obliquely above by a user who is an observer (viewing person). In the coordinate system (X, Y, Z) in FIG. 12A, a housing 350 of the air floating video display apparatus 1 is arranged on a horizontal plane (X-Y plane), and the air floating video 3 is formed to slightly incline in the front-back direction (Y-direction) from the vertical direction (Z-direction). When the plane of the air floating video 3 is suitably visually recognized from a viewpoint E of the user while the user faces the air floating video 3, the viewpoint E is arranged on a slightly oblique upside in the Y-direction from the plane of the air floating video 3 in accordance with an optical axis J2 as illustrated in the drawing. The user can suitably visually recognize the air floating video 3 with a line of sight slightly obliquely downward in the Y-direction from the viewpoint E.

On the other hand, FIG. 12B is a diagram of viewing from a direction opposite to the direction of the light emitted from the liquid crystal display panel 11. As illustrated in FIG. 12B, the lenticular lens 1103 is arranged substantially parallel or parallel to the light emitting surface of the liquid crystal display panel 11, and is arranged on the video light side emitted from the surface of the liquid crystal display panel 11. Further, the plurality of semicylinders (semicylindrical lenses) of the lenticular lens 1103 are arranged to extend in a longitudinal direction when viewed from the X-Z plane. Note that the coordinate system (X, Y, Z) is common between FIGS. 12A and 12B.

In the housing 350, the video display apparatus 10 and the like are arranged in a predetermined positional relationship. An upper surface (X-Y plane) of the housing 350 has an opening, and the retroreflector 330 is arranged at a predetermined angle α1. An optical axis J1 of the video display apparatus 10 is directed obliquely upward at a predetermined angle β1 with respect to the Y-direction.

The video display apparatus 10 is made of a liquid crystal display panel 11 as a video display element and a light source 13 that generates light of a specific polarization wave having a narrow divergence property. To the liquid crystal display panel 11, panels each having a screen size ranging from a small screen size of about 5 inches to a large size excessing 80 inches are applicable, and the liquid crystal display panel is made of a panel selected from these panels. The video light from the liquid crystal display panel 11 is emitted toward the retroreflector 330 (also referred to as a retroreflection portion or a retroreflection plate) on the optical axis J1. Light from the light source 13 having a narrow divergence angle is made incident on the liquid crystal display panel 11. As a result, video light flux φ1 having a narrow divergence angle is generated. The video light flux φ1 having the narrow divergence angle is made incident on the retroreflector 330 from the lower side in the Z-direction to be along the optical axis J1. By the retroreflection in the retroreflector 330, video light flux φ2 having a narrow divergence angle is generated in the direction of the optical axis J2 on the upper side of the retroreflector 330 in the Z-direction, based on the principle described in FIGS. 4A and 4B. The air floating video 3 (air floating video 331 in FIGS. 4A and 4B) is provided at a predetermined position outside the housing 350 by the video light flux φ2. The optical axis J2 is directed obliquely upward at a predetermined angle θ2 from the Y-direction.

The air floating video 3 is formed at a position symmetric to the video display apparatus 10 across the retroreflector 330 serving as a symmetrical plane. The surface of the video display apparatus 10 and the surface of the air floating video 3 are arranged at substantially symmetrical positions or symmetrical positions across the obliquely arranged surface of the retroreflector 330. On the surface of the air floating video 3, “r2” indicates the center position corresponding to the optical axis J2, “r1” indicates the lower end position corresponding to the light ray at the lower end of the video light flux φ2, and “r3” indicates the upper end position corresponding to the light ray at the upper end of the video light flux φ2.

In this configuration, the emission side of the liquid crystal display panel 11 is provided with the video light control sheet 334 (specifically see FIGS. 5 and 6A described above) in order to erase the ghost image 332 or 333 generated by the retroreflector 330 described in FIGS. 4A and 4B to provide the high-quality air floating video 3. As a result, divergence properties in unnecessary directions are controlled.

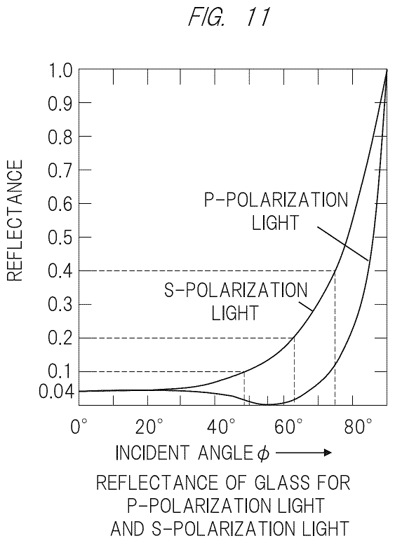

Further, as illustrated in FIG. 11, the reflectance of the video light from liquid crystal display panel 11 can be increased by a reflector member such as the retroreflector 330 in principle, and therefore, a S-polarization wave (electromagnetic wave having an electric field component vertical to the light entering surface, “S” is an abbreviation of Senkrecht) may be used. However, if the user uses polarization sunglasses, the air floating video 3 is reflected or absorbed by the polarization sunglasses. Therefore, in order to take measures against this, it is preferable to use a P-polarization wave (electromagnetic wave having an electric field component parallel to the light entering surface, “P” is an abbreviation of parallel). For this purpose, an illustrated depolarizing element 339 is provided as an element that optically converts a part of the video light of the specific polarization wave into the other polarization wave to be virtually converted into natural light. For example, the emission side of the video light control sheet 334 is provided with the depolarizing element 339. As a result, even if the user uses the polarization sunglasses, the user can view the favorable air floating video 3.

As commercially available products of the depolarizing element 339, COSMOSHINE SRF (manufactured by Toyobo Co., Ltd) and a depolarizing adhesive (manufactured by Nagase (sangyo) & Co., Ltd) are exemplified. In the case of COSMOSHINE SRF (manufactured by Toyobo Co., Ltd), when an adhesive is adhered on the video display apparatus, the reflection on the interface can be reduced to improve the luminance. In addition, in the case of the depolarizing adhesive (manufactured by Nagase (Sangyo) & Co., Ltd), the depolarizing adhesive is used so that a colorless transparent plate and the video display apparatus are adhered to each other through the depolarizing adhesive.

Furthermore, in the present embodiment, the image emitting surface of the retroreflector 330 is also provided with a video light control sheet 338B (the same as the video light control sheet 338, specifically see FIG. 6B described above). As a result, the ghost images 332 and 333 (FIGS. 4A and 4B) generated on both sides of the normal image of the air floating video 3 due to the unnecessary light are erased.

In the configuration of the present embodiment, the retroreflector 330 inclines at the predetermined angle α1 from the horizontal axis (Y-direction), and the air floating video 3 is generated in the oblique direction from the horizontal axis (particularly, to incline at an angle closer to the vertical plane than the horizontal plane). The present invention is not limited thereto, and the position and inclination of the arrangement of the air floating video 3 can be designed by changing the arrangement of the components.

Furthermore, in the present embodiment, the first ranging apparatus 340 (FIGS. 7A and 7B) is mounted at a predetermined position of the housing 350. That is, a sensing technique similar to that in FIGS. 7A and 7B is mounted on this system. As a result, a system is configured to allow the user to access and interact with the air floating video 3. The first sensing system including the first ranging apparatus 340 detects the state of the operation (aerial operation) performed with the user's hand finger or the like on the air floating video 3. Further, as similar to FIGS. 8A, 8B, and 9B, the second sensing system including the second ranging apparatus 341 may be added.

An attachment position and a viewing angle α3 of the first ranging apparatus 340 may be appropriately selected so as to sufficiently cover the size of the air floating video 3. In the present example, the first ranging apparatus 340 is attached at an illustrated position of the housing 350, the position being on the back side of the depth direction in the Y-direction (deeper than the positions of the user and the air floating video 3), being on the extension of the inclined surface of the retroreflector 330 in the depth direction and being slightly away so as not to block the video light flux of the video light. In the present example, the viewing angle α3 (range from the upper end A to the lower end B) of the first ranging apparatus 340 is set to a sufficiently wide viewing angle so as to be able to cover a region including the entire air floating video 3 and the user's face who is visually recognizing it from the viewpoint E of the reference position (facing position). The viewing angle α3 includes the viewing angle α2 covering the entire air floating video 3. The viewing angle α2 corresponds to, for example, the sensing planes a0, a1, a2, and a3 in FIGS. 7A and 7B.

As illustrated in FIGS. 7A and 7B (or FIGS. 8A and 8B), a ranging system in which the sensing plane of the air floating video 3 is divided into a plurality of areas is used as the TOF sensor of the first ranging apparatus 340. As a result, the resolution of each sensing region is improved. Furthermore, when the second sensing technique using the CMOS sensor as illustrated in FIGS. 8A, 8B and 9B is used, the detection accuracy can be further improved.

Furthermore, in the present embodiment, a light source that diverges visible light having a narrow-angle directionality is used as the light source 13, and the first ranging apparatus 340 (and the second ranging apparatus 341) is arranged at a position outside the video light flux of the narrow angle on the housing 350 side. In addition, the second ranging apparatus 341 may be similarly arranged. As a result, it is possible to eliminate an adverse effect on the sensing accuracy of the video light forming the air floating video 3.

In the above configuration illustrated in FIG. 12A, the lenticular lens 1103 is arranged on the video-light emission side (the position indicated by hatching) of the liquid crystal display panel 11. More specifically, the lenticular lens 1103 is arranged on the video-light emission side of the liquid crystal display panel 11 in the direction illustrated in FIG. 12B. On a surface (here, an x-y plane) of the lenticular lens 1103, the semicylindrical lenses extending in the y direction (longitudinal direction) are arranged as the plurality of semicylindrical lenses in the x direction (lateral direction). The x direction corresponds to the in-screen horizontal direction of the display panel 11, and the y direction corresponds to the in-screen vertical direction of the display panel 11. Because of this configuration, as described later, when the user moves toward (x direction, X-direction) the arrangement positions of the semicylindrical lenses forming the lenticular lens 1103, the user can view different images (or videos) from the respective positions. That is, the motion parallax is generated by displaying the parallax image as the image or the video, and the image or the video displayed on the liquid crystal display panel 11 can be recognized as the three-dimensional image. The multi-viewpoint video and the motion parallax will be described later.

In FIG. 12A, since the air floating video 3 is an actual image formed at a symmetrical position of the video display apparatus 10 or the liquid crystal display panel 11 across the retroreflector 330 that is the symmetrical plane, the user can visually recognize the air floating video 3 as a three-dimensional image with motion parallax. That is, according to the above-described configuration provided with the lenticular lens 1103, the air floating video 3 can be displayed as not simply a two-dimensional video displayed on the liquid crystal display panel 11 but the three-dimensional image with motion parallax.

### <Third Configuration Example of Air Floating Video Display Apparatus>

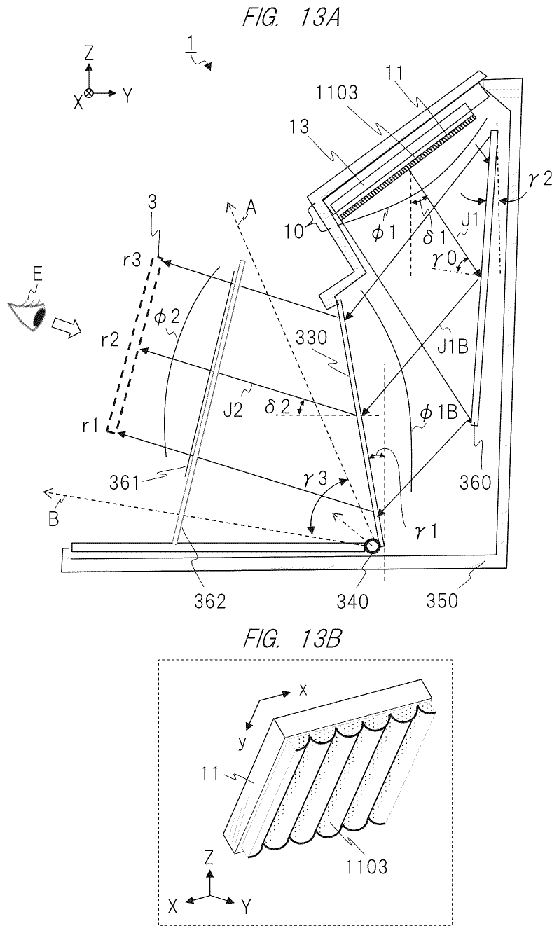

FIG. 13A illustrates another embodiment of the air floating video display apparatus. FIG. 13B is an enlarged view of a lenticular lens 1103 arranged on the video-light emission side of the video display apparatus 10 in FIG. 13A, that is, on the video-light emission side of the liquid crystal display panel 11. In the coordinate system (X, Y, Z) in FIG. 13A, the housing 350 of the air floating video display apparatus 1 is arranged on the horizontal plane (X-Y plane), and the air floating video 3 is formed to slightly incline in the front-back direction (Y-direction) from the vertical direction (Z-direction). When the plane of the air floating video 3 is suitably visually recognized from the viewpoint E of the user while the user faces the air floating video 3, the viewpoint E is arranged on a slightly oblique upside in the Y-direction from the plane of the air floating video 3 in accordance with an optical axis J2 as illustrated in the drawing. The user can suitably visually recognize the air floating video 3 with a line of sight slightly obliquely downward in the Y-direction from the viewpoint E.

On the other hand, in FIG. 13B, the lenticular lens 1103 is arranged substantially parallel or parallel to the light emitting surface of the liquid crystal display panel 11, and is arranged on the video light side emitted from the liquid crystal display panel 11. Further, the plurality of semicylinders (semicylindrical lenses) of the lenticular lens 1103 are arranged to extend in the longitudinal direction when viewed from the X-Z plane. Note that the coordinate system (X, Y, Z) is common between FIGS. 13A and 13B.

In the housing 350, the video display apparatus 10, a mirror 360 and the like are arranged in a predetermined positional relationship. The retroreflector 330 is arranged in an opening portion of the housing 350 such as an opening portion having a plane (X-Z plane) that stands substantially in the vertical direction in the present embodiment, at an angle γ1 (angle slightly obliquely inclining downward) from the Z direction. The mirror 360 is a plane mirror.

In the present embodiment, the video light from the video display apparatus 10 is reflected by the mirror 360, and then, is made incident on the retroreflector 330. The housing 350 has a portion protruding upward in the Z-direction, and the video display apparatus 10 is arranged in the portion. The optical axis J1 of the video display apparatus 10 faces downward in the Z-direction, backward in the Y-direction, and obliquely downward at a predetermined angle 61 from the Z-direction.

The video display apparatus 10 is made of the liquid crystal display panel 11 as the video display element and the light source 13 that generates the light of the specific polarization wave having the narrow divergence property. To the liquid crystal display panel 11, panels each having a screen size ranging from a small screen size of about 5 inches to a large size excessing 80 inches are applicable, and the liquid crystal display panel is made of a panel selected from these panels. The video light from the liquid crystal display panel 11 is turned back on the optical axis J1 by the mirror 360 that is an optical-path turning-back mirror, and is emitted toward the retroreflector 330 on an optical axis J1B after the turning back.

The light having the narrow divergence angle from the light source 13 is made incident on the liquid crystal display panel 11. As a result, the video light flux φ1 having the narrow divergence angle is generated. The video light flux φ1 having the narrow divergence angle is reflected by the mirror 360, and then, becomes the video light flux φ1B. The video light flux φ1B having the narrow divergence angle is made incident along the optical axis J1B on the retroreflector 330 from the right side in the Y-direction in the drawing. By the retroreflection in the retroreflector 330, the video light flux φ2 having the narrow divergence angle is generated in the direction of the optical axis J2 on the left side of the retroreflector 330 in the Y-direction in accordance with the principle described in FIGS. 4A and 4B. By the video light flux φ2, the air floating video 3 (air floating video 331 in FIGS. 4A and 4B) is formed at a predetermined position outside the opening portion of the housing 350. The optical axis J2 is directed obliquely upward at a predetermined angle δ2 from the Y-direction (an angle “90 degrees −δ2” from the Z-direction).

The air floating video 3 is formed at a substantially symmetrical position to the mirror 360 across the retroreflector 330 that is the symmetrical plane. In the configuration of the present embodiment, the optical path is turned back by the mirror 360, and therefore, the video display apparatus 10 is arranged above the air floating video 3 in the Z-direction. As a result, it is possible to achieve a system that forms the obliquely-inclined air floating video 3 as illustrated in the drawing by making the video light flux incident on the retroreflector 330 from the obliquely upside and emitting it obliquely upward.

Furthermore, imaging the air floating video 3 obliquely upward (on the optical axis J2 in the drawing) with respect to the housing 350 can be achieved by inclination arrangement of the retroreflector 330 at the predetermined angle γl from the vertical axis (Z-direction) of the bottom surface of the housing 350 as illustrated in the drawing. In addition, as a result of the configuration in which the emission axis of the retroreflector 330 inclines slightly obliquely downward as described above, it is possible to prevent the reduction in the image quality of the air floating video 3 that may be caused by the entering of the external light into the retroreflector 330 which results in the entering of it into the housing 350.

In order to provide the air floating video 3 with higher image quality by erasing the ghost images (FIGS. 4A and 4B) that may be caused in the air floating video 3, as similar to the second configuration example (FIGS. 12A and 12B), also in the present embodiment, the emission side of the liquid crystal display panel 11 may be provided with the video light control sheet 334 (FIGS. 5 and 6A) to control the divergence property in the unnecessary direction. Further, the image emitting surface of the retroreflector 330 may be also provided with the video light control sheet 334 (FIG. 6B) to erase the ghost images formed on both sides of the normal image of the air floating video 3 due to the unnecessary light.

Since the above-described structure is arranged inside the housing 350, it is possible to prevent the external light from entering the retroreflector 330, and to prevent the formation of the ghost images.

Also in the present embodiment, as the video light from the liquid crystal display panel 11, the S-polarization wave may be used as similar to FIG. 12A. Alternatively, for supporting the polarization sunglasses, the depolarizing element 339 may be arranged while using the P-polarization wave.

In the present embodiment, the retroreflector 330 inclines at the predetermined angle γl from the vertical axis (Z-direction), and the air floating video 3 is formed in the oblique direction from the horizontal axis (particularly, to incline at an angle closer to the vertical plane than the horizontal plane). The present invention is not limited to this, and the position and inclination of the arrangement of the air floating video 3 can be designed and adjusted by changing the arrangement of the components.

Furthermore, in the present embodiment, the first ranging apparatus 340 (FIGS. 7A and 7B) is mounted at a predetermined position of the housing 350. That is, a sensing technique similar to that in FIGS. 7A and 7B is mounted on this system. As a result, a system is configured to allow the user to access and interact with the air floating video 3. The first sensing system including the first ranging apparatus 340 detects the state of the operation (aerial operation) performed with the user's hand finger or the like on the air floating video 3.

An attachment position and a viewing angle γ3 of the first ranging apparatus 340 may be appropriately selected so as to sufficiently cover the size of the air floating video 3. In the present example, the first ranging apparatus 340 is attached at an illustrated position of a bottom portion of the housing 350, the position being near the front side of the retroreflector 330 in in the Y-direction and being slightly away so as not to block the video light flux of the video light. In the present example, the viewing angle γ3 of the first ranging apparatus 340 is set to a sufficiently wide viewing angle so as to be able to cover a region including the entire air floating video 3 and the user's face who is visually recognizing it from the viewpoint E of the reference position. The viewing angle γ3 includes the viewing angle covering the entire air floating video 3.

In addition to the first sensing system including the first ranging apparatus 340, the second sensing system including the second ranging apparatus 341 (particularly, a CMOS sensor) may be added as similar to FIGS. 8A, 8B, and 9B.

Furthermore, in the present embodiment, a light source that diverges visible light having a narrow-angle directionality is used as the light source 13, and the first ranging apparatus 340 (and the second ranging apparatus 341) is arranged at a position outside the video light flux of the narrow angle on the housing 350 side. As a result, it is possible to eliminate an adverse effect on the sensing accuracy of the video light forming the air floating video 3.

Furthermore, in the present embodiment, as illustrated in the drawing, a capacitive touch panel 361 may be fixed and arranged between the air floating video 3 and the retroreflector 330 by a support member 362. The support member 362 has, for example, a frame shape to support the touch panel 361 inside. The support member 362 is fixed to, for example, a bottom surface portion of the housing 350. The touch panel 361 is made of a member that transmits video light for forming the air floating video 3 and light from the first ranging apparatus 340.

The touch panel 361 detects a proximity state of the user's hand finger to a surface of the touch panel by using a capacitance system. Alternatively, the touch panel 361 detects a contact state of the user's hand finger onto a surface of the touch panel. By combination use of a third sensing technique including the touch panel 361 with the first sensing technique or the like, the detection accuracy can be further improved. A size and an attachment position of the capacitive touch panel 361 may be similarly selected so as to sufficiently cover the air floating video 3.

For example, a projected capacitance system is applicable to the touch panel 361 of the capacitance system that can capture highly accurate position information. The touch panel of this system is manufactured by, for example, using photolithography etching to make patterns of ITO which is a transparent electrode (Y-axis electrode) having a fine line-to-line distance and a copper thin film which is a transparent electrode (X-axis electrode) having a fine line-to-line distance on both surfaces of a transparent glass substrate. Therefore, when an object (for example, fingertip end) approaches this transparent glass substrate, each of the X-axis electrode and the Y-axis electrode detects change of the capacitance, and relative coordinates of the object are provided. In this system, the shorter the line-to-line distance of the transparent electrode is, the higher the resolution is provided, and therefore, multipoint detection can be performed. Therefore, this system achieves simultaneous input with a plurality of fingers.

Also, in the above-described configuration illustrated in FIG. 13A, as illustrated in FIG. 13B, the lenticular lens 1103 is arranged on the video-light emission side (the position indicated by oblique line) of the liquid crystal display panel 11 as similar to the air floating video display apparatus 1 illustrated in FIG. 12A. On a surface (here, the x-y plane) of the lenticular lens 1103, semicylindrical lenses extending in the y direction (longitudinal direction) are arranged as a plurality of semicylindrical lenses in the x direction (lateral direction). Because of this configuration, the user can recognize the air floating video 3 as the three-dimensional image with motion parallax. That is, according to the above-described configuration provided with the lenticular lens 1103, it is possible to display not simply the two-dimensional video displayed on the liquid crystal display panel 11 but the three-dimensional image as the air floating video 3.

Here, particularly if the displayed three-dimensional image is a person (particularly, a face), the fact that the user can recognize the air floating video 3 as the three-dimensional image leads to a new effect that is not provided by a related-art system in which the air floating video is the two-dimensional plane. For example, as described later, if the user exists around the air floating image, this manner leads to a new effect that always directs the person (particularly, a face) displayed as the air floating video to the user even when existing at any position. This manner makes the user feel as if the person displayed as the air floating video speak only to the user, and this state is particularly suitable for, for example, a scene where the displayed person explains something to the user or performs some assistance (support) to the user.

### [Technique for Generating/Displaying Multi-Viewpoint Video]

As described above, it is well known that the motion parallax is provided by the multi-viewpoint image or the multi-viewpoint video using the lenticular lens. The lenticular lens is aggregation of semicylindrical-shaped lenses (semicylindrical lenses) on a surface of the lenticular lens that are arranged to extend in a predetermined direction, and a liquid crystal display panel that displays different videos corresponding to the number of viewpoints of the multi-viewpoint image or the multi-viewpoint video is arranged below one semicylindrical lens. The predetermined direction (direction in which the axis of the semicylindrical lens extends) in the present embodiment (the second configuration example in FIGS. 12A and 12B or the third configuration example in FIGS. 13A and 13B) is the longitudinal direction (y direction) as described above.

FIG. 14A is a diagram illustrating a principle for generating the multi-viewpoint image using the lenticular lens 1103 in the present embodiment (the second configuration example and the third configuration example). FIG. 14B is a schematic view of the lenticular lens 1103 as viewed from obliquely upside in order to more clearly understand the configuration of the lenticular lens 1103. Here, note that a case of nine viewpoints as the multi-viewpoint image will be described. In FIG. 14A, as pixels 1401 of the liquid crystal display panel 11, nine pixels 1401 denoted by numbers 1 to 9 are grouped into one group, and form the multi-viewpoint image of the nine viewpoints. In FIG. 14A, the number of the pixels 1401 that can be viewed as an image for the observer's eyes is indicated by 1 to 9, and may be referred to as pixels 1 to 9. In FIG. 14B, the lenticular lens 1103 includes a plurality of lenses (semicylindrical lenses) 1103a repeatedly arranged in the X-direction.

On the other hand, it is known that a distance between human eyes, that is a distance between pupils, is almost constant, and, for example, an average pupillary distance PD of Japanese people is about 64 mm. When the pitch of the lenticular lens 1103, that is an arrangement interval between the semicylindrical lenses 1103a, is set to be substantially the same as a half of the distance between the human eyes, such as about 32 mm, light from different pixels 1401 reaches the right eye and the left eye of the observer (user) as illustrated in FIG. 14A. More specifically, light from the image displayed on the pixel 6 reaches the right eye of the observer, and light from the image displayed on the pixel 4 reaches the left eye of the observer.

For this reason, the observer views the images displayed on the different pixels 1401 with the right eye and the left eye, respectively. If an image provided by capturing an image of the same object or person while changing the viewpoint is displayed on each pixel 1401, the parallax occurs in both eyes of the observer. As a result, the observer can recognize the captured image as the three-dimensional image. As described above, in the configuration in which the lenticular lens 1103 is arranged on the light emission side of the liquid crystal display panel 11, the light from the different pixels 1401 reaches the right eye and the left eye of the observer, and therefore, the observer can recognize the three-dimensional image.

Here, when the observer (particularly, the face) moves left and right (X-direction), light from the pixel 1401 different from that before the movement reaches the right eye and the left eye of the observer. More specifically, as illustrated in FIG. 14A, when the observer moves rightward by one pixel, light from the image displayed on the pixel 7 reaches the right eye of the observer, and light from the image displayed on the pixel 5 reaches the left eye of the observer. That is, along with the movement (motion) of the observer, the light of the pixel 1401 different from that before the movement reaches the eyes. As a result, the observer can obtain an effect equivalent to that of viewing the same object or person from another angle, that is, motion parallax along with the right and left movement of the observer himself/herself. Therefore, in the configuration in which the lenticular lens 1103 is arranged on the light emission side of the liquid crystal display panel 11, it is possible to provide an effect equivalent to that of the viewing of the image with the three-dimensional texture while changing the angle by the movement of the observer's eyes.

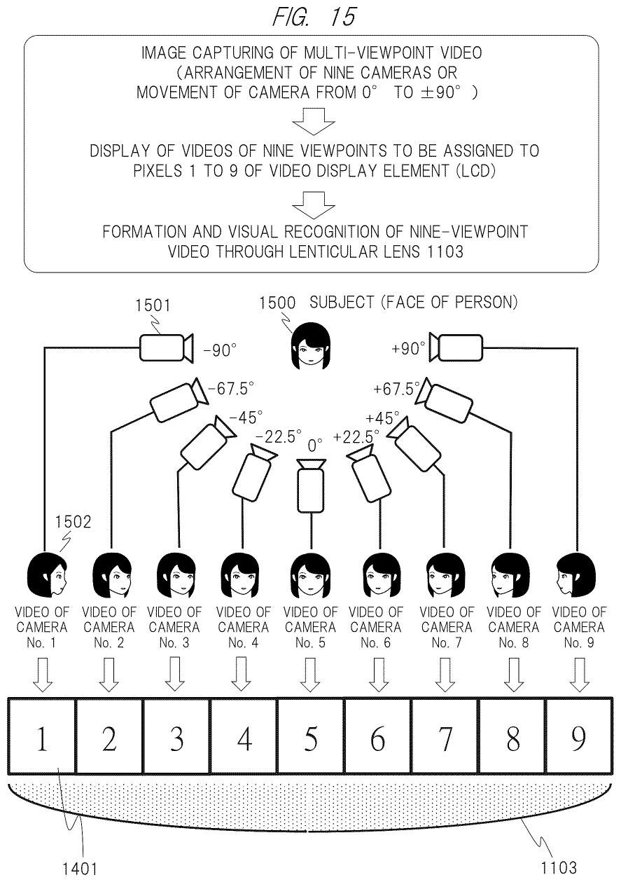

FIG. 15 is a schematic diagram illustrating an example of an apparatus for capturing an image for generating the motion parallax described above, that is, the multi-viewpoint image. FIG. 15 illustrates a state in which a person (particularly, a face portion of the person) that is a subject 1500 is captured from nine different viewpoints. More specifically, as illustrated in FIG. 15, the image is captured while arranging cameras No. 1 to No. 9 serving as nine cameras 1501 at positions on a semicircular line, that are positions having angles shifting from one another by a predetermined angle with a predetermined distance from the subject 1500. In the present embodiment, the cameras No. 1 to No. 9 are arranged at positions having angles shifting from one another by 22.5 degrees with the same distance from the subject 1500, in other words, arranged at nine positions obtained by dividing 180 degrees into eight. The present invention is not limited to this, and the distance and angle from the subject 1500 may be changed in accordance with the number of viewpoints.

In this case, when the subject 1500 is stationary, the multi-viewpoint image can be captured by sequentially moving one camera 1501 to the positions of the cameras No. 1 to No. 9. When the subject 1500 is a moving subject such as a face of a person who is speaking with moving his/her mouth while changing his/her facial expression, the nine cameras 1501 are used, and the image can be also captured as animation (in other words, moving image or video) while fixing the cameras 1501 at respective positions.

Respective images 1502 (or videos) captured by the nine cameras 1501 as described above are assigned and displayed on the nine respective pixels 1401 of the video display that is the liquid crystal display panel 11 in this case. As illustrated in FIG. 15, the multi-viewpoint image (or multi-viewpoint video) with motion parallax can be provided by the display of the video of one subject 1500 as the images 1502 (or videos) captured from different angles. In the example illustrated in FIG. 15, the image of the face portion of the person that is the subject 1500 is captured at different angles by the nine cameras No. 1 to No. 9, and the images 1502 captured by the nine cameras 1501 are assigned and displayed on the respective pixels 1401 (pixels 1 to 9) of the liquid crystal display panel 11.

Further, the lenticular lens 1103 is arranged on the light emission side of the liquid crystal display panel 11 to provide the multi-viewpoint image (or video) with motion parallax. The method of providing the multi-viewpoint image (or video) is not limited to the method using one or the plurality of cameras 1501 as described above, and a method of rendering the multi-viewpoint image (or video) by computer graphics (CG) may be used. Because of the rendering to form the CG, a large-scale image-capturing apparatus using a plurality of cameras is unnecessary, and the multi-viewpoint image (or video) can be more easily provided in a short time without restriction of the number of viewpoints due to the number of cameras, and this method is particularly suitable for forming the multi-viewpoint image or the multi-viewpoint video.

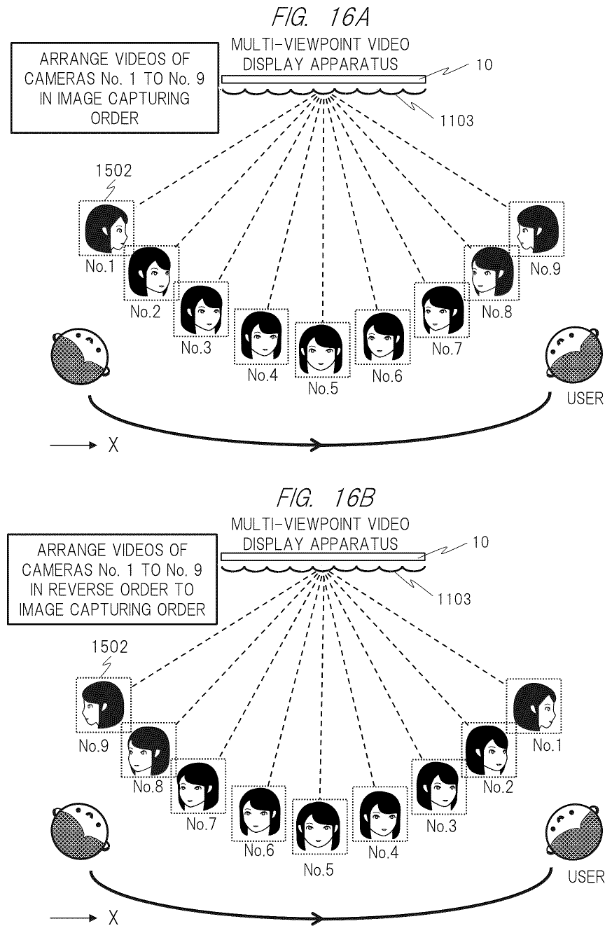

FIGS. 16A and 16B are diagrams illustrating a display example using the multi-viewpoint video display apparatus. Here, the multi-viewpoint video display apparatus means a display apparatus configured to include the lenticular lens 1103 arranged on the video-light emission side of the video display apparatus made of the liquid crystal display panel 11, the light source 13, and the like. Specifically, the multi-viewpoint video display apparatus includes the light source 13, the liquid crystal display panel 11 that is the video display, and the lenticular lens 1103. The video display apparatus 10 displays a video including at least two objects, and displays, as a multi-viewpoint image, a plurality of videos formed by fixing or shifting a position of any object of the at least two objects in the right-left direction (predetermined direction). That is, the video display apparatus 10 displays the video including at least two objects, and displays, as the multi-viewpoint image, a plurality of videos formed by fixing the position of any object (first object) of the at least two objects while shifting a position of other object (second objects) than the any object in the right-left direction between different multi-viewpoint images.

The right-left direction (predetermined direction) described here means a right-left direction (X-direction in FIGS. 14A and 14B) with respect to the viewpoint of the user, and corresponds to a direction in which the plurality of semicylindrical lenses 1103a of the lenticular lens 1103 are repeatedly arranged. Here, the video emitting surface of the liquid crystal display panel 11 as the video display and the entering surface of the lenticular lens 1103 are parallel to each other. The video emitting surface of the liquid crystal display panel 11 as the video display and the entering surface of the lenticular lens 1103 are arranged at a predetermined distance. In the present embodiment, the predetermined distance between the light entering surface of the lenticular lens 1103 and the light emitting surface of the liquid crystal display panel 11 is adjusted based on a focal length unique to the lenticular lens 1103. At this time, when the focal length of the lenticular lens 1103 is a relatively large value, the predetermined distance is increased. Conversely, when the focal length of the lenticular lens 1103 is a relatively small value, the distance between the light entering surface of the lenticular lens 1103 and the light emitting surface of the liquid crystal display panel 11, that is, the predetermined distance is adjusted so as to decrease the predetermined distance. As a result, a suitable multi-viewpoint video can be displayed.

FIGS. 16A and 16B illustrate a multi-viewpoint video display apparatus that displays the multi-viewpoint video having nine different viewpoints. FIG. 16A illustrates a case where the images 1502 formed by the cameras 1501 (No. 1 to No. 9) are arranged on the pixels 1401 (pixel 1 to 9) of the liquid crystal display panel 11 in the image-capturing order. On the other hand, FIG. 16B illustrates a case where the images 1502 formed by the cameras 1501 (No. 9 to No. 1) are arranged on the pixels 1 to 9 of the liquid crystal display panel 11 in an order opposite to that in FIG. 16A. The difference between the effects of FIGS. 16A and 16B is as follows. First, in FIG. 16A, when the user moves from the left side to the right side with respect to the multi-viewpoint video display apparatus, the user on the left side can observe an image of the subject (face of the person) viewed from the left side while the user on the right side can observe an image of the subject (face of the person) viewed from the right side. That is, the user observes the same subject as those when the user observes the subject from the left side or the right side.

On the other hand, in FIG. 16B, contrary to FIG. 16A, when the user (observer) moves from the left side to the right side with respect to the multi-viewpoint video display apparatus, the user on the left side can observe an image of the subject (face of the person) viewed from the right side of FIG. 16A while the user on the right side can observe an image of the subject (face of the person) viewed from the left side. As a result, in FIG. 16B, when the user views the object (face of the person), the user can feel that the line of sight of the person who is the subject is always directed toward the user even if the user exists at any position (relative angle) with respect to the subject.

The viewing state of FIG. 16B described above, that is, the feature in which the line of sight of the person who is the subject is apparently always directed toward the user regardless of the position of the user leads to an effect that makes the user feel that the person who is the subject always talks to (user) himself/herself while facing the user. Such an effect is particularly preferable in a scene where the person who is the subject gives some explanation or guidance to only the user.

Here, the multi-viewpoint video display apparatus using the lenticular lens often causes a problem of so-called reverse vision. As illustrated in FIG. 14A, when light from the image displayed on, for example, the pixel 6 reaches the right eye of the observer while light from the image displayed on, for example, the pixel 4 reaches the left eye of the observer, the observer can recognize the three-dimensional image. The reverse vision is a phenomenon in which the light from the pixel 4 reaches the observer's right eye although the light from the pixel 6 should reach the observer's right eye while the light from the pixel 6 reaches the observer's left eye although the light from the pixel 4 should reach the observer's left eye due to the positional relationship between the observer's eyes and the lenticular lens. When such reverse vision occurs, the observer cannot recognize the three-dimensional image to be originally observed.

The occurrence of the reverse vision can be effectively prevented by using the video display apparatus 10 including the liquid crystal display panel 11 as the video display element and the light source 13 having the narrow divergence property. More specifically, while the divergence angle of the lenticular lens for displaying the multi-viewpoint video is generally 40 degrees to 60 degrees (±20 to 30 degrees from the center), usage of the light source 13 having a narrow divergence property with a divergence angle of 30 degrees (±15 degrees from the center) as the light source of the video display apparatus 10, or usage of the video light control sheet 334 illustrated in FIGS. 6A and 6B can prevent the occurrence of the reverse vision, and is preferable.

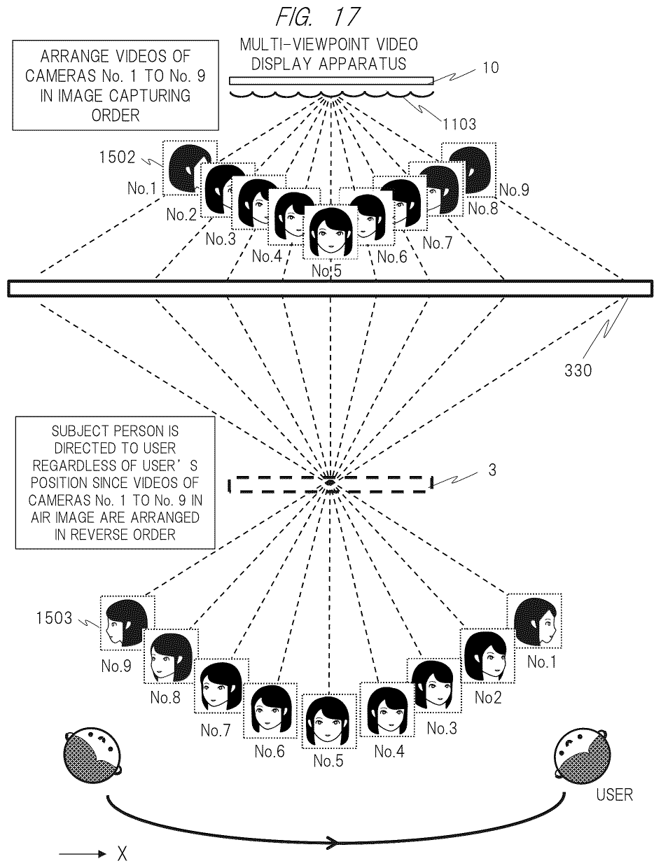

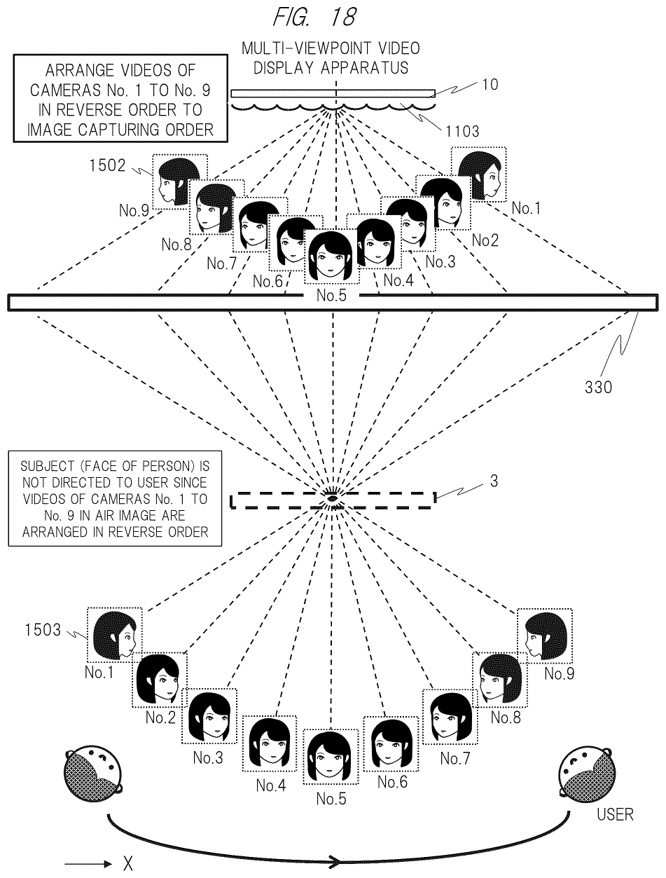

Next, each of FIGS. 17 and 18 is a diagram schematically illustrating a state in which the video light emitted from the multi-viewpoint video display apparatus including the lenticular lens 1103 illustrated in FIGS. 16A and 16B forms the air floating video 3 by the retroreflection plate (retroreflection portion, retroreflector) 330. FIGS. 17 and 18 are the same as each other in that the air floating video 3 is formed by the multi-viewpoint video display apparatus and the retroreflection plate 330.

The difference between the two embodiments of FIGS. 17 and 18 is that the order of the multi-viewpoint images on the multi-viewpoint video display apparatus is different. That is, FIG. 17 corresponds to FIG. 16A so that the images 1502 formed by the cameras No. 1 to No. 9 are assigned from left to right of the multi-viewpoint video display apparatus apparently for the user, in other words, assigned to the pixels 1 to 9 of the liquid crystal display panel 11. As a result, as the air floating video 3 formed by the retroreflection plate 330, the multi-viewpoint images 1503 corresponding to the images 1502 formed by the cameras No. 1 to No. 9 are displayed from right to left in the opposite order apparently for the user. On the other hand, FIG. 18 corresponds to FIG. 16B so that the images 1502 formed by the cameras No. 1 to No. 9 are assigned from right to left of the multi-viewpoint video display apparatus, in other words, assigned to the pixels 1 to 9 of the liquid crystal display panel 11. As a result, as the air floating video 3 formed by the retroreflection plate 330, the multi-viewpoint images 1503 corresponding to the images 1502 formed by the cameras No. 1 to No. 9 are displayed from left to right in the opposite order to FIG. 17 apparently for the user.

As described above, the user recognizes the air floating video 3 (multi-viewpoint image 1503) formed by the retroreflection plate 330 in the state in which the order of the multi-viewpoint videos displayed on the video display apparatus is opposite to the order of the multi-viewpoint videos based on the air floating video 3 because of the configuration with the arrangement of the lenticular lens 1103 between the video display apparatus 10 and the retroreflection plate 330. That is, when the air floating video 3 having motion parallax is provided to the user, the order of the images 1502 formed by the cameras No. 1 to No. 9 may be appropriately determined to arrange the images on the pixels 1401 on the liquid crystal display panel 11 in accordance with a purpose of what multi-viewpoint image is to be provided to the user.

### <First Example for Displaying Multi-Viewpoint Video as Air Floating Video>

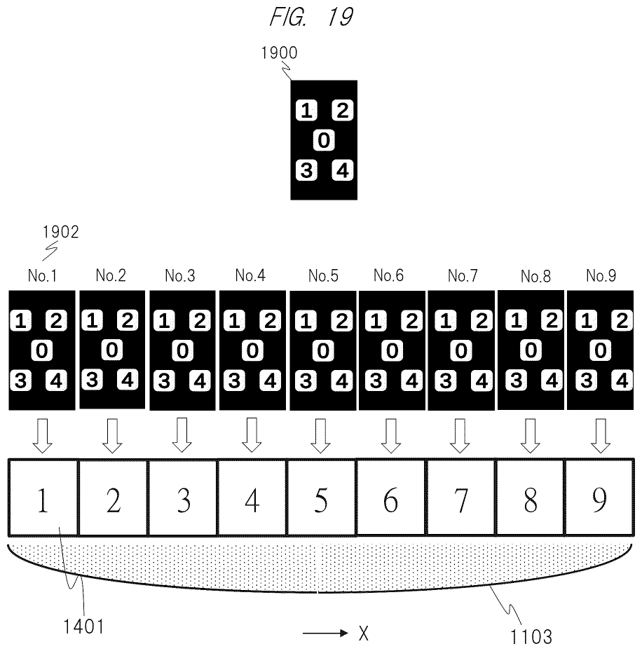

Next, a first example for displaying the multi-viewpoint image as the air floating video according to the present invention will be described. FIG. 19 is a diagram illustrating the first example for forming the multi-viewpoint image using the lenticular lens 1103 according to the present invention.

Here, FIG. 19 and FIG. 15 are compared with each other. First, in FIG. 15 described above, the image of the subject 1500 is captured by the nine cameras 1501 arranged at the positions having angles shifting from each other by a predetermined angle (specifically, 22.5 degrees) while separating from the subject 1500 (the face of a person) by a predetermined distance. As a result, the images 1502 formed by the cameras No. 1 to No. 9 which are the multi-viewpoint images are generated. The images 1502 formed by the cameras No. 1 to No. 9 are assigned to the pixels 1 to 9 that are the nine pixels 1401 of the liquid crystal display panel 11 to configure one pixel group. As illustrated in FIGS. 14A and 14B, one pixel group is made of the plurality of pixels 1401 within one lens 1103a of the lenticular lens group (the plurality of semicylindrical lenses 1103a) of the lenticular lens 1103.

On the other hand, FIG. 19 illustrates another method instead of the method of capturing the image of one subject from different angles to form the multi-viewpoint image. As an example, there is a case of formation of the multi-viewpoint image 1902 which is the nine images 1902 indicated by images No. 1 to No. 9 by fixing a position of a number 0 among five numbers 0, 1, 2, 3, and 4 in the subject 1900 while gradually shifting positions of the four numbers 1, 2, 3, and 4 from left to right in the X-direction. The formed images No. 1 to No. 9 are assigned to the pixels 1401 in one pixel group of the liquid crystal display panel 11.

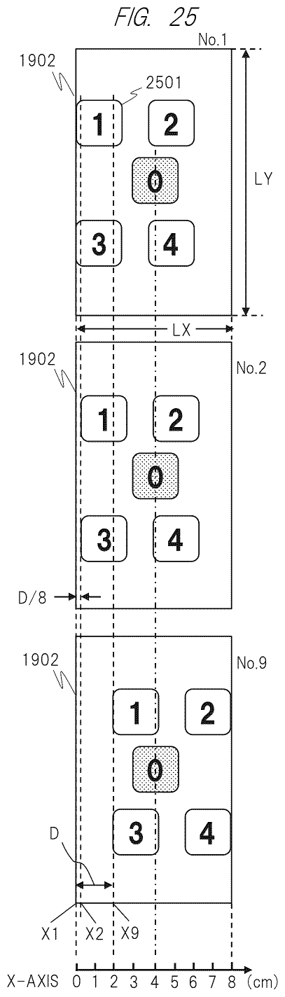

FIG. 25 is a supplementary explanatory diagram related to the formation of the multi-viewpoint image 1902 which is the nine images 1902 indicated by the images No. 1 to No. 9. Here, as the multi-viewpoint image 1902, only three of the image No. 1, the image No. 2, and the image No. 9 are illustrated with their positions in the X-direction aligned. For example, of the plurality of objects in the image No. 1, an object 2501 of the number 1 will be described as an object (second object) moving left and right in the X-direction. It is assumed that the object 2501 of the number 1 is moved from the leftmost position to the rightmost position in the X-axis direction. An X-axis position of the leftmost side of the object of the number 1 in the image No. 1 is assumed to be “X1”, and an X-axis position of the leftmost side of the object of the number 1 in the image No. 9 is assumed to be “X9”. A movement distance from the position X1 to the position X9 of the object 2501 of number 1 is assumed to be “D”. The unit movement distance (D/8) is obtained by dividing the movement distance D by eight corresponding to the number (9) of multi-viewpoint (9-viewpoint) images 1902. A position X2 of the object 2501 of the number 1 in the image No. 2 is a position moved by one unit movement distance (D/8) from the position X1 in the image No. 1. The X-axis positions of the left side of the object 2501 in the other images No. 3 to No. 9, that are the positions X3 to X9, can be similarly provided.

With reference to FIG. 25, the X-axis position of the object in each image will be described more specifically with reference to numerical values. If the size of the multi-viewpoint image 1902 that is the screen size of the video display apparatus 10 is, for example, 6.5 inches (so-called 6.5-type liquid crystal screen), the screen size in FIG. 25 has a vertical length “LY” of approximately 14.5 cm and a horizontal length “LX” of approximately 8 cm. At this time, in attention to the object (second object) moved left and right in the X-direction, that is, attention to the numbers 1 and 3 out of the numbers 1, 2, 3, and 4, the X-axis positions of the leftmost sides of the numbers 1 and 3 in the image No. 1 and the image No. 9 move from the position X1 to the position X9 as described above.

If it is assumed that the movement distance D from the position X1 to the position X9 is 2.0 cm as illustrated in FIG. 25, the distance between the position X1 and the position X2 is ⅛ of the movement distance D. In a specific numerical value, since the movement distance D=2.0 cm, the distance between the position X1 and the position X2 is “2.0 cm/8” that is 0.25 cm. Similarly, in the other images No. 3 to No. 9, the movement distances between adjacent images that are the distances between the position X2 and the position X3, between the position X3 and the position X4, between the position X4 and the position X5, between the position X5 and the position X6, between the position X6 and the position X7, between the position X7 and the position X8, and between the position X8 and the position X9 are each 0.25 cm.

On the other hand, in all of the images No. 1 to No. 9, the object of the number 0 is an object (first object) whose position is unchanged, and the position of the number 0 does not change on the images No. 1 to No. 9. As illustrated in FIG. 25, the X-axis position of the center of the object of the number 0 is always fixed at a position of 4.0 cm.

As described above, in the images No. 1 to No. 9, the multi-viewpoint image (the 9-viewpoint image in the example of FIG. 25) can be generated by the object (the second object) whose position in the X-axis direction changes and the object (the first object) whose position in the X-axis direction is unchanged.

When the multi-viewpoint image 1902 of the subject 1900 is formed, note that the example of FIG. 19 and the like show that the plurality of images 1902 are assigned to only one pixel group associated with one cylindrical lens 1103a (FIGS. 14A and 14B). However, the present invention is not limited thereto, and the multi-viewpoint image 1902 of the subject 1900 can be made of a plurality of adjacent pixel groups.

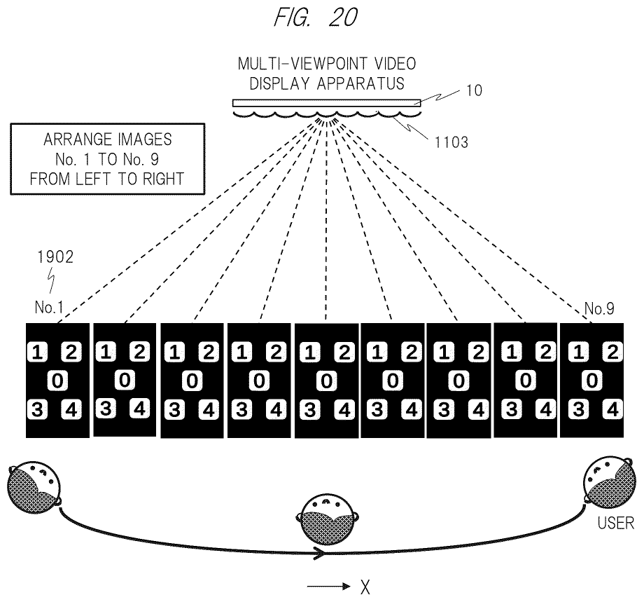

Next, FIG. 20 is a diagram illustrating that the motion parallax can be provided by fixing the position of the number 0 (first object) for the pixel 1 to 9 of the liquid crystal display panel 11 as described above while gradually moving the numbers 1 to 4 (second object) simply from left to right by a predetermined distance as illustrated in FIG. 25 to form the multi-viewpoint image 1902, and besides, by arranging the lenticular lens 1103 on the video-light emission side of the liquid crystal display panel 11. That is, when the viewpoint of the illustrated user moves from left to right in the X-direction, the position of the number 0 as the image apparently does not change while the numbers 1 to 4 as the image apparently move from left to right. As a result, for the user, the number 0 apparently exists at a relatively far position (back side) while the numbers 1 to 4 apparently exist at relatively near positions (front side).

A phenomenon in which the number 0 apparently exists at the relatively far position (back side) while the numbers 1 to 4 apparently exist at the relatively near positions (front side) for the user as described above, in other words, a phenomenon making the user feel the sense of perspective or the three-dimensional texture can be explained as the following physical phenomenon analogy. That is, this can be explained from a phenomenon in which, for a passenger on a train who is looking at outside scenery through a window of the running train, a position of a distant object such as mountain or cloud does not change while a position of a near object such as building or field significantly changes depending on a speed of the train.

In consideration of the analogy with the scenery viewed through the window of the running train as described above, the mountain or cloud existing at the far position corresponds to the number 0 in FIG. 20. That is, even when the user moves from left to right or in the opposite direction, the position of the number 0 does not change. On the other hand, the building or field existing at the near position corresponds to the numbers 1 to 4 in FIG. 20. That is, when the user moves from left to right or in the opposite direction, the position of the number changes significantly. This produces an effect making the user feel the state in which the number 0 exists at the far position, that is, at a relatively far position, while the numbers 1 to 4 exist at the near positions, that is, at relatively near positions.

When the motion parallax is provided by the multi-viewpoint image as described above, it is not always necessary as the multi-viewpoint image to use the images 1502 captured by the cameras 1501 arranged at the different positions on the circumference as illustrated in FIG. 15, and the multi-viewpoint image can be formed by simply shifting the relative positions of the plurality of subjects (the numbers 0 to 4 of the subject 1900 in FIG. 19) in the right-left direction as illustrated in FIG. 19. In the subject 1900 in FIG. 19, the number 0 is an example of the first object whose position is fixed while the numbers 1 to 4 are an example of the second object whose position is shifted left or right.

Here, by the method illustrated in FIG. 19, that is, by the method of forming the multi-viewpoint image by simply shifting the relative positions of the numbers 0 to 4 in the right-left direction as the object (second object) in the same image, the multi-viewpoint image can be very easier to be formed than the method of forming the multi-viewpoint image by using the plurality of cameras 1501 arranged on the circumference illustrated in FIG. 15. Moreover, the method has a feature capable of providing the motion parallax for the plurality of objects (here, the numbers 0 to 4) displayed in one image.

FIG. 20 illustrates a display example using the multi-viewpoint video display apparatus made of the video display apparatus 10 and the lenticular lens 1103 and using the multi-viewpoint image 1902 formed by the method illustrated in FIG. 19. As described above, the user can obtain the motion parallax and can three-dimensionally view the displayed object by using the combination of the lenticular lens 1103 with the multi-viewpoint image 1902 formed by simply shifting the relative positions of the numbers 0 to 4 in the right-left direction. In the case of FIG. 20, when the user moves left and right in the X-direction, the number 0 apparently exists on the back side while the numbers 1 to 4 apparently exist on the front side.

### <Second Example for Displaying Multi-Viewpoint Video as Air Floating Video>

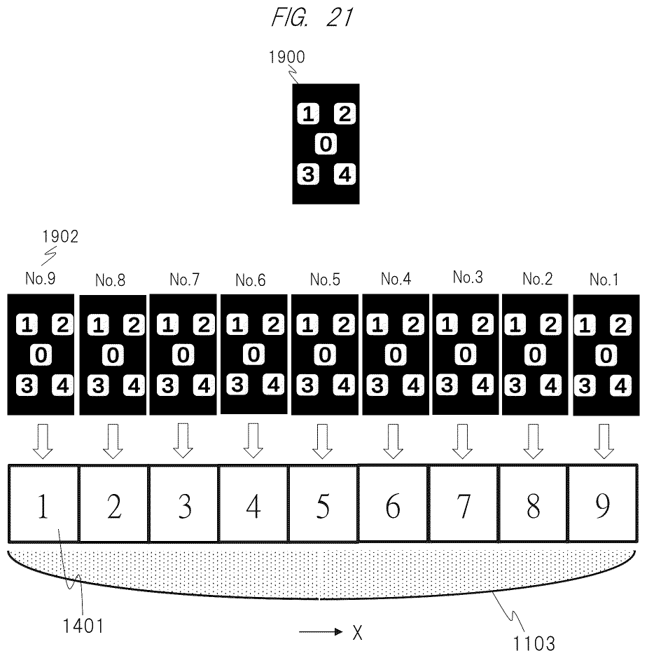

Next, as being opposite to the case of FIG. 19, FIG. 21 illustrates a case where the position of the number 0 among the five numbers 0, 1, 2, 3, and 4 in the subject 1900 is fixed while the positions of the four numbers 1, 2, 3, and 4 are gradually shifted from right to left to form the multi-viewpoint image 1902 which is the nine images 1902 indicated by images No. 1 to No. 9. The formed images No. 1 to No. 9 are assigned as one pixel group to the pixels 1 to 9 of the liquid crystal display panel 11.

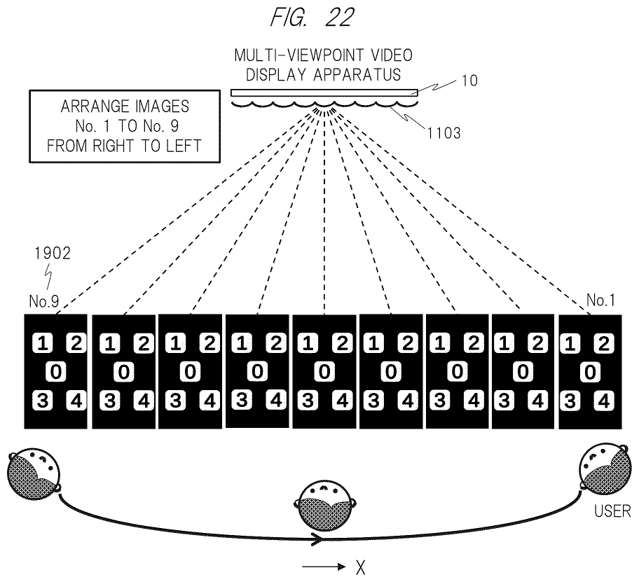

FIG. 22 is a diagram illustrating the state in which the user can obtain the motion parallax by the arrangement of the lenticular lens 1103 on the video-light emission side of the liquid crystal display panel 11 and by the formation of the multi-viewpoint image 1902 by fixing the position of the number 0 while gradually shifting the relative positions of the numbers 0 to 4 in the right-left direction for the pixels 1 to 9 as described above. That is, when the viewpoint of the illustrated user moves from left to right in the X-direction, the position of the number 0 does not change while the numbers 1 to 4 apparently move from right to left. In this case, as being opposite to FIG. 20, for the user, the number 0 apparently exists at a near position (front side) while the numbers 1 to 4 apparently exist at far positions (back side, deep side).

A phenomenon in which the number 0 apparently exists at the near position (front side) while the numbers 1 to 4 apparently exist at the far positions (back side) for the user as described above can be explained as the following physical phenomenon analogy. That is, in FIG. 22, when the user is on the left side, the numbers 1 to 4 apparently exist on the right side of the number 0 for the user. When the user is on the front side, the number 0 and the numbers 1 to 4 apparently exist on the same plane. Conversely, when the user is on the right side, the numbers 1 to 4 apparently exist on the left side of the number 0 for the user. In other words, for the user, the position of the number 0 always apparently remains at the reference position (center) while the numbers 1 to 4 always apparently exist at positions farther than the number 0 (back side, deep side).

That is, also in the cases of FIGS. 20 and 22, as similar to the cases of FIGS. 19 and 21, the positions of the number 0 and the numbers 1 to 4 in the depth direction apparently shift for the user since the position of the number 0 is fixed as the first object while the numbers 1 to 4 are arranged as the second object on the respective pixels 1 to 9 while being gradually shifted from left to right or from right to left. More specifically, in the case of FIGS. 19 and 20, the position of the number 0 apparently exists at the position farther than the numbers 1 to 4. Conversely, in the case of FIGS. 21 and 22, the position of the number 0 apparently exists at the position nearer than those of the numbers 1 to 4.

One of the points of the first example of the present invention lies in the above-described point. That is, in order to obtain the motion parallax by using the multi-viewpoint image, in the related-art technique, it is necessary to form the multi-viewpoint image by capturing the image of the subject at different angles from the position where the cameras are arranged on the circumference. On the other hand, in the first example of the present invention, one object among the plurality of objects apparently exists at a relatively farther position (back side) than another object while another object among the plurality of objects apparently exists at a relatively nearer position (front side) than the one object when the relative positions of the plurality of objects configuring the multi-viewpoint image simply linearly shift in a predetermined direction (right-left direction).

The second point of the first example of the present invention appears when the multi-viewpoint image 1902 formed as described above is further displayed as the air floating video 3.

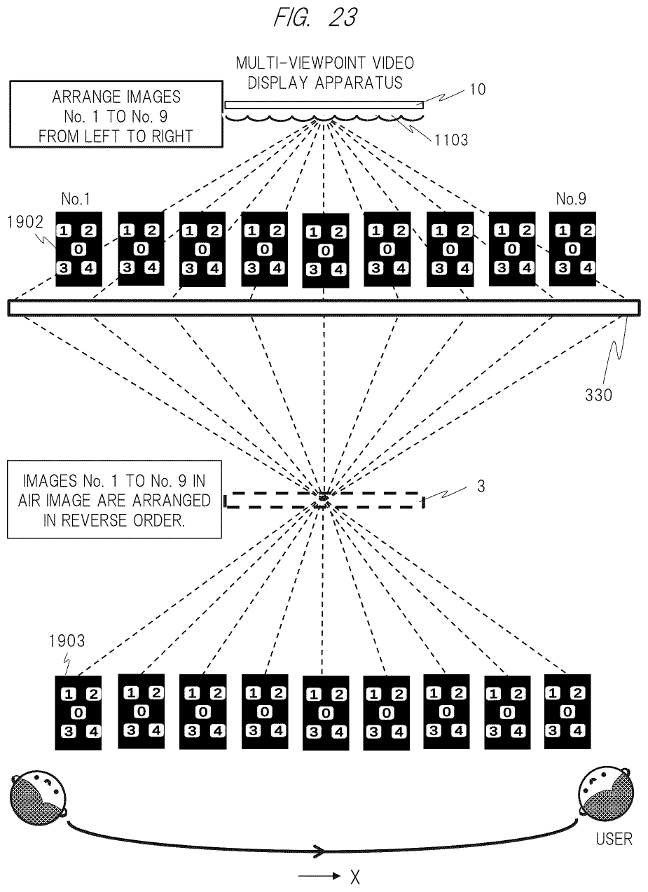

FIG. 23 is a diagram illustrating a state in which the multi-viewpoint image 1902 displayed by the multi-viewpoint video display apparatus made of the video display apparatus 10 and the lenticular lens 1103 illustrated in FIG. 20 is displayed as the air floating video 3 by the retroreflection plate 330. As described above with reference to FIGS. 17 and 18, the user recognizes the air floating video 3 formed by the retroreflection plate 330 in the state in which the right-left arrangement order of the multi-viewpoint images (which may be the multi-viewpoint videos) displayed by the video display apparatus 10 is opposite to the right-left arrangement order of the multi-viewpoint images based on the air floating video 3.

That is, as illustrated in FIG. 19, when the multi-viewpoint image 1902 is formed in the order in which the image No. 1 corresponds to the leftmost pixel 1, the image No. 2 corresponds to the pixel 2 right adjacent to the pixel 1, and the last image No. 9 corresponds to the rightmost pixel 9, the multi-viewpoint video display apparatus displays such a formed multi-viewpoint image 1902 as the air floating video 3 through the video display apparatus 10, the lenticular lens 1103, and the retroreflection plate 330 as illustrated in FIG. 23. In the video display apparatus 10 and the lenticular lens 1103, the images No. 1 to No. 9 are arranged in order from left to right in the X-direction. Then, the user recognizes the air floating video 3 so that the images No. 1 to No. 9 which are the multi-viewpoint images 1903 are arranged in the order opposite to the order in the video display apparatus 10 so that the image No. 1 apparently exists on the rightmost side, the image No. 2 apparently exists on the left side of the image No. 1, and the last image No. 9 apparently exists on the leftmost side for the user.

In the images No. 1 to No. 9 which are the multi-viewpoint images 1902 illustrated in FIG. 23, the position of the number 0 is fixed as the first object while the numbers 1 to 4 as the second object are arranged corresponding to the respective pixels 1 to 9 while being shifted in the right-left direction, that is, in the X-axis direction. Here, correspondence of the arrangement positions of the number 0 as the first object and the numbers 1 to 4 as the second object in the images No. 1 to No. 9 to the coordinates (X coordinates) on the X-axis illustrated in FIG. 25 can be represented as shown in the following Table 1.

TABLE 1

| | Image No. | | | | | | | | |
|---|---|---|---|---|---|---|---|---|---|
| | No. | No. | No. | No. | No. | No. | No. | No. | No. |
| | 1 | 2 | 3 | 4 | 5 | 6 | 7 | 8 | 9 |
| (1) X coordinates of Midpoint of “Number 0” | 4.0 | 4.0 | 4.0 | 4.0 | 4.0 | 4.0 | 4.0 | 4.0 | 4.0 |
| as First object on Multi-viewpoint image 1902 | | | | | | | | | |
| (2) X coordinates (X1 to X9) of Left side of | 0.0 | 0.25 | 0.50 | 0.75 | 1.00 | 1.25 | 1.50 | 1.75 | 2.00 |
| “Numbers 1 and 3” as Second object on Multi- | | | | | | | | | |
| viewpoint image 1902 | | | | | | | | | |

In Table 1, (1) the X coordinates of the midpoint of “number 0” as the first object on the multi-viewpoint image 1902 are the X coordinates of the central point of “number 0” as the display object, and the position of “number 0” is unchanged in any of the images No. 1 to No. 9. Therefore, these X coordinates always have the same value to be specifically 4.0. On the other hand, (2) the X coordinate of the leftmost side (hereinafter, referred to as left side) of “numbers 1 and 3” as the second object on the multi-viewpoint image 1902 corresponds to X1 to X9 illustrated in FIG. 25. Therefore, values of X1 to X9 are 0.0, 0.25, 0.50, 0.75, 1.00, 1.25, 1.50, 1.75, and 2.00, respectively, as shown in Table 1.

Note that the relative positional relationship between “numbers 2 and 4” and “numbers 1 and 3” among the objects in FIG. 23 is always constant. Therefore, Table 1 does not show specific X coordinates of “numbers 2 and 4”. However, in the example shown in FIG. 25, in the image No. 1, the position of the left side of the “numbers 1 and 3” coincides with X1, that is, the leftmost side of the image No. 1 itself. On the other hand, regarding the “numbers 2 and 4”, in the image No. 9, the position (X coordinate) of the right side of the “numbers 2 and 4” coincides with the X coordinates of the rightmost side of the image No. 9 itself.

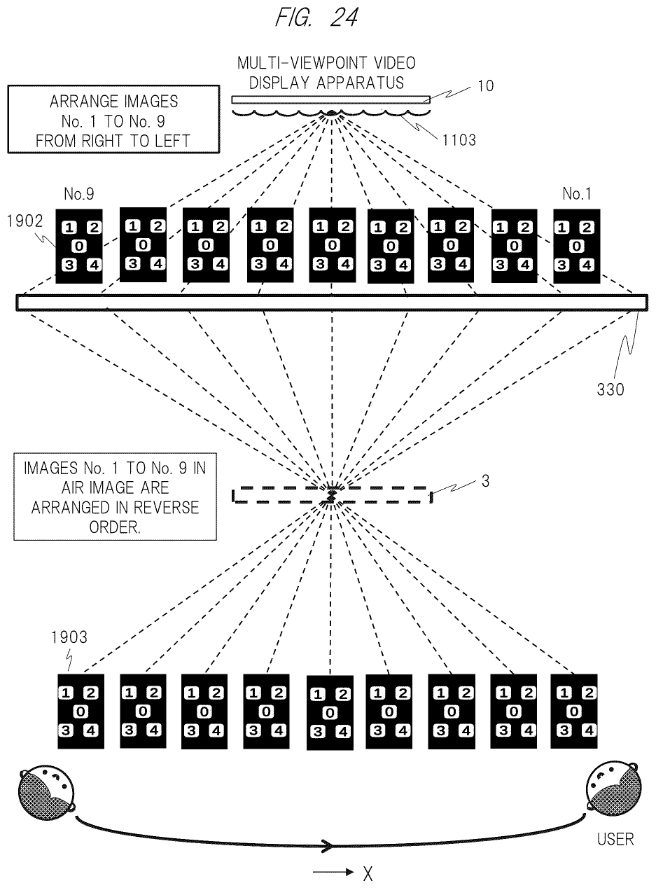

As described above, the position, that is the X coordinates, of each object displayed in the images No. 1 to No. 9 which are the multi-viewpoint image 1902 illustrated in FIG. 23 has been described with reference to the example in which the screen size is 6.5 inches. Note that FIG. 23 also shows a multi-viewpoint floating image 1903 that is an air floating video, in addition to the multi-viewpoint image 1902. As described in the description of FIG. 23, the multi-viewpoint image 1902 and the multi-viewpoint floating image 1903 are only in a relationship in which the right and left arrangement orders are opposite to each other, and the multi-viewpoint image 1902 and the multi-viewpoint floating image 1903 are exactly the same as each other in the relative positional relationship between the displayed objects. Therefore, the description of the X coordinates of each object (specifically, the numbers 0 to 4) regarding the multi-viewpoint floating image 1903 is omitted here. The same applies to FIG. 24 described below, and therefore, the repetitive description for the X coordinates of the numbers 0 to 4 of the multi-viewpoint image 1902 and the multi-viewpoint floating image 1903 is omitted.

As described above, in the embodiment illustrated in FIG. 23, the multi-viewpoint image 1903 recognized as the air floating video 3 by the user has the same arrangement order as the order illustrated in FIG. 22. That is, for the user who is recognizing (observing) the air floating video 3, the position of the number 0 apparently always remains at the reference position (center), and the numbers 1 to 4 apparently exist at a relatively farther position (back side, deep side) than the number 0.

Subsequently, FIG. 24 is a diagram illustrating a state in which the multi-viewpoint image 1902 displayed by the multi-viewpoint video display apparatus made of the video display apparatus 10 and the lenticular lens 1103 illustrated in FIG. 22 is displayed as the air floating video 3 by the retroreflection plate 330. Also in this case, as similar to FIG. 23, the user recognizes the air floating video 3 formed by the retroreflection plate 330 so that the right-left arrangement order of the multi-viewpoint image 1902 (which may be the multi-viewpoint video) displayed by the video display apparatus 10 is opposite to the right-left arrangement order of the multi-viewpoint image 1902 based on the air floating video 3.

The details in the middle are similar to those in the case of FIG. 23, and therefore, the detailed description thereof is omitted. However, in the embodiment illustrated in FIG. 24, the multi-viewpoint image 1903 recognized as the air floating video 3 by the user has the same arrangement order as the order illustrated in FIG. 20. That is, for the user who is recognizing (observing) the air floating video 3, the position of the number 0 apparently always remains at the reference position (center), and the numbers 1 to 4 apparently exist at a relatively nearer position (front side) than the number 0.

As described above with reference to FIGS. 23 and 24, the right-left arrangement order of the multi-viewpoint image 1902 displayed by the video display apparatus 10 and the right-left arrangement order of the multi-viewpoint image 1903 based on the air floating video 3 are recognized exactly in the opposite order by the user. More specifically, in the case of FIG. 23, the position of the number 0 apparently always remains at the reference position (center) while the numbers 1 to 4 apparently always exist at a relatively farther position (back side, deep side) than the number 0. On the other hand, in the case of FIG. 24, the position of the number 0 apparently always remains at the reference position (center) while the numbers 1 to 4 apparently always exist at a relatively nearer position (front side) than the number 0.

When it is desired to display the multi-viewpoint image 1903 as illustrated in FIG. 24 in the first state in which the objects of the numbers 1 to 4 are displayed on the front side, the air floating video display apparatus which is the multi-viewpoint video display apparatus may display the multi-viewpoint image 1902 as illustrated in FIG. 22 so that the arrangement order of the second object having the moving numbers 1 to 4 is in the opposite order (from right to left). Conversely, when it is desired to display the multi-viewpoint image 1903 as illustrated in FIG. 23 in the second state in which the objects of the numbers 1 to 4 are displayed on the back side, the multi-viewpoint image 1902 as illustrated in FIG. 20 may be displayed so that the arrangement order of the second object having the moving numbers 1 to 4 is in the forward order (from left to right).

That is, according to the first example of the present invention, for example, when a plurality of numbers is displayed as the object to be displayed as the air floating video 3, the multi-viewpoint image can be formed by not changing the position of an optional number among the plurality of numbers but relatively shifting the positions of the other numbers in the right-left direction. That is, the air floating video display apparatus for aerially forming the air floating video 3 is made of the video display apparatus 10 for displaying images of at least two objects, the lenticular lens 1103 arranged on the video-light emission side of the video display apparatus, and the optical member (retroreflector 330) for forming the video light emitted from the video display apparatus 10 as the aerially-formed air floating video 3. The video display apparatus 10 displays the object such as the push button corresponding to the number as the multi-viewpoint image obtained by simply moving it in the right-left direction apparently for the user.

When the user observes the formed air floating video 3, this manner results in an effect in which the relative positions of the objects (in this case, the push buttons corresponding to the numbers) in the depth direction, in other words, the positional relationship meaning the back side or the front side thereof apparently different. In other words, the depth texture or the three-dimensional texture can be provided to the air floating video 3. The object displayed as this image is not limited to the number, and may be any letter or figure.

Thus, according to the present embodiment, in the case of the display of the air floating video 3 as, for example, an HMI or a GUI showing the number as the push button (in other words, the number button), when the optional number button is touched (aerially operated) by the user, this case results in a new effect in which only the touched number button is apparently recessed to the back side while the other number buttons apparently remain stayed on the relatively front side under the display control. As the specific display control, the air floating video display apparatus may perform control to change the touched number button (for example, the object of the number 1) from the first state in which the touched number button is displayed on the front side as described above to the second state in which the touched number button is displayed on the back side.

The embodiments illustrated in FIGS. 23 and 24 show that the example (FIG. 23) in which the number 0 (first object whose position is fixed) is displayed on the front side with respect to the other numbers 1 to 4 (second object whose position is moved) and the example (FIG. 24) in which the other numbers 1 to 4 are displayed on the front side with respect to the number 0. The present invention is not limited to these examples. For example, one, two or more optional numbers among the numbers 0 to 9 can be displayed on the front side or the back side with respect to other numbers. Furthermore, in the above-described examples, the explanation has been made in the case where only two positions on the front side and the back side are provided as the positions of the object of the multi-viewpoint image in the depth direction. However, the present invention is not limited thereto, and the position of the object of the multi-viewpoint image in the depth direction can be similarly achieved as a multi-step position by designing the moving distance of the shifting of the image in a predetermined direction or the like.

As described above, the principle of the first example of the present invention has been described in the case of the numbers 0 to 4 as the object. However, as described above, the object displayed as the air floating video 3 is not limited to the number, and may be an optional letter or figure. Therefore, the application range of the first example of the present invention is wide. For example, the present invention can be also applied to a phone including the push buttons of the numbers 0 to 9, an enter button, a calling on/off button, and the like, and can also be applied to an elevator including number buttons representing the numbers of floors of the elevator and a door open/close button.

According to the first example of the present invention, the relative positions of the objects in the depth direction (meaning the front side or the back side) can be displayed to be different by simply linearly moving each object of a plurality of objects configuring the multi-viewpoint image in the right-left direction, which results in the formation of the plurality of images (for example, the image 1902 in FIG. 23) in which the positional relation among the objects is made different by the movement. Therefore, in the first example, the multi-viewpoint image can be formed by a simpler method than the related-art method for forming the multi-viewpoint image. Moreover, the invention brings effects for the user in which the user can reliably find presence or absence of an operation error because of three-dimensionally visually recognizing whether the button (object) operated by the user is reliably reacting, and besides, in which the user can safely operate an apparatus touched and operated particularly by a large number of unspecified users because of being able to operate the button as the air floating image.

### <Third Example for Displaying Multi-Viewpoint Video as Air Floating Video>

In the first and second examples, any case as illustrated in FIGS. 19 and 21 forms the nine images 1902 indicated by images No. 1 to No. 9 which are multi-viewpoint images by fixing the position of the number 0 among the five numbers 0, 1, 2, 3, and 4 in the subject 1900 and gradually shifting the positions of the four numbers 1, 2, 3, and 4 from left to right (FIG. 19) or conversely from right to left (FIG. 21).

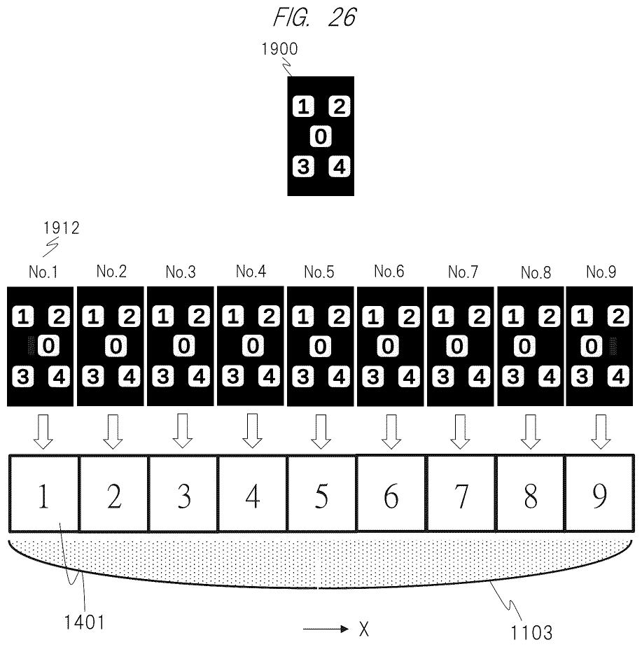

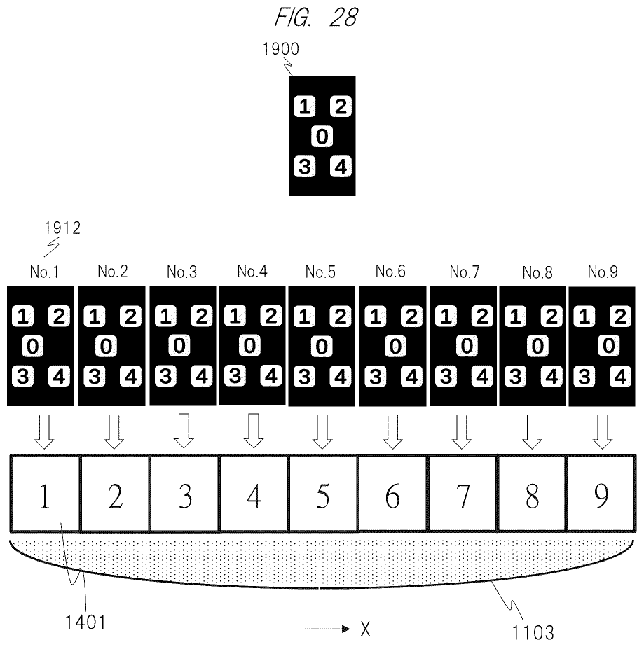

In the third example of the present invention, as being opposite to the first and second examples, the positions of the four numbers 1, 2, 3, and 4 among the five numbers 0, 1, 2, 3, and 4 in the images No. 1 to No. 9 are fixed as the first object, and only the position of the number 0 is moved with the number 0 as the second object. Specifically, as illustrated in FIG. 26, the nine images 1912 indicated by the images No. 1 to No. 9 which are multi-viewpoint images are formed by shifting the position of the number 0 in the X-direction from right to left in the order of the images No. 1 to No. 9, or conversely from left to right in the X-direction as illustrated in FIG. 28 by a predetermined distance.

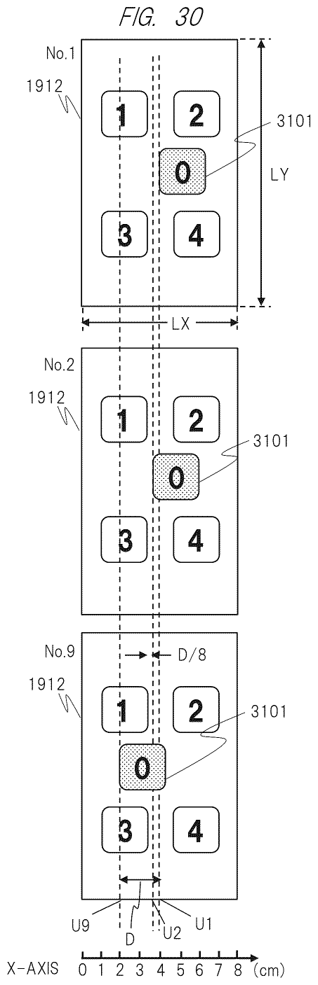

FIG. 30 is a supplementary explanatory diagram related to the formation of the nine images 1912 indicated by images No. 1 to No. 9 which are the multi-viewpoint image illustrated in FIG. 26. FIG. 30 shows the uniformed X-direction positions of only three images of image No. 1, image No. 2, and image No. 9 in FIG. 26 as the multi-viewpoint image 1912.

With reference to FIG. 30, an example will be described, the example showing that an object 3101 of the number 0 among the plurality of objects in the images No. 1, No. 2, and No. 9 moves from the right position to the left position in the X-axis direction as the object (second object) to be moved in the right-left direction in the X-direction. An X-axis position in a case in which the number 0 is on the rightmost side in the image No. 1 is assumed to be “U1”, and an X-axis position in a case in which the number 0 is on the leftmost side in the image No. 9 is assumed to be “U9”. In these cases, a movement distance from the rightmost position U1 to the leftmost position U9 is assumed to be “D”. The unit movement distance (D/8) is obtained by dividing the movement distance D by eight corresponding to the number (9) of multi-viewpoint (9-viewpoint) images 1902. A position U2 of the object 3101 of the number 0 in the image No. 2 is a position moved by one unit movement distance (D/8) from the position U1 in the image No. 1. The positions of the other images can be similarly provided. By this method, the position of the object of the number 0 in each of the images No. 1 to No. 9 is determined.

With reference to FIG. 30, the X-axis position of the object in each image will be described more specifically with reference to numerical values. If the size of the multi-viewpoint image 1902 that is the screen size of the video display apparatus 10 is, for example, 6.5 inches (so-called 6.5-type liquid crystal screen), the screen size in FIG. 30 has a vertical length “LY” of approximately 14.5 cm and a horizontal length “LX” of approximately 8 cm. At this time, in attention to the object (second object) moved left and right in the X-direction, that is, attention to the number 0, the X-axis position of the leftmost side of the number 0 moves from the position U1 to the position U9 as described above.

If it is assumed that the movement distance D from the position U1 to the position U9 is 2.0 cm as illustrated in FIG. 30, the distance between the position U1 and the position U2 is ⅛ of the movement distance D. In a specific numerical value, since the movement distance D=2.0 cm, the distance between the position U1 and the position U2 is “2.0 cm/8” that is 0.25 cm. Similarly, in the other images No. 3 to No. 9 not illustrated in FIG. 30, the movement distances between adjacent images that are the distances between the position U2 and the position U3, between the position U3 and the position U4, between the position U4 and the position U5, between the position U5 and the position U6, between the position U6 and the position U7, between the position U7 and the position U8, and between the position U8 and the position U9 are each 0.25 cm.

On the other hand, in all of the images No. 1 to No. 9, the objects of the numbers 1 to 4 are objects (first object) whose positions are unchanged, and the positions of the objects of the numbers 1 to 4 are always fixed at the same position.

As described above, in the images No. 1 to No. 9, the multi-viewpoint image (the 9-viewpoint image in the example of FIG. 30) can be formed by the object (the second object) whose position in the X-axis direction changes and the object (the first object) whose position in the X-axis direction is unchanged.

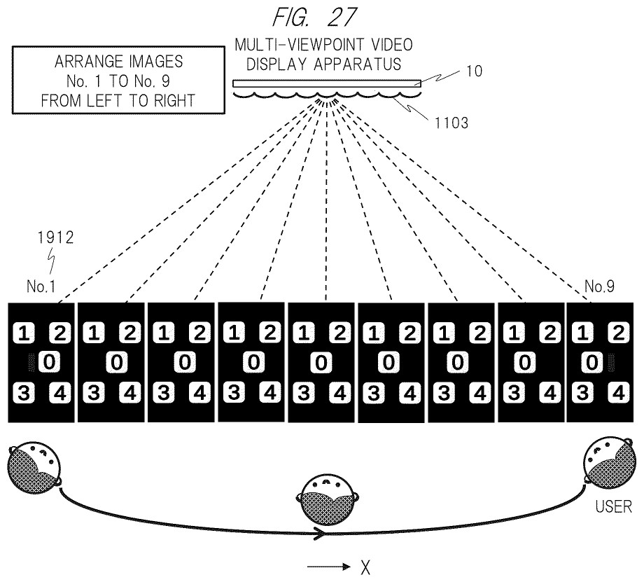

Next, FIG. 27 is a diagram illustrating that the motion parallax can be provided by fixing the positions of the numbers 1 to 4 (first object) for the pixels 1 to 9 arranged from left to right in the liquid crystal display panel 11 as described above while gradually moving the number 0 (second object) simply in an opposite direction to the X direction, that is, from left to right in the direction of the images No. 1 to No. 9 to form the multi-viewpoint image 1912, and besides, by arranging the lenticular lens 1103 on the video-light emission side of the liquid crystal display panel 11. That is, when the viewpoint of the illustrated user moves from right to left in the X-direction, the positions of the numbers 1 to 4 as the image apparently do not change while the number 0 as the image apparently moves from right to left. As a result, for the user, the number 0 apparently exists at a relatively farther position (back side) than the numbers 1 to 4 while the numbers 1 to 4 apparently exist at relatively nearer positions (nearer to the front side than the number 0). Note that FIG. 27 does not illustrate the liquid crystal display panel 11. However, the video display apparatus is made of the liquid crystal display panel 11 and the light source 13.

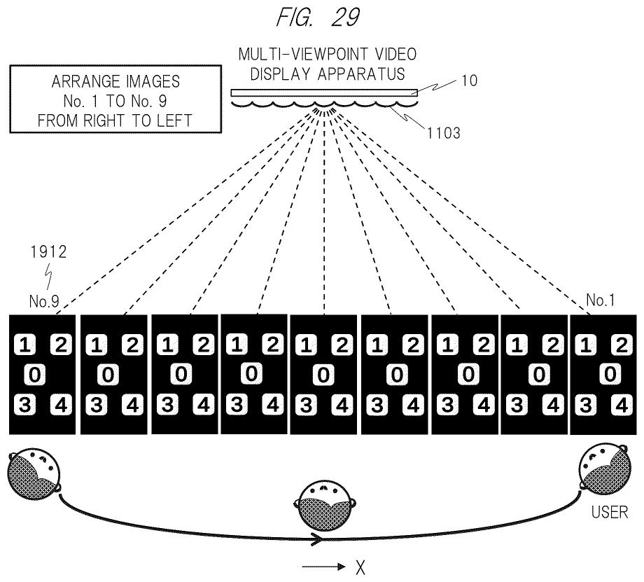

On the other hand, FIG. 29 is a diagram illustrating that the motion parallax can be provided by fixing the positions of the numbers 1 to 4 (first object) for the pixels 1 to 9 arranged from right to left in the liquid crystal display panel 11 while gradually moving the number 0 (second object) simply in an opposite direction to the X direction, that is, from right to left in the direction of the images No. 1 to No. 9 to form the multi-viewpoint image 1912, and besides, by arranging the lenticular lens 1103 on the video-light emission side of the liquid crystal display panel 11. That is, when the viewpoint of the illustrated user moves from left to right in the X-direction, the positions of the numbers 1 to 4 as the image apparently do not change while the number 0 as the image apparently moves from left to right. As a result, for the user, the number 0 apparently exists at a relatively nearer position (front side) than the numbers 1 to 4 while the numbers 1 to 4 apparently exist at relatively farther positions (deeper than the number 0). Note that FIG. 29 does not illustrate the liquid crystal display panel 11. However, the video display apparatus 10 is made of the liquid crystal display panel 11 and the light source 13.

When the motion parallax is provided by the multi-viewpoint image as described above, it is not always necessary to use the images 1502 captured by the cameras 1501 arranged at the different positions on the circumference as illustrated in FIG. 15, and the multi-viewpoint image can be formed by simply shifting the relative positions of the plurality of subjects (the numbers 0 to 4 of the subject 1900 in FIGS. 26 and 28) in the right-left direction as illustrated in FIGS. 26 and 28. In the subject 1900 in FIGS. 26 and 28, the numbers 1 to 4 are an example of the first object whose position is fixed while the number 0 is an example of the second object whose position is shifted left or right.

Here, by the method illustrated in FIGS. 26 and 28, that is, by the method of forming the multi-viewpoint image by simply shifting the relative positions of the numbers 0 to 4 in the right-left direction as the plurality of objects in the same image, the multi-viewpoint image can be very easier to be formed than the method of forming the multi-viewpoint image by using the plurality of cameras 1501 arranged on the circumference illustrated in FIG. 15. Moreover, the method has a feature capable of providing the motion parallax for the plurality of objects (here, the numbers 0 to 4) displayed in one image, and is preferable for forming the multi-viewpoint image.

FIG. 27 illustrates a display example using the multi-viewpoint video display apparatus made of the video display apparatus 10 and the lenticular lens 1103 and using the multi-viewpoint image 1912 formed by the method illustrated in FIG. 26. As described above, the user can visually recognize the motion parallax between the displayed objects and thus can three-dimensionally view the plurality of objects by using the combination of the lenticular lens 1103 with the multi-viewpoint image 1912 formed by simply shifting the relative positions of the numbers 0 to 4 in the right-left direction. In the case of FIG. 27, when the user moves left and right in the X-direction, the number 0 apparently exists on the back side while the numbers 1 to 4 apparently exist on the front side. In other words, the object provides the motion parallax in accordance with the movement of the user who is visually recognizing the air floating video.

### <Fourth Example for Displaying Multi-Viewpoint Video as Air Floating Video>

Next, as being opposite to the case of FIG. 26, FIG. 28 illustrates a case where the positions of the numbers 1, 2, 3, and 4 among the five numbers 0, 1, 2, 3, and 4 in the subject 1900 are fixed while the position of the number 0 is gradually shifted from left to right in the X direction to form the nine images 1912 indicated by images No. 1 to No. 9 as the multi-viewpoint image. The formed images No. 1 to No. 9 are assigned as one pixel group to the pixels 1 to 9 of the liquid crystal display panel 11.

Next, FIG. 29 is a diagram illustrating that the motion parallax can be provided by fixing the positions of the numbers 1 to 4 for the pixels 1 to 9 arranged from right to left as described above while gradually moving the position of the number 0 simply in an opposite direction to the X direction, that is, from right to left in the direction of the images No. 1 to No. 9 to form the multi-viewpoint image 1912, and besides, by arranging the lenticular lens 1103 on the video-light emission side of the liquid crystal display panel 11. That is, when the viewpoint of the illustrated user moves from left to right in the X-direction, the positions of the numbers 1 to 4 as the image apparently do not change while the number 0 as the image apparently moves from left to right in the opposite direction to the X direction. In this case, as being opposite to FIG. 27, for the user, the number 0 apparently exists at a relatively nearer position (front side) while the numbers 1 to 4 apparently exist at relatively farther positions (back side, deep side).

One of the points of the third and fourth examples of the present invention lies in the above-described point as similar to the first and second examples. That is, in order to obtain the motion parallax by using the multi-viewpoint image, in the related-art technique, it is necessary to form the multi-viewpoint image by capturing the image of the subject at different angles from the position where the cameras are arranged on the circumference. On the other hand, in the third and fourth examples of the present invention, one object among the plurality of objects apparently exists at a relatively farther position (back side) than another object while another object among the plurality of objects apparently exists at a relatively nearer position (front side) than the one object when the relative positions of the plurality of objects configuring the multi-viewpoint image simply linearly shift in a predetermined direction (right-left direction).

As similar to the first and second examples, the second point of the third and fourth examples of the present invention appears when the multi-viewpoint image 1912 formed as described above is further displayed as the air floating video 3.

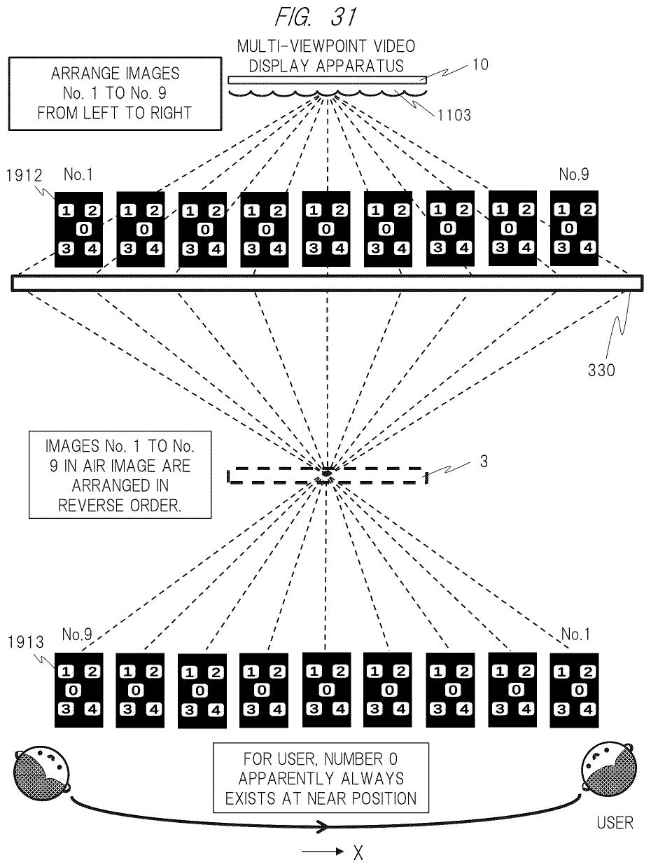

FIG. 31 is a diagram illustrating a state in which the multi-viewpoint image 1912 displayed by the multi-viewpoint video display apparatus made of the video display apparatus 10 and the lenticular lens 1103 illustrated in FIG. 27 is displayed as the air floating video 3 by the retroreflection plate 330. As described above with reference to FIGS. 17 and 18, the user recognizes the air floating video 3 formed by the retroreflection plate 330 in the state in which the right-left arrangement order of the multi-viewpoint images (which may be the multi-viewpoint videos) displayed by the video display apparatus 10 is opposite to the right-left arrangement order of the multi-viewpoint images based on the air floating video 3.

That is, as illustrated in FIG. 27, when the multi-viewpoint image 1912 is formed in the order in which the image No. 1 corresponds to the leftmost pixel 1, the image No. 2 corresponds to the pixel 2 right adjacent to the pixel 1, and the last image No. 9 corresponds to the rightmost pixel 9, the multi-viewpoint video display apparatus displays such a formed multi-viewpoint image 1912 as the air floating video 3 through the video display apparatus 10, the lenticular lens 1103, and the retroreflection plate 330 as illustrated in FIG. 31. In the video display apparatus 10 and the lenticular lens 1103, the images No. 1 to No. 9 are arranged in order from left to right in the X-direction. Then, in the air floating video 3, the user recognizes that the images No. 1 to No. 9 which are the multi-viewpoint images 1913 are arranged in the order opposite to the order in the video display apparatus 10 so that the image No. 1 apparently exists on the rightmost side, the image No. 2 apparently exists on the left side of the image No. 1, and the last image No. 9 apparently exists on the leftmost side. Therefore, in the air floating video 3, for the user, the position of the number 0 of the images No. 1 to No. 9 which are the multi-viewpoint images 1913 apparently move from left to right in the X direction. Also, for the user, the number 0 apparently always exists on the front side.

As described above, in the embodiment illustrated in FIG. 31, the multi-viewpoint image 1913 recognized as the air floating video 3 by the user has the same arrangement order as the order illustrated in FIG. 29. That is, for the user who is recognizing (observing) the air floating video 3, the positions of the numbers 1 to 4 apparently always remain at the same position on the screen, and the number 0 apparently exists at a relatively nearer position (front side, forward side) than the numbers 1 to 4.

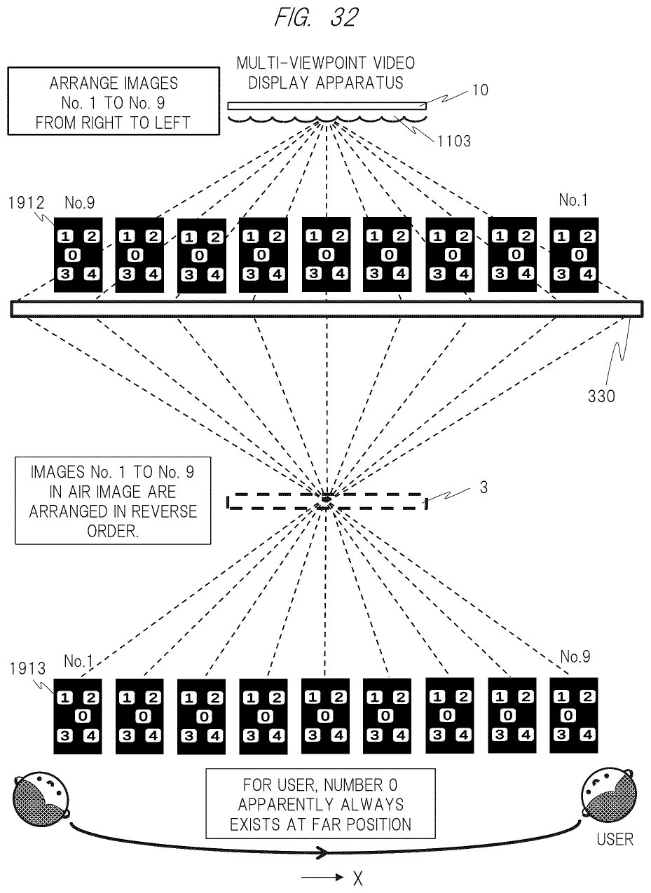

Subsequently, FIG. 32 is a diagram illustrating a state in which the images No. 1 to No. 9 are arranged from right to left and in which the multi-viewpoint image 1912 displayed by the multi-viewpoint video display apparatus made of the video display apparatus 10 and the lenticular lens 1103 illustrated in FIG. 29 is displayed as the air floating video 3 by the retroreflection plate 330. Also in this case, as similar to FIG. 31, the user recognizes the air floating video 3 formed by the retroreflection plate 330 so that the right-left arrangement order of the multi-viewpoint image 1912 (which may be the multi-viewpoint video) displayed by the video display apparatus 10 is opposite to the right-left arrangement order of the multi-viewpoint image 1902 based on the air floating video 3.

The details in the middle are similar to those in the case of FIG. 31, and therefore, the detailed description thereof is omitted. However, in the embodiment illustrated in FIG. 32, the multi-viewpoint image 1913 recognized as the air floating video 3 by the user has the same arrangement order as the order illustrated in FIG. 27. That is, for the user who is recognizing (observing) the air floating video 3, the positions of the numbers 1 to 4 apparently always remain at the same position on the screen, and the number 0 apparently exists at a relatively farther position (back side, deep side) than the numbers 1 to 4.

As described above with reference to FIGS. 31 and 32, the right-left arrangement order of the multi-viewpoint image 1912 displayed by the video display apparatus 10 and the right-left arrangement order of the multi-viewpoint image 1913 based on the air floating video 3 are recognized exactly in the opposite order by the user. More specifically, in the case of FIG. 31, the positions of the numbers 1 to 4 apparently always remain at the same position on the screen while the number 0 apparently always exist at a relatively nearer position farther (front side) than the numbers 1 to 4. On the other hand, in the case of FIG. 32, the position of the number 0 apparently always remains at the reference position (center) while the numbers 1 to 4 apparently always exist at a relatively farther position (back side, deep side) than the numbers 1 to 4.

When it is desired to display the multi-viewpoint image 1913 as illustrated in FIG. 31 in the first state in which the object of the number 0 is displayed on the front side, the air floating video display apparatus which is the multi-viewpoint video display apparatus may display the multi-viewpoint image 1912 so that the arrangement order of the second object having the moving number 0 is in the opposite order (from right to left). Conversely, when it is desired to display the multi-viewpoint image 1913 as illustrated in FIG. 32 in the second state in which the object of the number 0 is displayed on the back side, the multi-viewpoint image 1912 may be displayed so that the arrangement order of the second object having the moving number 0 is in the forward order (from left to right).

Here, the position of the object displayed on each image will be described more specifically using numerical values by taking images No. 1 to No. 9 which are the multi-viewpoint images 1912 illustrated in FIG. 31 as an example. In FIG. 31, the positions of the numbers 1 to 4 as the first object are fixed, and the number 0 as the second object is arranged in the pixels 1 to 9 in the right-left direction, that is, the X-direction. Here, when the positions where the numbers 1 to 4 as the first object and the number 0 as the second object are arranged in the images No. 1 to No. 9 are made to correspond to the coordinates on the X-axis illustrated in FIG. 30, they can be expressed as Table 2 below.

TABLE 2

| | Image No. | | | | | | | | |
|---|---|---|---|---|---|---|---|---|---|
| | No. | No. | No. | No. | No. | No. | No. | No. | No. |
| | 1 | 2 | 3 | 4 | 5 | 6 | 7 | 8 | 9 |
| (1) X coordinates of Midpoint of | 4.0 | 4.0 | 4.0 | 4.0 | 4.0 | 4.0 | 4.0 | 4.0 | 4.0 |
| “Numbers 1 to 4” as First object | | | | | | | | | |
| on Multi-viewpoint image 1912 | | | | | | | | | |
| (2) X coordinates (X1 to X9) of Left | 4.00 | 3.75 | 3.50 | 3.25 | 3.00 | 2.75 | 2.50 | 2.25 | 2.00 |
| side of “Number 0” as Second object | | | | | | | | | |
| on Multi-viewpoint image 1912 | | | | | | | | | |

In Table 2, (1) the X coordinates of the midpoint of “numbers 1 to 4” as the first object on the multi-viewpoint image 1912 are the X coordinates of the central point (midpoint) of four positions at which the four numbers 1 to 4 are arranged as the display object, and the positions of “numbers 1 to 4” are unchanged in any of the images No. 1 to No. 9. Therefore, these X coordinates of the midpoint of the “numbers 1 to 4” always have the same value to be specifically 4.0. On the other hand, (2) the X coordinate of the left side of “number 0” as the second object on the multi-viewpoint image 1912 corresponds to U1 to XU illustrated in FIG. 30. Therefore, in each of the images No. 1 to No. 9, values of U1 to U9 are 4.00, 3.75, 3.50, 3.25, 3.00, 2.75, 2.50, 2.25, and 2.00, respectively, as shown in Table 2.

As described above, the position, that is the X coordinates, of each object displayed in the images No. 1 to No. 9 which are the multi-viewpoint image 1902 illustrated in FIG. 31 has been described. Note that FIG. 31 also shows the multi-viewpoint floating image 1913 that is an air floating video, in addition to the multi-viewpoint image 1912. As described in the description of FIG. 31, the multi-viewpoint image 1912 and the multi-viewpoint floating image 1913 are only in a relationship in which the right and left arrangement orders are opposite to each other, and the multi-viewpoint image 1912 and the multi-viewpoint floating image 1913 are exactly the same as each other in the relative positional relationship between the displayed objects. Therefore, the description of the X coordinates of each object (specifically, the numbers 0 to 4) regarding the multi-viewpoint floating image 1913 is omitted here. The same applies to FIG. 32 described below, and therefore, the repetitive description for the X coordinates of the numbers 0 to 4 of the multi-viewpoint image 1912 and the multi-viewpoint floating image 1913 is omitted.

As described above, according to the third and fourth examples of the present invention, for example, when a plurality of numbers is displayed as the object to be displayed as the air floating video 3, the multi-viewpoint image can be formed by not changing the position of an optional number among the plurality of numbers but relatively shifting the positions of the other numbers in the right-left direction. That is, the air floating video display apparatus for aerially forming the air floating video 3 is made of the video display apparatus 10 for displaying images of at least two objects, the lenticular lens 1103 arranged on the video-light emission side of the video display apparatus, and the optical member (retroreflector 330) for forming the video light emitted from the video display apparatus 10 as the aerially-formed air floating video 3. The video display apparatus 10 and the retroreflector 330 may be housed in the housing. The video display apparatus 10 displays a plurality of multi-viewpoint images including at least three objects so that the position of the optional object among at least the three objects is fixed while the positions of the objects other than the optional object shift among the plurality of different multi-viewpoint images in a predetermined direction. And, the plurality of multi-viewpoint images are aerially displayed the air floating video by the retroreflector 330. The predetermined direction described here is the right-left direction with respect to the viewpoint of the user who is visually recognizing the air floating video. The video display apparatus 10 displays the object such as the push button corresponding to the number as the multi-viewpoint image obtained by simply moving it in the right-left direction apparently for the user. On the other hand, the positional relation of at least two objects among the objects displayed by the video display apparatus 10 is opposite to that of the object displayed as the air floating video in the tight-left direction.

Note that the lenticular lens 1103 is arranged between the video display apparatus 10 and the retroreflector 330, and is arranged at a predetermined distance from the emitting surface of the display panel 11. Further, a distance between the lenticular lens 1103 and the video display apparatus 10 is adjusted by a focal length of the lenticular lens 1103, and the light emitting surface of the display panel 11 and the light entering surface of the lenticular lens 1103 are parallel to each other.

In addition, when a sensor or the like detects that the user has approached the housing that houses the video display apparatus 10 and the retroreflector 330, the object is displayed as the air floating video. The sensor described here is, for example, a human detecting sensor, an imager, a camera, or the like. In the case of the human detecting sensor, it is detected that the user has approached it, based on an output result from the human detecting sensor. In the case of the imager, it is detected that the user has approached it, based on the image in which the user has been imaged, captured by the imager.

Therefore, when the user observes the formed air floating video 3, this manner results in an effect in which the relative positions of the objects (in this case, the push buttons corresponding to the numbers) in the depth direction, in other words, the positional relationship meaning the back side or the front side thereof apparently different. In other words, the depth texture or the three-dimensional texture can be provided to the air floating video 3. The object displayed as this image is not limited to the number, and may be any letter, figure, background or the like.

Thus, according to the present embodiment, in the case of the display of the air floating video 3 as, for example, an HMI or a GUI showing the number as the push button (in other words, the number button), when the optional number button is touched (aerially operated) by the user, this case results in a new effect in which only the touched number button is apparently recessed to the back side while the other number buttons apparently remain stayed at the original positions under the display control. As the specific display control, the air floating video display apparatus may perform control to change the touched number button (for example, the object of the number 0) from the first state in which the touched number button is displayed on the front side as described above to the second state in which the touched number button is displayed on the back side.

The embodiments illustrated in FIGS. 31 and 32 show that the example (FIG. 32) in which the numbers 1 to 4 (first object whose position is fixed) are displayed on the front side with respect to the other number 0 (second object whose position is moved) and the example (FIG. 31) in which the other number 0 is displayed on the front side with respect to the numbers 1 to 4. In addition, it is needless to say that the number as the display object is not limited to 0 to 4, and may be the numbers 0 to 9, may be a number of 2 or more digits, or may be any letter string such as “ON” and “OFF”. As described above, in the present invention, any one, two or more numbers or letter strings can be displayed on the front side or the back side as compared with other numbers or letter strings.

Furthermore, in the above-described example, the case where only the two depth positions on the front side and the back side are provided as the positions of the object of the multi-viewpoint image in the depth direction has been described. However, the present invention is not limited to this, and it is also possible to set the positions of the object of the multi-viewpoint image in the depth direction as multi-stepwise positions (such as three steps that are the front side, the middle, and the back side) by setting the moving distance of shifting the image in the predetermined direction to a different value. At this time, the number or the letter may be displayed as the objects positioned on the front side and the back side while a background image or any symbol (for example, logotype (logo mark)) may be displayed as the object positioned on the middle side with respect to these objects. This will be described later as another example.

### <Fifth Example for Displaying Multi-Viewpoint Video as Air Floating Video> (Reduction of Imbalanced Resolution)

Next, a fifth example of the present invention will be described. As well known, in the multi-viewpoint image, the larger the number of viewpoints is, the more the degradation of the horizontal resolution of the multi-viewpoint image is. As seen in the first to fourth examples described above, when the number of viewpoints is 9, that is, in a multi-viewpoint image of nine viewpoints, the resolution in the horizontal direction decreases to 1/9. For example, in a case of usage of a liquid crystal panel having 1920 pixels as the resolution in the horizontal direction, when the multi-viewpoint image of nine viewpoints is displayed on this panel, the number of pixels in the horizontal direction simply decreases to about “1920 pixels/9”, that is, about 213 pixels. On the other hand, as a method for preventing the decrease in resolution in the multi-viewpoint image display, there is a technique for preventing the decrease in resolution by obliquely arranging a lenticular lens.

It can be expected that the resolution is improved about three times by using the technique for preventing the decrease in resolution as described above. As a result, in the multi-viewpoint image of nine viewpoints, the horizontal resolution decreases to 1/9. On the other hand, by obliquely arranging the lenticular lens, the decrease in resolution is made ⅓, and the horizontal resolution becomes “1920 pixels/3=640 pixels”. However, it is still not possible to reduce the decrease in horizontal resolution to zero, and problems as described below arise.

In the case of the first and second examples of the present invention, with reference to FIGS. 19 and 21, the display positions of the numbers 1 to 4 as the displayed object change for each viewpoint while the display position of the number 0 is fixed (unchanged) even if the viewpoint changes. Thus, the horizontal resolution of the numbers 1 to 4 decreases to “1920 pixels/9” while the resolution of number 0 remains at 1920 pixels. Here, even if the technique for preventing the decrease in resolution by obliquely arranging the lenticular lens as described above is adopted, when the user observes the number as the multi-viewpoint image, the resolution of the numbers 1 to 4 decreases to about ⅓ of that of the number 0 while the resolution of the number 0 remains at the original resolution. This results in a problem that the numbers 1 to 4 apparently blur as compared to the number 0.

In order to solve such a problem that is the imbalanced horizontal resolution among the objects, the resolution of the object without the decrease in resolution such as the number 0 in the case of FIGS. 19 and 21 may be decreased to be about the same as the resolution of the numbers 1 to 4 to reduce the imbalanced horizontal resolution among the display objects. Specifically, the display position of the number 0 as the object is not fixed among the nine pixels illustrated in FIGS. 19 and 21, but is slightly shifted among the nine pixels to reduce the above-described imbalanced resolution.

Specifically, the position of the number 0 as the object displayed on the pixel 1 to 9 in FIGS. 19 and 20 may be shifted between adjacent pixels by about 2% of the size of the object. In the case of nine viewpoints, by the shifting between adjacent pixels by 2%, the resolution of the number 0 as the display object decreases by about ⅕. A reason for this is as follows. That is, by the shifting of the number 0 between adjacent pixels by 2%, the blurring of “2% ×9-18%” that is about 20% is caused in the number 0, and as a result, the resolution of the number 0 decreases by about ⅕. As a result of the above description, the imbalanced horizontal resolution between the objects, that is, between the numbers 0 and 1 to 4 can be reduced.

At this time, the direction of shifting between adjacent pixels of the number 0 as the display object is preferably opposite to the direction of shifting between adjacent pixels of the numbers 1 to 4. This is because a result of the above description also increases the depth texture between the numbers 0 and 1 to 4. That is, this leads to an effect in which the object displayed on the front side can be viewed on the further front side while the object displayed on the back side can be viewed on the further back side, and is preferable.

### <Sixth Example for Displaying Multi-Viewpoint Video as Air Floating Video> (Example of Increasing Depth Texture)

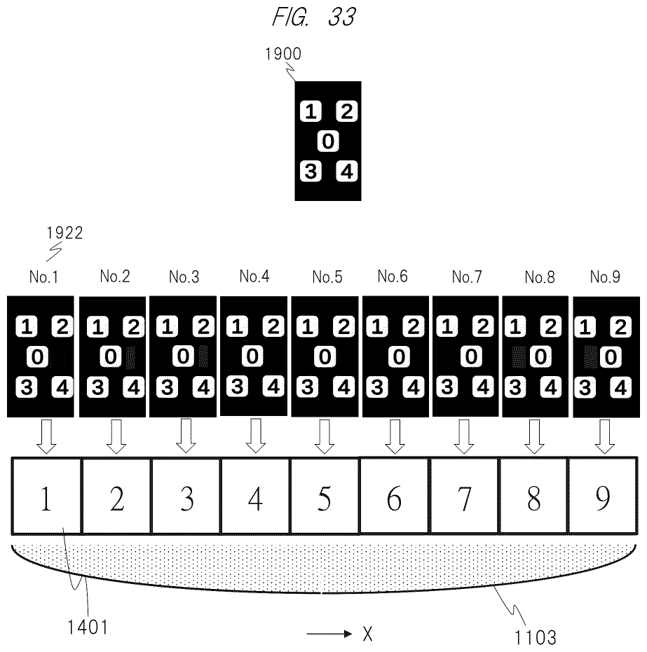

Next, A sixth example of the present invention will be described. FIGS. 33 to 35 are diagrams each illustrating an embodiment in which the depth texture (which may be referred to as three-dimensional texture) of the plurality of objects is made larger than those of the embodiments described above. More specifically, when the plurality of objects are displayed as the air floating video, for example, the number 0 among the numbers 0 to 4 as the display objects apparently exists on the deepest side while the four numbers that are the numbers 1 to 4 apparently exits on the foremost side for the user.

FIG. 33 illustrates a case where the positions of the numbers 1 to 4 among the five numbers 0, 1, 2, 3, and 4 as the display objects in the subject 1900 are gradually shifted from left to right in the opposite direction to the X direction while the position of the number 0 is gradually shifted from right to left in the opposite direction to the X direction to form the nine images 1922 indicated by images No. 1 to No. 9 as the multi-viewpoint image 1922. The formed images No. 1 to No. 9 are assigned as one pixel group of the liquid crystal display panel 11 to the pixels 1 to 9 of the nine images 1401.

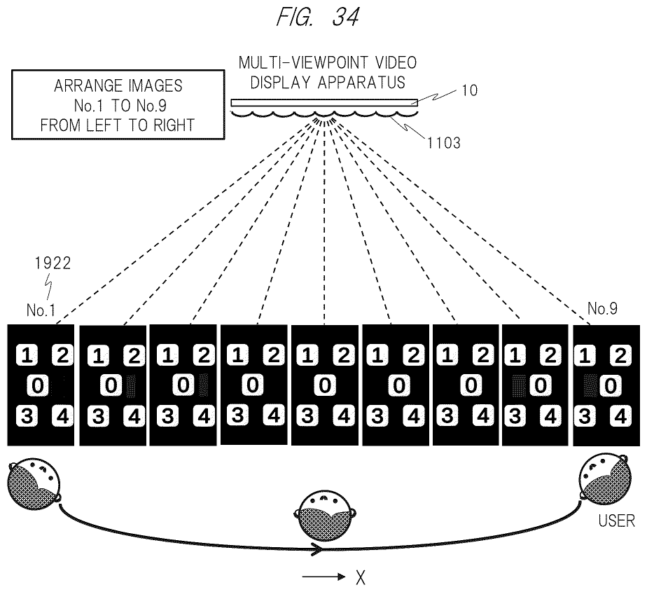

Next, FIG. 34 illustrates a display example using the multi-viewpoint video display apparatus made of the video display apparatus 10 and the lenticular lens 1103 and using the multi-viewpoint image 1922 formed by the method illustrated in FIG. 33. As described above, the user can visually recognize the motion parallax between the displayed objects and thus can three-dimensionally view the plurality of objects by using the combination of the lenticular lens 1103 with the multi-viewpoint image 1922 formed by simply shifting the relative positions of the numbers 0 to 4 in the right-left direction. In the case of FIG. 34, when the user moves left and right in the X-direction, the numbers 1 to 4 apparently exist on the back side (deep side) while the number 0 apparently exists on the front side (nearer to the front side).

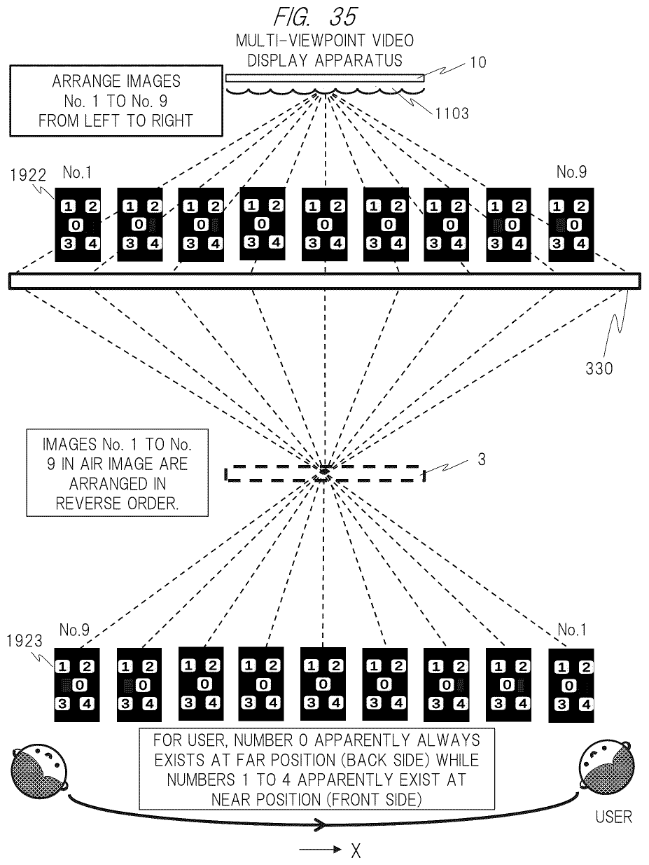

FIG. 35 is a diagram illustrating a state in which the multi-viewpoint image 1922 displayed by the multi-viewpoint video display apparatus made of the video display apparatus 10 and the lenticular lens 1103 illustrated in FIG. 34 is displayed as the air floating video 3 by the retroreflection plate 330. As described above, the user recognizes the air floating video 3 formed by the retroreflection plate 330 so that the right-left arrangement order of the multi-viewpoint image (which may be the multi-viewpoint video) displayed by the video display apparatus is opposite to the right-left arrangement order of the multi-viewpoint image 1902 based on the air floating video 3. Note that the movement (movement state) of the display object numbers 1 to 4 in the images No. 1 to No. 9 configuring the multi-viewpoint image 1923 in FIG. 35 is the same as the movement of the display object numbers 1 to 4 illustrated in FIG. 25 while the movement (movement state) of the display object number 0 is the same as the movement of the display object number 0 illustrated in FIG. 30.

That is, as illustrated in FIG. 33, when the multi-viewpoint image 1922 is formed in the order in which the image No. 1 corresponds to the leftmost pixel 1, the image No. 2 corresponds to the pixel 2 right adjacent to the pixel 1, and the last image No. 9 corresponds to the rightmost pixel 9, the multi-viewpoint video display apparatus displays such a formed multi-viewpoint image 1922 as the air floating video 3 through the video display apparatus 10, the lenticular lens 1103, and the retroreflection plate 330 as illustrated in FIG. 35. In the video display apparatus 10 and the lenticular lens 1103, the images No. 1 to No. 9 are arranged in order from left to right in the X-direction. Then, the user recognizes the air floating video 3 so that the images No. 1 to No. 9 which are the multi-viewpoint images 1923 are arranged in the order opposite to the order in the video display apparatus 10 so that the image No. 1 apparently exists on the rightmost side, the image No. 2 apparently exists on the left side of the image No. 1, and the last image No. 9 apparently exists on the leftmost side for the user.

As a result of the above description, in the embodiment illustrated in FIG. 35, in the multi-viewpoint floating image 1923 recognized as the air floating video 3 by the user, the positions of the numbers 1 to 4 apparently always exist on the front side in the depth direction of the screen, that is, on the front side, while the position of the number 0 apparently exists at a relatively deeper position than the numbers 1 to 4.

Here, in comparison between FIG. 35 and FIG. 32, in any case, the position of the number 0 apparently exists at the relatively deeper position than the numbers 1 to 4. However, the numbers 1 to 4 apparently exist on a nearer side, that is, on a side nearer to the front side than that in the case of FIG. 32. In other words, there is an effect that the user can feel a larger sense of perspective (depth texture) between the position of the number 0 and the positions of the numbers 1 to 4 in the depth direction in the example illustrated in FIG. 35 than the example illustrated in FIG. 32. This is a feature of the sixth example of the present invention, and is preferable since the user can feel the larger sense of perspective (depth texture) in the depth direction between the objects recognized as the air floating video.

### <Seventh Example for Displaying Multi-Viewpoint Video as Air Floating Video> (Example of Displaying Depth Positions of Display Object to be Three Steps as Front, Middle, and Back Side)

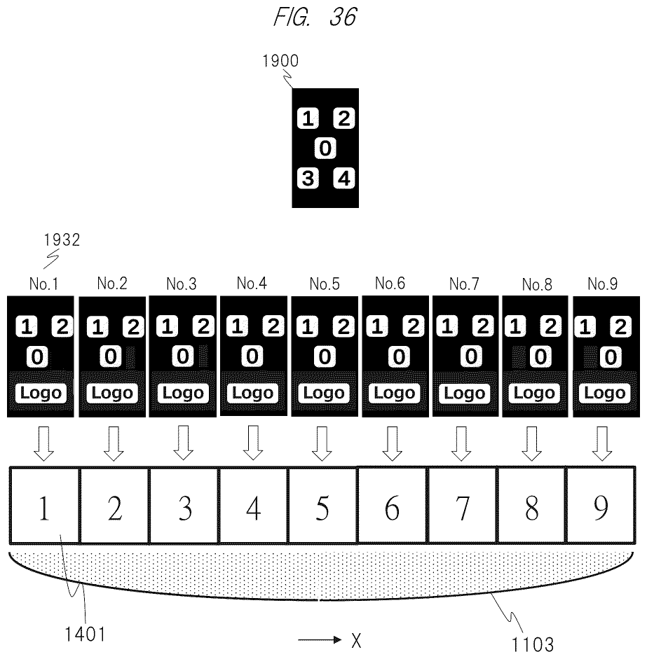

Next, with reference to FIGS. 36 to 39, an example (seventh example) in which the depth of the object as the air floating video is apparently displayed for the user to be divided into three steps that are the frontmost position, the deepest position, and an intermediate position between these positions will be described.

FIG. 36 illustrates a case where the positions of the numbers 1 and 2 among the three numbers 0, 1 and 2 as the display objects in the subject 1900 are shifted by a predetermined distance from right to left in the X direction while the position of the number 0 is shifted by a predetermined distance from left to right in the X direction to form the nine images 1932 indicated by images No. 1 to No. 9 as the multi-viewpoint image 1932. Furthermore, in this seventh example, the display objects include a letter string of four letters “Logo” in addition to the numbers 0, 1, and 2. Note that the position of the letter string “Logo” in the right-left direction does not change and is always arranged at a constant position in any of the images No. 1 to No. 9.

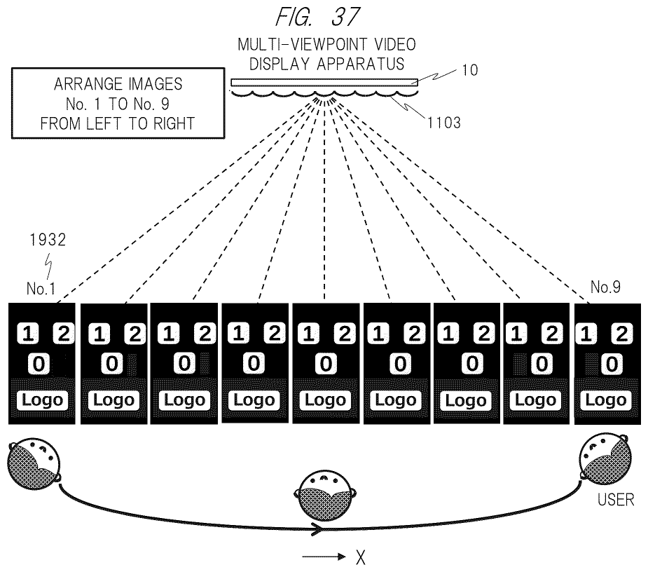

Next, FIG. 37 illustrates a display example using the multi-viewpoint video display apparatus made of the video display apparatus 10 and the lenticular lens 1103 and using the multi-viewpoint image 1932 formed by the method illustrated in FIG. 36. As described above, the user can visually recognize the motion parallax between the displayed objects, and thus, the numbers 0, 1 and 2 can apparently exist at the different positions in the depth direction from one another for the user, by using the combination of the lenticular lens 1103 with the multi-viewpoint image 1932 formed by simply shifting the relative positions of the plurality of display objects, more specifically, the numbers 0, 1 and 2 in the right-left direction as described above. In the case of FIG. 37, when the user moves in the X-direction, the numbers 1 and 2 apparently exist on the back side (deep side) while the number 0 apparently exists on the front side (nearer to the front side).

On the other hand, in FIG. 37, as described above, the position of the letter string “Logo” which is another display object in the right-left direction does not change in any of the nine images 1932 indicated by images No. 1 to No. 9, and always apparently exists at a constant position. Therefore, even when the user moves in the X-axis direction, the position thereof in the depth direction for the user apparently does not change.

That is, for the user, the number 0 among the plurality of display objects illustrated in FIGS. 36 and 37 apparently exists on the nearest side (front side) in the depth direction, the numbers 1 and 2 apparently exist on the farthest side (deepest side), and the letter string “Logo” apparently exists at an intermediate depth position between the number 0 and the numbers 1 and 2.

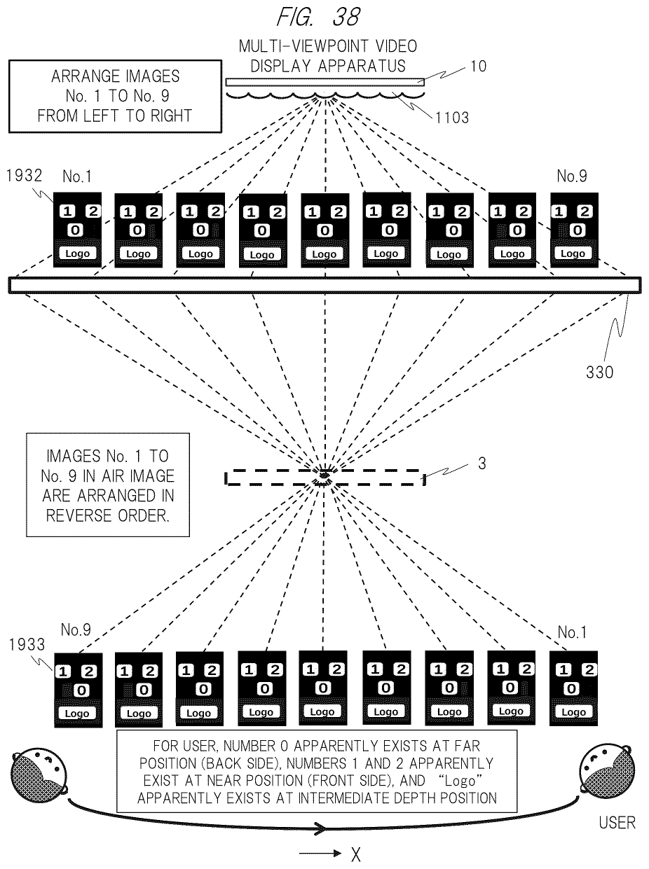

FIG. 38 is a diagram illustrating a state in which the multi-viewpoint image 1932 displayed by the multi-viewpoint video display apparatus made of the video display apparatus 10 and the lenticular lens 1103 illustrated in FIG. 37 is displayed as the air floating video 3 by the retroreflection plate 330. As described above, the user recognizes the air floating video 3 formed by the retroreflection plate 330 so that the right-left arrangement order of the multi-viewpoint image (which may be the multi-viewpoint video) displayed by the video display apparatus 10 is opposite to the right-left arrangement order of the multi-viewpoint image 1902 based on the air floating video 3.

That is, as illustrated in FIG. 36, when the multi-viewpoint image 1932 is formed in the order in which the image No. 1 corresponds to the leftmost pixel 1, the image No. 2 corresponds to the pixel 2 right adjacent to the pixel 1, and the last image No. 9 corresponds to the rightmost pixel 9, the multi-viewpoint video display apparatus displays the multi-viewpoint image 1932 as the air floating video 3 through the video display apparatus 10, the lenticular lens 1103, and the retroreflection plate 330 as illustrated in FIG. 38. In the video display apparatus 10 and the lenticular lens 1103, the images No. 1 to No. 9 are arranged in order from left to right in the X-direction. Then, the user recognizes the air floating video 3 so that the images No. 1 to No. 9 which are the multi-viewpoint images 1933 are arranged in the order opposite to the order in the video display apparatus 10 so that the image No. 1 apparently exists on the rightmost side, the image No. 2 apparently exists on the left side of the image No. 1, and the last image No. 9 apparently exists on the leftmost side for the user.

As a result of the above description, in the embodiment illustrated in FIG. 38, in the multi-viewpoint floating image 1933 recognized as the air floating video 3 by the user, the positions of the numbers 1 and 2 apparently always exist on the nearest side in the depth direction of the screen, that is, on the front side, while the position of the number 0 apparently exists at a relatively deeper position than the numbers 1 and 2.

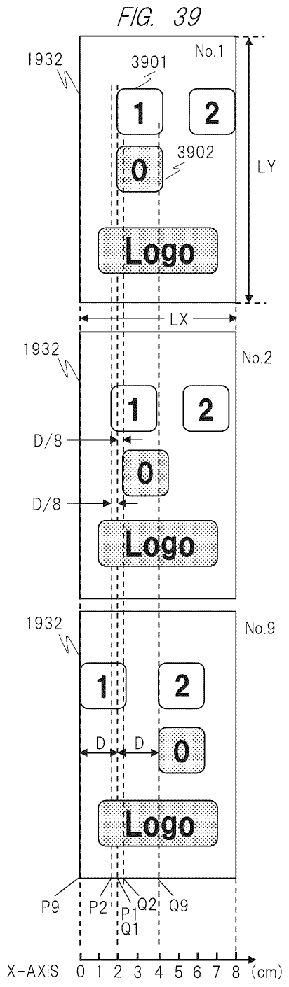

FIG. 39 is a supplementary explanatory diagram related to the formation of the nine images 1932 indicated by images No. 1 to No. 9 which are the multi-viewpoint image 1932 illustrated in FIGS. 36 and 37. FIG. 39 shows the uniformed X-direction positions of only three images of image No. 1, image No. 2, and image No. 9 in FIG. 36 as the multi-viewpoint image 1932.

With reference to FIG. 39, an example will be described, the example showing that an object 3901 of the number 1 among the plurality of objects in the images No. 1, No. 2, and No. 9 moves from the right position to the left position in the X-axis direction. An X-axis position of a left side of the object 3901 of the number 1 in a case in which the number 1 as the object is on the rightmost side in the image No. 1 is assumed to be “P1”, and an X-axis position of the left side of the object 3901 of the number 1 in a case in which the number 1 is on the leftmost side in the image No. 9 is assumed to be “P9”. In these cases, a movement distance from the rightmost position P1 of the number 1 as the object to the leftmost position P9 is assumed to be “D”. The unit movement distance (D/8) is obtained by dividing the movement distance D by eight corresponding to the number (9) of multi-viewpoint (9-viewpoint) images 1932. The position P2 of the object 3901 of the number 1 in the image No. 2 is a position moved by one unit movement distance (D/8) from the position P1 in the image No. 1. The positions of the other images can be similarly provided. By this method, the position of the object of the number 1 in each of the images No. 1 to No. 9 is determined.

In the example shown in FIG. 39, the X-axis position of the object in each image will be described more specifically with reference to numerical values. If the size of the multi-viewpoint image 1932 that is the screen size of the video display apparatus 10 is, for example, 6.5 inches (so-called 6.5-type liquid crystal screen), the screen size in FIG. 39 has a vertical length “LY” of approximately 14.5 cm and a horizontal length “LX” of approximately 8 cm. At this time, in attention to the number 1, the X-axis position of the left side of the number 1 moves from the position P1 to the position P9 as described above.

If it is assumed that the movement distance D from the X-axis position P1 to position P9 of the left side of the number 1 is 2.0 cm as illustrated in FIG. 39, the distance between the position P1 and the position P2 is ⅛ of the movement distance D. In a specific numerical value, since the movement distance D=2.0 cm, the distance between the position P1 and the position P2 is “2.0 cm/8” that is 0.25 cm. Similarly, in the other images No. 3 to No. 9 not illustrated in FIG. 39, the movement distances between adjacent images that are the distances between the position P2 and the position P3, between the position P3 and the position P4, between the position P4 and the position P5, between the position P5 and the position P6, between the position P6 and the position P7, between the position P7 and the position P8, and between the position P8 and the position P9 are each 0.25 cm.

Next, the movement of the object 3902 of the number 0 among the plurality of objects in the images No. 1, No. 2, and No. 9 is opposite to the movement of the number 1 which is the object 3901 in the right-left (X-axis) direction. That is, the X-axis position of the left side of the number 0 in the image No. 1 in a case in which the number 0 of the object 3902 is arranged at the leftmost position is assumed to be “Q1”, and the X-axis position of the left side of the number 0 in the image No. 9 in a case in which the number 0 is arranged at the rightmost position is assumed to be “Q9”. Note that the position Q1 is the same position as the position P1.

In these cases, a movement distance from the leftmost position Q1 to the rightmost position Q9 is assumed to be “D”. The movement distance D may be the same as the movement distance of the number 1 to correspond to the number (9) of multi-viewpoint (9-viewpoint) images 1932. This is for, when the user observes the number 1 and the number 0 as objects as the multi-viewpoint image with motion parallax, making the depth perceptive recognized by the user equal between the number 1 and the number 0.

On the other hand, in all of the images No. 1 to No. 9, the object (Logo) that is the letter string is an object (first object) whose position does not change, and the position does not change on the images No. 1 to No. 9, and the position of the object that is the letter string (Logo) is always fixed at the same position as illustrated in FIG. 39. More specifically, the X-axis position of the center point (midpoint) of the object that is the letter string (Logo) is a position of 4.0 cm.

As described above, the multi-viewpoint image (a 9-viewpoint image in the example of FIG. 39) having the motion parallax can be formed by the object numbers 1, 2, and 0 whose X-axis positions change on the images No. 1 to No. 9. At the same time, since the position of the object of the letter string (Logo) illustrated in FIG. 39 does not change on all of the images No. 1 to No. 9, the letter string (Logo) apparently does not have the motion parallax for the user.

Here, the position of the object displayed on each image will be described more specifically with reference to numerical values while taking the images No. 1 to No. 9 which are the multi-viewpoint images 1932 illustrated in FIG. 38 as an example. In FIG. 38, the images No. 1 to No. 9 formed by moving the numbers 0, 1, and 2 as objects in the right-left direction, that is, the X-axis direction are arranged at the pixels 1 to 9, respectively. Here, correspondence between the X-axis coordinates illustrated in FIG. 39 and the positions of the numbers 0, 1, and 2 in the images No. 1 to No. 9 and the arrangement position of the letter string (Logo) as the object whose position does not change on the images No. 1 to No. 9 can be expressed as shown in the following Table 3.

TABLE 3

| | Image No. | | | | | | | | |
|---|---|---|---|---|---|---|---|---|---|
| | No. | No. | No. | No. | No. | No. | No. | No. | No. |
| | 1 | 2 | 3 | 4 | 5 | 6 | 7 | 8 | 9 |
| (1) X coordinates (P1 to P9) of Left | 2.00 | 1.75 | 1.50 | 1.25 | 1.00 | 0.75 | 0.50 | 0.25 | 0.00 |
| side of “Number 1” as Object | | | | | | | | | |
| on Multi-viewpoint image 1932 | | | | | | | | | |
| (2) X coordinates (Q1 to Q9) of Left | 2.00 | 2.25 | 2.50 | 2.75 | 3.00 | 3.25 | 3.50 | 3.75 | 4.00 |
| side of “Number 0” as Object | | | | | | | | | |
| on Multi-viewpoint image 1932 | | | | | | | | | |
| (3) X coordinates of Midpoint of | 4.0 | 4.0 | 4.0 | 4.0 | 4.0 | 4.0 | 4.0 | 4.0 | 4.0 |
| “Letter string (Logo)” as Object | | | | | | | | | |
| on Multi-viewpoint image 1932 | | | | | | | | | |

In Table 3, (1) the X coordinates of the left side of “number 1” as the object on the multi-viewpoint image 1932 is the X coordinates of the leftmost side of number 1 as the display object, and corresponds to the X coordinates of points P1 to P9 in FIG. 39. Specifically, in each of the images No. 1 to No. 9, the X coordinates of the points P1 to P9 are 2.00, 1.75, 1.50, 1.25, 1.00, 0.75, 0.50, 0.25, and 0.00, respectively. On the other hand, (2) the X coordinates of the left side of “number 0” as the object on the multi-viewpoint image 1932 corresponds to the X coordinates of Q1 to Q9 illustrated in FIG. 39. Therefore, as shown in Table 3, in each of the images No. 1 to No. 9, the values of 01 to 09 are 2.00, 2.25, 2.50, 2.75, 3.00, 3.25, 3.50, 3.75, and 4.00, respectively.

Furthermore, in Table 3, (3) the X coordinates of the midpoint of the “letter string (Logo)” as the object on the multi-viewpoint image 1932 is the X coordinates of the central point of the letter string (Logo) as the display object, and the X coordinates in the images No. 1 to No. 9 does not change as illustrated in FIG. 39 to be always 4.0.

As described above, the positions, in other words, particularly the specific positions in the right-left direction, that is the X coordinates of the respective objects displayed in the images No. 1 to No. 9 which are the multi-viewpoint images 1932 illustrated in FIG. 38 have been described with reference to FIG. 39. Note that FIG. 38 also illustrates a multi-viewpoint floating image 1933 that is an air floating video in addition to the multi-viewpoint image 1932. As described above, in FIG. 38, only the right-left arrangement orders of the multi-viewpoint image 1932 and the multi-viewpoint floating image 1933 are opposite to each other, and the relative positional relationship between the displayed objects is exactly the same between the multi-viewpoint image 1932 and the multi-viewpoint floating image 1933. Therefore, the description of the X coordinates of each object (specifically, the numbers 0, 1, and 2) related to the multi-viewpoint floating image 1933 is omitted here.

The above-described point is a feature of the seventh example of the present invention. Regarding the position in the depth direction between the objects recognized as the air floating video, for the user, the numbers 1 and 2 which are the air floating videos apparently exist on the foremost side, the position of the number 0 apparently exists at a position relatively deeper than the numbers 1 and 2, and the letter string “Logo” apparently exists at a midpoint position in the deep direction between the number 0 and the numbers 1 and 2. That is, in the seventh example, the plurality of objects displayed as the air floating video, in other words, the plurality of objects visually recognized by the user exist at three different depth positions that are the frontmost side, the deepest side, and the midpoint depth position in the depth direction, and therefore, it can be said that the seventh example is suitable in that the user can easily visually recognize the positions of the display objects in the depth direction.

As described above, the first to seventh examples of the present invention have been specifically described with reference to the numbers 0 to 4 as the objects, and besides, with reference to the letter string in the case of the seventh example. However, as described above, the object displayed as the air floating video 3 is not limited to the number and the letter string, and may be any figure, background (for example, translucent wallpaper), or the like. Therefore, the application range of the first example of the present invention is wide. For example, the present invention can be also applied to a phone including the push buttons of the numbers 0 to 9, an enter button, a calling on/off button, and the like, and can also be applied to an elevator including number buttons representing the numbers of floors of the elevator and a door open/close button. Furthermore, as described later, when the embodiments are applied to a vending machine for a drink or the like, a caution and an explanation of how to use the vending machine for the user, and numbers corresponding to products that can be selected by the user can be displayed as the air floating video to be used as means for selecting the number corresponding to a specific product that is a product desired by the user.

### <Embodiment of Present Invention Related to Vending Machine>

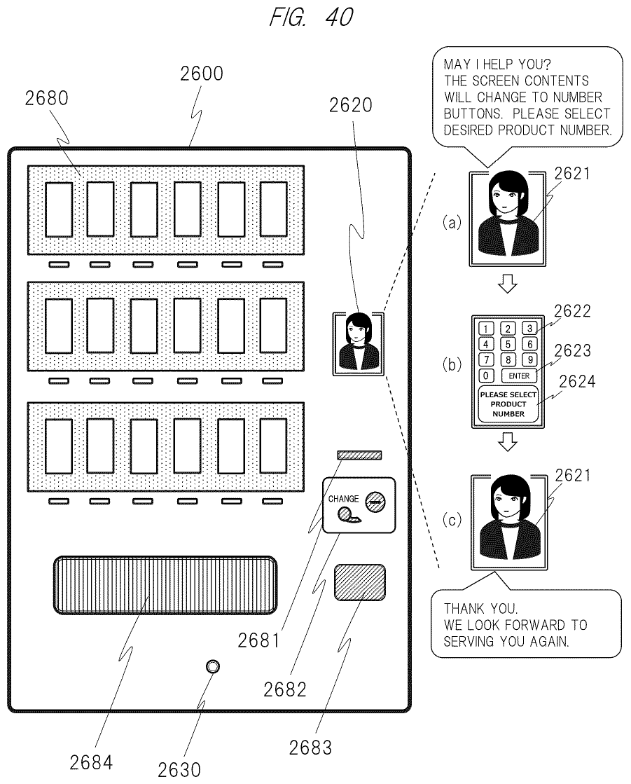

Next, an example of the application of the air floating video display apparatus to the vending machine as an embodiment of the present invention will be described with reference to FIG. 40. FIG. 40 is a diagram illustrating a case of the application of the multi-viewpoint video display apparatus (air floating video display apparatus) of the present invention to, for example, the vending machine for drinks.

In FIG. 40, a vending machine main body 2600 includes an air floating video display 2620. Although not illustrated, the air floating video display 2620 also has the internal configuration illustrated in FIG. 12A, 12B, 13A, or 13B, and the air floating video 3 formed by the air floating video display 2620 is formed based on the multi-viewpoint video formed by the video display apparatus 10 and the lenticular lens 1103. The vending machine main body 2600 further includes a drink display 2680 that displays drinks sold by the vending machine main body 2600, a bill insertion portion 2681 for inserting bills, a coin insertion portion 2682 for inserting coins, a change takeout port 2683 for taking out change, and a drink takeout port 2684 for taking out a drink purchased by the user.

The vending machine main body 2600 includes a human detecting sensor or a camera 2630. The human detecting sensor or the camera 2630 is a device for detecting approach of the user to the vending machine main body 2600. When the user approaches the vending machine main body 2600, the air floating video display apparatus detects the user approach based on the detection result made by the human detecting sensor or the camera 2630, and activates the air floating video display 2620. Next, as illustrated in (a) of FIG. 40, a person image 2621 appears as the air floating video (multi-viewpoint image) on the air floating video display 2620, and the machine emits a voice sound saying that, for example, “May I help you? Thank you for using. The screen changes to the number buttons. Please select desired product number.” to the user. Then, the person image 2621 disappears from the air floating video display 2620, and subsequently, a number button 2622, an enter button 2623 and an explanatory text 2624 of “Please select the product number” are displayed as illustrated in (b). At this time, although not illustrated, a cancel button or a return button may be displayed in addition to the number button 2622, the enter button 2623, and the explanatory text 2624.

Here, the video of the person image 2621 displayed on the air floating video display 2620 illustrated in FIG. 40 may be the air floating video 3 (1503) based on the multi-viewpoint image 1502 having the motion parallax as illustrated in FIG. 17. As a result, the user can visually recognize the video of the person image 2621 as the three-dimensional image. Further, when the user moves around the vending machine main body 2600, for the user, the person image 2621 apparently talks to the user while always directing its line of sight to the user along with the user's movement in, for example, the right-left direction. Therefore, this leads to an effect that makes texture for the user in which the image of the person image 2621 apparently talks to only the user.

The user selects a drink by operating the number button 2622 and the enter button 2623 displayed on the air floating video display 2620, and inserts a predetermined amount of money into the bill insertion portion 2681 or the coin insertion portion 2682, so that the drink is provided in a form that allows the user to take it out from the drink takeout port 2684.

Here, the multi-viewpoint image displayed as the air floating video illustrated in FIGS. 23, 24, 31, 32, 35, and 38 is used as the number button 2622, the enter button 2623, and the explanatory text 2624. As a result, when the user performs the touch operation (aerial operation) on, for example, the number button 1 and the number button 2 of the number buttons 0 to 9 in this order, and subsequently performs the touch operation (aerial operation) on the enter button 2623, so that the user can select the drink represented by a number 12. Here, as similar to FIGS. 25 and 31, the number button 1, the number button 2, and the enter button 2623 are displayed to apparently recess to be deeper than the other buttons that are the number button 0 and the number buttons 3 to 9. As a result, the user can clearly recognize that the user has selected the drink of the number 12.

At this time, there is a feature in which the explanatory text 2624 as the air floating video apparently exists on the front side of the number button 1, the number button 2, and the enter button 2623, and apparently exists on the back side of the other number buttons that are the number buttons 3 to 9 and the number 0 for the user. In other words, the depth positions of the number button 2622 and the enter button 2623 appropriately change in accordance with the result of the user's operation while the depth position of the explanatory text 2624 does not change and always remains at a constant depth position.

After the drink is taken out from the drink takeout port 2684, the number buttons 0 to 9, the enter button 2623, and the explanatory text 2624 disappear from the air floating video display 2620, and the person image 2621 appears again as illustrated in (c), and the machine emits a voice sound saying, for example, “Thank you. We look forward to your usage again”. Even in this case, the voice sound may be emitted from a normal loudspeaker, or from the super-directive loudspeaker so that only the user can hear the voice sound.

Through the above-described series of operations, the user can purchase the desired drink. The example of FIG. 40 shows that the vending machine main body 2600 includes only the air floating video display among the above-described components. However, the vending machine main body may include both the video display apparatus and the air floating video display, or may include the air floating video display at not only one position but also two or more positions. Note that, for example, if the air floating video displays are provided at two locations, the person image may be displayed as the multi-viewpoint image having the motion parallax on any one of the air floating video displays while the number button, the enter button, and the explanatory text 2624 may be displayed on the other air floating video display.

Furthermore, as the person image 2621, a plurality of different person images or animation character icon images having different ages and genders may be displayed. Data for displaying the plurality of different person images or animation character icon images having different ages and genders is stored in the nonvolatile memory 1108 of FIG. 2, and one of the plurality of different person images or animation character icon images may be appropriately selected and displayed on the air floating video display. In this case, in accordance with the attribute of the user (for example, age), it may be determined which person image or character icon is to be displayed.

As described above, since the present embodiment includes the air floating video display 2620 based on the multi-viewpoint image (or video) having the motion parallax, the user can select and purchase the product with contactless. Further, the user's approach to the vending machine can be detected, and the air floating video can be automatically displayed, and the person image 2621 recognized as the three-dimensional image can be displayed on the air floating video display 2620, based on the display of the multi-viewpoint image (or video) having the motion parallax. This results in texture making the user feel that an actual person apparently exists there and always talks to the user even if the user moves to any position. Furthermore, when the user has touched any one of the number buttons 2622 (the number buttons 0 to 9) and the enter button 2623, the number button 2622 and the enter button 2623 having been selected (touched) by the user are displayed to apparently recess to be deeper than the other buttons as described above while the depth position of the description 2624 apparently does not change and always remains at a constant depth position, and therefore, this results in an effect allowing the user to clearly recognize the change in the depth position of the number of the drink selected by the user.

In addition, as described above, in the present embodiment, the multi-viewpoint video is displayed as the air floating video, and the push button as the HMI is particularly displayed three-dimensionally, and therefore, for the user, an actual push button is apparently pressed down, and this results in an effect providing the air floating video suitable for the HMI.

In the foregoing, the present invention has been described in detail, based on the embodiments. However, the present invention is not limited to the foregoing embodiments, and various modifications can be made within the scope of the present invention. In each embodiment, components except for essential components can be added, eliminated or replaced. Each component may be single or plural unless otherwise particularly specified. A combination mode of the embodiments may be also applicable.

In the technique according to the embodiments, since the high-resolution and high-luminance video is displayed as the air floating video to be aerially floating, for example, the user can perform operations without concern about contact infection in illness by using combination with a contactless finger-position detecting apparatus or others. When the technique according to the present examples is applied to the system that is used by unspecified users, a contactless user interface having the less risk of the contact infection in illness and being available without the concern can be provided. The present invention providing such a technique contributes to “the third goal: Good Health and Well-being (for all people)” of the Sustainable Development Goals (SDGs: Sustainable Development Goals) advocated by the United Nations.

Furthermore, in the technique according to the embodiments, since only the normal reflection light is efficiently reflected to the retroreflector by reducing the divergence angle of the emitted video light and further unifying the emitted video light to be of the specific polarization wave, a bright and clear air floating video with high light utilization efficiency can be provided. According to the technique according to the embodiment, it is possible to provide a highly available contactless user interface capable of significantly reducing power consumption. The present invention providing such a technique contributes to “the ninth goal: Industry, Innovation and Infrastructure” and “the eleventh goal: Sustainable Cities and Communities” of the Sustainable Development Goals (SDGs: Sustainable Development Goals) advocated by the United Nations.

Furthermore, the technique according to the embodiments enables the formation of the air floating video using the video light having high directionality (rectilinear propagation). In the technique according to the present embodiments, even in display of video that requires high security by a system such as so-called kiosk terminal or display of video that is highly confidential and that is desired to be concealed from a person facing the user, it is possible to provide a contactless user interface having less risk of causing a person other than the user to peek the air floating video by displaying the video light with high directionality. The present invention contributes to “11. Make cities sustainable” of the sustainable development goals (SDGs: Sustainable Development Goals) proposed by the United Nations by providing the above-described techniques.

What is claimed is:

1. An air floating video display apparatus comprising:
a video display apparatus displaying a video;
a lenticular lens arranged on a video-light emission side of the video display apparatus; and
a retroreflector reflecting video light emitted from the video display apparatus and aerially forming an air floating video by using the reflection light,
wherein the video display apparatus displays a video including at least two objects so as to display, as a multi-viewpoint image, a plurality of videos formed by fixing a position of an optional object among the at least two objects while shifting a position of an object other than the optional object in a predetermined direction among different multi-viewpoint images.

2. The air floating video display apparatus according to claim 1,
wherein the predetermined direction is right-left direction with respect to a viewpoint of a user who is visually recognizing the air floating video.

3. The air floating video display apparatus according to claim 1,
wherein the lenticular lens is arranged between the video display apparatus and the retroreflector.

4. The air floating video display apparatus according to claim 1,
wherein the video display apparatus includes a display panel, and
the lenticular lens is arranged at a position far away by a predetermined distance from a light emitting surface of the display panel.

5. The air floating video display apparatus according to claim 4,
wherein a distance between the lenticular lens and the video display apparatus is adjusted by a focal length of the lenticular lens.

6. The air floating video display apparatus according to claim 1,
wherein the video display apparatus includes a display panel, and
a light emitting surface of the display panel and a light entering surface of the lenticular lens are parallel to each other.

7. The air floating video display apparatus according to claim 1,
wherein the object is any one of a number, a letter and a figure.

8. The air floating video display apparatus according to claim 1,
wherein the lenticular lens is arranged between the video display apparatus and the retroreflector,
the air floating video display apparatus further includes:
a housing configured to house the video display apparatus and the retroreflector; and
a controller configured to execute a predetermined processing based on a predetermined operation,
the object is any one of a number, a letter and a figure, and
the object has motion parallax along with movement of a user who is visually recognizing the air floating video.

9. The air floating video display apparatus according to claim 1,
wherein the lenticular lens is arranged between the video display apparatus and the retroreflector,
the air floating video display apparatus further includes:
a housing configured to house the video display apparatus and the retroreflector; and
a controller configured to execute a predetermined processing based on a predetermined operation,
the object has motion parallax along with movement of a user who is visually recognizing the air floating video, and
a position of the object displayed by the video display apparatus is opposite to a position of the object displayed as the air floating video in the predetermined direction.

10. The air floating video display apparatus according to claim 1,
wherein the lenticular lens is arranged between the video display apparatus and the retroreflector,
the air floating video display apparatus further includes:
a housing configured to house the video display apparatus and the retroreflector; and
a controller configured to execute a predetermined processing based on a predetermined operation,
the object has motion parallax along with movement of a user who is visually recognizing the air floating video, and
when it is detected that the user has approached the housing, the object is displayed as the air floating video.

11. The air floating video display apparatus according to claim 8, further comprising
a human detecting sensor,
wherein it is detected that the user has approached, based on an output result of the human detecting sensor.

12. The air floating video display apparatus according to claim 8, further comprising
an imager,
wherein it is detected that the user has approached, based on an image in which the user has been imaged, captured by the imager.

13. An air floating video display apparatus comprising:
a video display apparatus displaying a video;
a lenticular lens arranged on a video-light emission side of the video display apparatus; and
a retroreflector reflecting video light emitted from the video display apparatus and aerially forming an air floating video by using the reflection light,
wherein the video display apparatus displays a plurality of multi-viewpoint images including at least three objects so that a position of an optional object among the at least three objects is fixed while a position of an object other than the optional object is shifted among the plurality of different multi-viewpoint images in a predetermined direction.

14. The air floating video display apparatus according to claim 13,
wherein the plurality of multi-viewpoint images are aerially displayed as the air floating video by the retroreflector.

15. The air floating video display apparatus according to claim 13,
wherein the predetermined direction is right-left direction with respect to a viewpoint of a user who is visually recognizing the air floating video.

16. The air floating video display apparatus according to claim 13,
wherein the lenticular lens is arranged between the video display apparatus and the retroreflector.

17. The air floating video display apparatus according to claim 13,
wherein the video display apparatus includes a display panel, and
the lenticular lens is arranged at a position far away by a predetermined distance from a light emitting surface of the display panel.

18. The air floating video display apparatus according to claim 16,
wherein a distance between the lenticular lens and the video display apparatus is adjusted by a focal length of the lenticular lens.

19. The air floating video display apparatus according to claim 13,
wherein the video display apparatus includes a display panel, and
a light emitting surface of the display panel and a light entering surface of the lenticular lens are parallel to each other.

20. The air floating video display apparatus according to claim 13,
wherein the object is any one of a number, a letter, a figure and background.

21. The air floating video display apparatus according to claim 13,
wherein the lenticular lens is arranged between the video display apparatus and the retroreflector,
the air floating video display apparatus further includes:
a housing configured to house the video display apparatus and the retroreflector,
the object is any one of a number, a letter, a figure and background, and
the object has motion parallax along with movement of a user who is visually recognizing the air floating video.

22. The air floating video display apparatus according to claim 13,
wherein the lenticular lens is arranged between the video display apparatus and the retroreflector,
the air floating video display apparatus further includes:
a housing configured to house the video display apparatus and the retroreflector,
the object has motion parallax along with movement of a user who is visually recognizing the air floating video, and
positions of at least two objects among the objects displayed by the video display apparatus are opposite to a position of the object displayed as the air floating video in the predetermined direction.

23. The air floating video display apparatus according to claim 13,
wherein the lenticular lens is arranged between the video display apparatus and the retroreflector,
the air floating video display apparatus further includes:
a housing configured to house the video display apparatus and the retroreflector,
the object has motion parallax along with movement of a user who is visually recognizing the air floating video, and
when it is detected that the user has approached the housing, the object is displayed as the air floating video.

24. The air floating video display apparatus according to claim 23, further comprising
a human detecting sensor,
wherein it is detected that the user has approached, based on an output result of the human detecting sensor.

25. The air floating video display apparatus according to claim 23, further comprising
an imager,
wherein it is detected that the user has approached, based on an image in which the user has been imaged, captured by the imager.
